(19) United States
(12) Patent Application Publication
(10) Pub. No.: US 2026/0042008 A1
(43) Pub. Date: Feb. 12, 2026

(54) PHYSICAL PROXIMITY-BASED MANIFESTATION OF VIRTUAL OBJECTS IN A VIRTUAL ENVIRONMENT

(71) Applicants: Robert Plotkin, Manalapan, NJ (US); Steven K. Gold, Belfast, ME (US)

(72) Inventors: Robert Plotkin, Manalapan, NJ (US); Steven K. Gold, Belfast, ME (US)

(21) Appl. No.: 19/362,580

(22) Filed: Oct. 20, 2025

Related U.S. Application Data
(63) Continuation-in-part of application No. 18/131,059, filed on Apr. 5, 2023.
Application No. 18/131,059 is a continuation-in-part of application No. 17/900,431, filed on Aug. 31, 2022, now Pat. No. 12,198,278.
(60) Provisional application No. 63/329,249, filed on Apr. 8, 2022.
(60) Provisional application No. 63/342,459, filed on May 16, 2022.
(60) Provisional application No. 63/710,665, filed on Oct. 23, 2024.

(51) Int. Cl. A63F 13/537

(52) U.S. Cl. CPC A63F 13/537

(57) ABSTRACT

Systems, methods, and storage media for manifesting a virtual object in a virtual environment are disclosed. Exemplary embodiments may: receive, at a first physical object detector, a first signal, from a first physical object-associated element in a first physical environment; identify, at a first value identification module, based on the first signal, a first value associated with the first signal; identify, at a first virtual object identification module, based on the first value, a first virtual object; and manifest, at a first virtual environment output device, a first manifestation of the first virtual object in a first manifestation of the first virtual environment.

### SUMMARY

Systems and methods of at least some embodiments of the present invention include manifesting a virtual object in a virtual environment based on and/or in response to determining that a physical element of such an embodiment of the present invention—such as a physical object detector, virtual environment output device, mobile device, or user—in a physical environment is in proximity to a physical object in the physical environment. Systems and methods of at least some embodiments of the present invention include changing, modifying, or removing the manifestation of a virtual object in a virtual environment, based on and/or in response to determining proximity between a physical element in a physical environment and a physical object in the physical environment, a change in proximity between a physical element in a physical environment and a physical object in the physical environment, or the absence of proximity (also referred to as non-proximity) between a physical element in a physical environment and a physical object in the physical environment. Systems and methods of at least some embodiments of the present invention include proximity determination based on and/or in response to a signal (e.g., signal content) received from a physical object-associated element. Systems and methods of at least some embodiments of the present invention include changing, modifying, or removing the manifestation of a virtual object in a virtual environment, based on and/or in response to determining a physical motion or physiological parameter (or physiologic parameter change) of a user.

One aspect of the present disclosure relates to a system configured for manifesting a virtual object in a virtual environment. The system may include one or more hardware processors configured by machine-readable instructions. The system may be configured to receive, at a first physical object detector, a first signal (e.g., signal content), from a first physical object-associated element in a first physical environment. The first physical object-associated element may be associated with a first physical object in the first physical environment. The processor(s) may be configured to identify, at a first value identification module, based on and/or in response to the first signal (e.g., first signal content), a first value associated with the first signal. The first value may be associated with the first physical object, e.g., the first value may represent an identity of the first physical object. The processor(s) may be configured to identify, at a first virtual object identification module, based on and/or in response to the first value, a first virtual object. The processor(s) may be configured to manifest, at a first virtual environment output device, a first manifestation of the first virtual object in a first manifestation of the first virtual environment. In certain embodiments of the invention, a virtual object may be changed, modified, or removed based on and/or in response to a signal (e.g., or signal content) received from an object-associated element. In certain embodiments of systems of the invention, a virtual object may be changed, modified, or removed based on and/or in response to determining a physical motion or physiological parameter (or physiologic parameter change) of a user by means of a sensor or other system element.

Another aspect of the present disclosure relates to a method for manifesting a virtual object in a virtual environment. The method may include receiving, at a first physical object detector, a first signal (e.g., signal content), from a first physical object-associated element in a first physical environment. The first physical object-associated element may be associated with a first physical object in the first physical environment. The method may include identifying, at a first value identification module, based on and/or in response to the first signal (e.g., first signal content), a first value associated with the first signal. The first value may be associated with the first physical object, and may represent an identity of the first physical object. The method may include identifying, at a first virtual object identification module, based on and/or in response to the first value, a first virtual object. The method may include manifesting, at a first virtual environment output device, a first manifestation of the first virtual object in a first manifestation of the first virtual environment. In certain embodiments of methods of the invention, a virtual object may be changed, modified, or removed based on and/or in response to a signal (e.g., signal content) received from an object-associated element. In certain embodiments of methods of the invention, a virtual object may be changed, modified, or removed based on and/or in response to determining a physical motion or physiological parameter (or physiologic parameter change) of a user by means of a sensor or other system element.

Yet another aspect of the present disclosure relates to a non-transient computer-readable storage medium having instructions embodied thereon, the instructions being executable by one or more processors to perform a method for manifesting a virtual object in a virtual environment. The method may include receiving, at a first physical object detector, a first signal, from a first physical object-associated element in a first physical environment. The first physical object-associated element may be associated with a first physical object in the first physical environment. The method may include identifying, at a first value identification module, based on and/or in response to the first signal, a first value associated with the first signal. The first value may be associated with the first physical object, and may represent an identity of the first physical object. The method may include identifying, at a first virtual object identification module, based on and/or in response to the first value, a first virtual object. The method may include manifesting, at a first virtual environment output device, a first manifestation of the first virtual object in a first manifestation of the first virtual environment. In certain embodiments of the invention, a non-transient computer-readable storage medium may have instructions thereon to cause a virtual object to be changed, modified, or removed based on and/or in response to a signal (e.g., signal content) received from an object-associated element. In certain embodiments of the invention, a non-transient computer-readable storage medium may have instructions thereon to cause a virtual object to be changed, modified, or removed based on and/or in response to determining a physical motion or physiological parameter (or physiologic parameter change) of a user by means of a sensor or other system element.

Aspects and embodiments of the present invention provide features and benefits, such as an ability to manifest a virtual object in a virtual environment based on and/or in response to proximity between a first physical object and an element of a system of the invention, and/or to change, modify, or remove a virtual object based on and/or in response to proximity of a physical object to an element of a system of the invention, a signal, signal content, a user movement, or a user physiologic parameter (or physiologic parameter change), as examples. Other features and advantages of various aspects and embodiments of the present invention will become apparent from the following description and from the claims.

### BRIEF DESCRIPTION OF THE DRAWINGS

FIG. 1 illustrates a system for manifesting a virtual object in a virtual environment, in accordance with one or more embodiments of the invention.

FIG. 2 illustrates a method for manifesting a virtual object in a virtual environment, in accordance with one embodiment of the invention.

FIG. 3 illustrates a system for manifesting a virtual object in a virtual environment, in accordance with one or more embodiments of the invention.

### DEFINITIONS OF TERMS USED HEREIN

Electronic Processing Means: In at least some embodiments of the present invention, “electronic processing means” refers to one or more physical objects which, in combination, are configured to receive electronic input and to perform one or more operations on that electronic input to produce electronic output. A computer is an example of electronic processing means. An analog circuit is an example of electronic processing means which may or may not be a computer.

Manifesting: In at least some embodiments of the present invention, “manifesting” refers to the process of generating, e.g., using electronic processing means, output (referred to herein as a “manifestation”) representing digital data (e.g., a virtual environment and/or one or more virtual objects). Such a manifestation may include, for example, one or more of the following: visual output, auditory output, haptic output, and tactile output. Such manifesting may, for example, include generating output representing one or more properties of the digital data, such as one or more virtual object properties. (The terms “property,” “characteristic,” “parameter,” and “feature” are used interchangeably herein.) As this implies, two sets of digital data (e.g., a first and second virtual object) may have different properties, which may result in manifestations of those two sets of digital data differing from each other. Similarly, embodiments of the present invention may manifest a first property of a first virtual object to generate a first manifestation of the first virtual object, where the first manifestation represents the first property. The first property of the first virtual object may change (e.g., to a different value), and embodiments of the present invention may generate (e.g., in response to the change of the first property) a new manifestation of the first virtual object (or modify the first manifestation of the first virtual object to produce a modified first manifestation of the first virtual object), where the new manifestation (or the modified first manifestation) of the first virtual object represents the changed first property of the first virtual object. A manifestation of a virtual environment or a virtual object may include a plurality of manifestations of a plurality of virtual objects contemporaneously. For example, a manifestation of a virtual environment may include a plurality of manifestations of a plurality of virtual objects contemporaneously. In at least some embodiments of the invention, manifesting may be performed by, or take place at, a virtual environment output device, wherein a manifestation may be manifested using the virtual environment output device. A manifestation may include or consist of digital data. A manifestation may include or consist of a physical object (e.g., a manifestation that is printed on paper, such as a code (e.g., a bar code or QR code)).

Non-Proximity: In at least some embodiments of the present invention, “non-proximity” is the absence (or lack) of proximity (as defined herein) between two physical objects, such as a first physical object-associated element that is associated with a first physical object, and a physical object (proximity) detector. For example, in at least some embodiments of the invention, a first physical object (or a first physical object-associated element that is associated with the first physical object, for example) and a second physical object (or a physical object detector that is not the first physical object-associated element or the first physical object, for example) may be in non-proximity to each other while they are more than some distance (e.g., 5 centimeters, 1 meter) apart from each other. As another example, in at least some other embodiments of the invention, while a first physical object communicates a first signal (e.g., by means of a first physical object-associated element that is associated with the first physical object), and a second physical object neither receives nor detects the first signal (e.g., by means of a physical object detector that is capable of receiving or detecting the first signal, and that is not the first physical object-associated element or the first physical object)—wherein there is a lack of receipt of the first signal, or there is a failure to detect the first signal, for example—the first physical object and the second physical object may be in non-proximity to each other. At least some embodiments of the present invention may determine whether two physical objects are not in proximity (i.e., are in non-proximity) to each other based on one or more inputs relating to one or both of the two physical objects. Such a determination may include determining whether the one or more inputs satisfy a proximity criterion, such as determining whether the one or more inputs indicate that the two physical objects are beyond a certain distance of each other. As one example, an embodiment of the present invention may receive a first input representing a location of the first physical object and may receive a second input representing a second location of the second physical object, and determine whether the first physical object and the second physical object are in non-proximity to each other (e.g., more than a certain distance from each other) based on the first input and the second input. At least some embodiments of the present invention may treat the two physical objects as being in non-proximity to each other based on the results of such a determination, such as by treating the two physical objects as being in non-proximity to each other in response to determining that the two physical objects are more than the certain distance from each other. In a first example, two physical objects may be in non-proximity with each other, meaning that they are not in proximity with each other. Alternatively, two physical objects may, at a first time, be in non-proximity with each other, and then, at a second time after the first time, be in proximity with each other. In a third example, two physical objects may, at a first time, be in proximity to each other, and then, at a second time after the first time, be in non-proximity with each other. Two physical objects may, possibly repeatedly, change their proximity status relative to one another. In at least some embodiments, non-proximity of two physical objects is determined, detected, sensed, analyzed, and/or calculated using a physical object detector (or other proximity sensing or detecting means), possibly including other local or remote processing means. In at least some embodiments, non-proximity of two physical objects is determined, detected, sensed, etc. when a first physical object detector associated with a first physical object (such as a mobile device, as one example) does not detect a signal from a first physical object-associated element associated with a second physical object. In this case, the failure to detect a signal determines (or may be used to determine) non-proximity between the first physical object and the second physical object. In at least some embodiments, a simple lack of detection of a signal (that is being communicated by a physical object-associated element, for example) by a physical object detector, indicates non-proximity between the physical object-associated element and the physical object detector. In various embodiments, non-proximity between two physical objects may be determined based on the absence of a signal, the lack of receipt of a signal (or the failure to receive a signal), the strength (or weakness) of a signal, the content of a signal, or some combination of these, as determined by a physical object detector or other element of a system of the invention. At least some embodiments of a physical object detector use a form of an electromagnetic sensor. At least some embodiments of a physical object detector use a radio or wireless signal, e.g., RFID, NFC. At least some embodiments of a physical object detector use a visual sensor, e.g., a camera. At least some embodiments of a physical object detector use an audio sensor, e.g., a microphone to perform any of the functions of a physical object detector disclosed herein. In at least some embodiments, when a signal (such as a signal that is communicated by a first physical object-associated element that is associated with a first physical object) is not detected by a physical object detector (such as a physical object detector that is associated with a second physical object, e.g., a mobile communication device used by a first user), then a determination is made that the first physical object and the second physical object are in non-proximity. Embodiments of the present invention may also determine that a first physical object and a second physical object are in non-proximity by determining that the first physical object and the second physical object are not within a particular (e.g., defined) physical space at the same time, such as by using a computer, processor, and/or sensor means. Sensors may determine (or assist in the determination of) that two physical objects are in non-proximity by virtue of not detecting a signal, or detecting a signal strength below a threshold, such as a present or pre-established threshold, as examples. In at least some embodiments, two physical objects that are in non-proximity are not in proximity. The phrases “not in proximity” and “non-proximity” are used interchangeably herein.

Object: The term “object,” when not qualified by “physical” or “virtual” (e.g., “physical object,” “virtual object”), may refer herein to a physical object or a virtual object.

Physical Environment: In at least some embodiments of the present invention, a “physical environment” is a physical space (e.g., a physical three-dimensional space) in which at least one physical object exists or may exist. At least some embodiments of a physical environment may contain a physical object, e.g., at least some physical object that is suited to the physical space dimensions that defines the physical environment. A physical environment exists continuously through time (e.g., it cannot be paused by a device input such as the push of a button). A physical environment behaves exclusively according to the natural laws of physics. A physical environment does not use virtual environment output means in order to be made real, or to exist. A physical environment is not a virtual environment (as those terms are defined herein).

Physical Object: In at least some embodiments of the present invention, a “physical object” is an object that is i) made of matter (e.g., atoms and/or molecules), ii) not digital data stored or transmitted by a computer or electronic processing means, and iii) not manifested using virtual environment output means. A physical object is not a virtual object, and a virtual object is not a physical object (as those terms are defined herein). For clarity, while a VR headset is an example of a physical object, an image of a virtual object (as defined herein, e.g., an avatar) generated by a computer executing software and manifested as visual output using an output or display means (e.g., a VR headset) is not a physical object in embodiments of the present invention. An example of an embodiment of a physical object is a living, breathing person—such as the patent examiner reading this patent application—who thinks, translocates in the physical world, is made of matter, is not digital data transmitted or stored by electronic processing means, and is not manifested using virtual environment output means. An embodiment of a physical object may also be a non-living (e.g., inanimate) physical object, such as a thing that is also made of matter, not digital data transmitted or stored by electronic processing means, and not manifested using virtual environment output means. Without limitation, a physical object that is a thing may, for example, be a product, item of clothing, footwear, sneaker, mode of transportation, car, bike, aircraft, boat, food or beverage item, tool, building, house, apartment, office, or furnishing.

Physical Object-Associated Element: In at least some embodiments of the present invention, a “physical object-associated element” is a physical element that is attached to, integrated with, connected with, adhered onto, printed on, displayed at, contained within, or otherwise associated with a physical object of the present invention. A physical object-associated element may be distinct from, or the same as, the physical object with which the physical object-associated element is associated. For example, a physical object may be its own physical object-associated element. In other words, a physical object may be the physical object-associated element with which the physical object is associated. A physical object-associated element is an example of a physical object, as that term is used herein. In at least some embodiments, a physical object-associated element communicates a signal. In at least some embodiments, such a signal may, for example, be an electromagnetic, radio, visual (light-based), and/or audio (sound-based) signal. In at least some embodiments such a signal may be passively and/or actively communicated. In at least some embodiments, a physical object-associated element may be or include a passive radio frequency identification (RFID) transmitter or active RFID transmitter. In at least some embodiments, a physical object-associated element may be or include a near-field communication (NFC) transmitter. In at least some embodiments, a physical object-associated element may be or include a Bluetooth transmitter or a Bluetooth Low Energy (BLE) transmitter. In at least some embodiments, a signal communicated by a transmitter may be received by a radio receiver or electromagnetic energy receiver means. In at least some embodiments, a physical object-associated element may be or include a code or a manifestation of a code, such as a visual (e.g., printed or electronically displayed) QR code, barcode, or other visual code that visually (optically) communicates a signal. In at least some embodiments the signal contains the code. In at least some embodiments, the signal represents the code. In at least some embodiments, such a visual manifestation of a signal may be detected, sensed, or otherwise received by a camera or other optical receiver means (e.g., a code reader, such as a bar code reader or a QR code reader). In at least some embodiments, a physical object-associated element may be or include a sound generation means, such as a speaker or other mechanism that outputs an audio signal and audibly communicates the signal. In at least some embodiments, such an audible signal may be detected, sensed, or otherwise received by a microphone and/or other sound receiver means. Other embodiments of physical object-associated elements, and other embodiments of signals communicated by physical object-associated elements, fall within the scope of the present invention. In at least some embodiments, a signal output by a physical object-associated element communicates information. In at least some embodiments, such a signal contains information. In at least some embodiments, such a signal communicates and/or contains information relating to the physical object. In at least some embodiments, the information relates to the identity of the physical object (e.g., the identity of the physical object and/or an identifier that facilitates the identification of the physical object). In at least some embodiments, the information relates to a characteristic or parameter of the physical object, or a characteristic or parameter of the physical environment within which the physical object exists. In at least some embodiments, such a signal communicates and/or contains information that is used in a determination of proximity or non-proximity of the physical object (and/or its associated physical object-associated element) relative to a physical object detector (and/or a sensor), or relative to another physical object (such as a mobile device of a user), as examples. In at least some embodiments, a process of identifying that two physical objects are in proximity (or non-proximity) includes the process of determining that the two physical objects are in proximity (or non-proximity). In at least some embodiments of a signal, information communicated by and/or contained in a signal may be communicated as information content of the signal, or by virtue of a feature of the signal itself, such as a measure of the strength of the signal. A single physical object-associated element may be associated with zero, one or more physical objects. A single physical object may be associated with zero, one, or more physical object-associated elements.

Proximity: In at least some embodiments of the present invention, “proximity” refers to a relation between two physical objects that exists while the two physical objects are positioned within a certain distance from each other, such as being near or close to each other, as may, for example, be quantified using a unit of distance measurement, e.g., meters. When a proximity relation exists between two objects, we say that they are “in proximity” or “in proximity to each other.” For example, in at least some embodiments of the invention, a first physical object and a second physical object may be in proximity when the first physical object (or a first physical object-associated element that is associated with the first physical object, for example) and the second physical object (or a physical object detector that is not the first physical object-associated element or the first physical object, for example) are less than some distance (e.g., 5 centimeters, 1 meter) apart from each other. As another example, in at least some other embodiments of the invention, a first physical object and a second physical object may be in proximity when the first physical object communicates a first signal (e.g., by means of a first physical object-associated element that is associated with the first physical object), and the second physical object detects the first signal (e.g., by means of a physical object detector that is capable of receiving or detecting the first signal, and that is not the first physical object-associated element or the first physical object) receives or detects the first signal. In any embodiments disclosed herein which identify that a first physical object is in proximity to a second physical object, identifying may include determining that the first physical object is in proximity to the second physical object. At least some embodiments of the present invention may determine whether two physical objects are in proximity to each other based on one or more inputs relating to one or both of the two physical objects. Such a determination may include determining whether the one or more inputs satisfy a proximity criterion, such as determining whether the one or more inputs indicate that the two physical objects are within a certain distance of each other. As one example, at least some embodiments of the present invention may receive a first input representing a location of the first physical object, and may receive a second input representing a second location of the second physical object, and determine whether the first physical object and the second physical object are in proximity to each other (e.g., within no more than a certain distance from each other) based on the first input and the second input. At least some embodiments of the present invention may treat the two physical objects as being in proximity to each other (or not in proximity to each other) based on the results of such a determination, such as by treating the two physical objects as being in proximity to each other in response to determining that the two physical objects are not more than the certain distance from each other. In some embodiments of the invention, proximity may exist between two physical objects when there is no more than a relatively small distance between the two physical objects, such as a few (e.g., less than 5) millimeters or centimeters, for example. In some embodiments, proximity may exist between two physical objects when there is no more than a relatively large distance between the two physical objects, such as several (e.g., more than 3) decimeters or meters. In at least some embodiments, proximity may serve as a proxy for the use of, or interaction with, a physical object by a user (when, for example, a physical object-associated element that is associated with a physical object is in proximity with a physical object detector that is an element of a mobile communication device in possession of a user). A distance may be a specific or predetermined distance (e.g., less than 1 meter), or an approximate distance (e.g., less than 1 meter+/−0.5 meters), as may be determined by a system or method of the invention. In addition, proximity between two physical objects may be determined based on the presence of a signal (e.g., a signal receiver or physical object detector detects the presence of the signal), receipt of a signal (e.g., a signal receiver or physical object detector receives the signal), characteristic or strength of a signal (e.g., a signal receiver or physical object detector facilitates a determination that a signal strength is above a predetermined threshold), or content of a signal (e.g., a signal receiver or physical object detector processes information contained in the signal to determine proximity). In at least some embodiments, such a signal may be communicated by or using a physical object-associated element that generates, transmits, displays, presents or otherwise communicates the signal, for example. In at least some embodiments, the signal may be received by or using a physical object detector or other signal receiver or sensor means, for example. In at least some embodiments, proximity between a first physical object and a second physical object may be determined based on a measure of proximity is between a first point at the first physical object and a second point at the second physical object, wherein the first and second physical objects are distinct from one another, and may be positioned or moved closer together (e.g., to be brought into proximity), or farther apart (to be moved out of proximity, or moved to a position of non-proximity), from each other. In at least some embodiments, proximity between a first physical object and a second physical object may be determined, detected, sensed, analyzed, or calculated, or some combination of these methods, involving a physical object detector, and possibly also local or remote processing means. In at least some embodiments, proximity may be determined directly, such as by means of a proximity detector means or physical object detector that determines proximity. In at least some embodiments, proximity may be determined indirectly, such as by determining that two physical objects are (or were, if determining retroactively) within a predetermined distance from each other at a point in time (e.g., the two objects are/were in the same place at the same time). In at least some embodiments, proximity between a first physical object and a second physical object may be determined automatically, such as by a constantly operating physical object detector (that continuously monitors for proximity, for example), or non-automatically, such as by means of an intervention of a physical object detector, or by intervention of a user (possibly including manual manipulation of an element of the invention by the user, for example), as examples. In at least some embodiments, proximity between a first physical object and a second physical object may be a binary relation, e.g., the first and second physical objects (such as a physical object-associated element associated with the first physical object, and a physical object detector associated with the second physical object) may either be in proximity with each other, or not in proximity (in non-proximity) with each other. In at least some embodiments, proximity is a non-binary (e.g., discrete or continuous) relation, and may be quantified as a measure of distance or a signal strength, as examples. In at least some embodiments, proximity between a first physical object and a second physical object is determined, detected, sensed, analyzed, and/or calculated using a physical object detector means, a physical object detector, proximity detector means, or proximity determination means. In at least some embodiments, proximity between a first physical object and a second physical object is determined, detected, sensed, etc. when a first physical object detector associated with the first physical object (such as a mobile device, as one example) detects a first signal from a first physical object-associated element associated with the second physical object. In this case, the detection of such a first signal indicates, or may be used to determine, that the first physical object and the second physical object are in proximity. In at least some embodiments, simple detection of a signal (that is being communicated by a physical object-associated element) by a physical object detector indicates proximity between the physical object-associated element and the physical object detector. At least some embodiments of a physical object detector use an electromagnetic sensor. At least some other embodiments of a physical object detector use a radio receiver or wireless signal receiver, e.g., an RFID or NFC transmitter tag receiver. At least some other embodiments of a physical object detector use an optical sensor (e.g., a camera) to receive an optical signal. At least some other embodiments of a physical object detector use an audio sensor (e.g., a microphone) to receive an audio signal. In at least some embodiments, when a signal (such as a signal that is communicated by a physical object-associated element that is associated with a physical object) is detected by a physical object detector (such as a physical object detector that is associated with a second physical object, such as a mobile device that is used by a user), then a determination of proximity is made. In at least some embodiments proximity may be determined based on the presence of a signal, the receipt of a signal, the strength of a signal, a characteristic of a signal, or the content of a signal, or some combination of these. Additionally, proximity between a first physical object and a second physical object may also be determined by determining that the first and second physical objects are within a particular (e.g., defined) physical space at the same time, such as by using a computer, processor, and/or sensor means. In at least some embodiments, two physical objects that are in proximity are not in non-proximity. Embodiments of the present invention may generate, store, and/or communicate data representing the proximity state (e.g., “in proximity” or “not in proximity”) of two physical objects. Such “proximity state data” may, for example, represent the proximity state of the two physical objects at a particular point in time or during a particular range of times. The time(s) associated with the proximity state data may, for example, be stored explicitly in data (e.g., in one or more timestamps within, or otherwise associated with, the proximity state data) or may be implicit (e.g., the current time may be assumed to be the time that is associated with the proximity state data). Note that at any particular time, the proximity state data associated with two physical objects may represent a proximity state that is or is not the actual proximity state of the two physical objects at that particular time. For example, an embodiment of the present invention may, at a first time, determine that two physical objects are in proximity and generate proximity state data indicating such proximity at the first time. At a second time that is later than the first time, the two physical objects may no longer be in proximity, at which time the proximity state data no longer represents the actual proximity state of the two physical objects at the second time.

Space: In at least some embodiments of the present invention, a “space” is a physical or virtual region having two or more dimensions (e.g., two dimensions or three dimensions) within which entities (e.g., physical objects and/or virtual objects) exist. A space may be bounded or boundless. Entities may have properties within a space, such as any one or more of the following: position (e.g., as defined by coordinates within the dimensions of the space; for example, in a three-dimensional space, an entity existing within the space may have a position that is represented by coordinates x, y, and z), mass, and velocity. A set of laws of physics, such as natural laws of physics (in the case of a physical space) or artificial laws of physics (in the case of a virtual space), may govern the behavior of entities within a space, whether that set of laws of physics is (fully or partially) known to humans. In a virtual space, the artificial laws of physics that govern the behavior of entities within the virtual space may or may not simulate, or be equal to or an approximation of, the natural laws of physics. Time may pass within a space. Time may pass in a virtual space at a different rate (or possibly in a different direction) than in physical space. The properties of entities within a space may change over time. A manifestation of a space may have a different number of dimensions than the space. For example, a space may have three dimensions and a manifestation of the space may have two dimensions. A “physical object,” as that term is used herein, is an example of an entity in a physical space. A “virtual object,” as that term is used herein, may represent an entity in a virtual space. A physical space is not a virtual space, and a virtual space is not a physical space (as those terms are defined herein).

Transmit: In at least some embodiments of the present invention, data (e.g., signal) may be “transmitted” over any medium, such as one or more wires or wirelessly. Transmitting data may include transmitting the data over a network. The terms “output,” “provide,” and “communicate,” as used herein include, but are not limited to, transmitting. For example, embodiments of the present invention may “provide” an output from one software component to another, without transmitting that output over one or more wires or wirelessly.

Virtual Environment: In at least some embodiments of the present invention, a “virtual environment” is a virtual object which represents a virtual entity, where the virtual entity contains at least one other virtual entity represented by at least one other virtual object. Virtual environment output means may manifest a virtual environment to generate a manifestation of the virtual environment. In at least some embodiments of the present invention, a virtual environment may be a simulation of a physical environment or of a fictional environment. In at least some embodiments, a virtual environment is generated by electronic processing means. In at least some embodiments, a virtual environment includes digital data representing behaviors according to a digital model, such as a digital model of laws of physics. Such a digital model of laws of physics may or may not simulate natural laws of physics (i.e., the laws of physics that govern the physical universe). In at least some embodiments, the digital model of laws of physics may be modified versions of natural laws of physics, such as laws of physics in which there is a smaller or larger gravitational force than in natural laws of physics, for example. An embodiment of a virtual environment may perfectly, or approximately (e.g., within some margin of error), simulate a physical environment, such as a particular interior physical space or physical cityscape that exists in a physical environment. Such an embodiment is an example of what is referred to herein as a “non-fictional virtual environment.” An embodiment of a virtual environment may also simulate a fictional environment (e.g., an environment which is made up, imagined, or which otherwise is not the same as any physical environment), which may (in some or all of its aspects) resemble a physical environment. For example, one embodiment of a fictional virtual environment may closely simulate a physical environment with regard to the relative positions and dimensions of its virtual objects, but may be manifested visually using different colors and/or other properties than the physical environment which it otherwise simulates or resembles. As another example, an embodiment of a fictional virtual environment may have certain behaviors which exist in the physical environment (e.g., laws of physics, such as the law of gravity), but which behave differently (at least in part) in the fictional virtual environment than in the physical environment (e.g., a virtual earth with zero gravity). In at least some embodiments, a virtual environment represents a virtual entity which includes, or is made of, at least one virtual object. In at least some embodiments, a collection of virtual objects may create or define a virtual entity represented by a particular virtual environment. As another example, an avatar—e.g., a simulation of an actual or fictional person—may exist, and move around in, an embodiment of a virtual entity represented by a virtual environment. In another embodiment of a virtual environment, a first avatar simulating a first real person may interact with a second avatar simulating a second real person within a virtual entity represented by the virtual environment. In another embodiment of a virtual environment, a first avatar simulating a first real person may interact with a second avatar representing a second fictional person within a virtual entity represented by the virtual environment. In another example of an embodiment of a virtual environment, an avatar (a first virtual object) interacts with a second virtual object, e.g., the avatar sits on a virtual chair, or walks along a virtual walking path, or wears a virtual hat, or observes a virtual bird fly through the virtual air in a virtual entity represented by the virtual environment. In at least some embodiments, a virtual environment is a simulation of a physical environment. In at least some embodiments, a virtual environment is a representation of a physical environment. A virtual environment is not a physical environment (as those terms are defined herein).

Virtual Environment Output Means: In at least some embodiments, “virtual environment output means” (also referred to as a “virtual environment output device”) refers to a means, such as a device, for manifesting one or more virtual objects and/or one or more virtual environments. Examples of virtual environment output means include a virtual reality (VR) output device (e.g., headset), an augmented reality (AR) device, a mixed reality (MR) device, an extended reality output device, an enhanced reality output device, a digital display (e.g., a display monitor that outputs two-dimensional visual output), and any direct-to-brain output means (e.g., one or more neural sensors). A neural sensor or similar sensor technology may be positioned on the surface of or within the brain, on the surface of or within a nerve, or on the surface of or within a muscle or other body cell, tissue, or organ. Although a neural sensor may detect neural (e.g., nerve or neuronal) activity, other similar or related physiologic sensors may detect other physiologic activity in a cell, tissue, or organ, including but not limited to electrical and chemical activity.

Virtual Object: In at least some embodiments of the present invention, a “virtual object” is digital data stored and/or transmitted by electronic processing means. In at least some embodiments of the present invention, a virtual object may be manifested using virtual environment output means. In at least some embodiments of the present invention, a “virtual object” is a simulation (a “simulation” is defined as an imitation of the operation of a physical or real-world process or system, such as a physical environment and/or one or more physical objects, over time) of an object (e.g., of a physical, fictional or imagined object) that is generated by electronic processing means, possibly involving the use of software, and capable of being manifested using virtual environment output means. An embodiment of a virtual object may include a set of digital parameters and corresponding values. Such parameters and/or corresponding values may change over time. In at least some embodiments, such parameters and values may additionally be stored in one or more computer-readable media. In one embodiment, digital data representing a virtual bicycle—e.g., a simulation of a physical bicycle, such as a bicycle that may be purchased in a physical bicycle store and pedaled along a real-life bicycle path by an actual living person—is an example of a virtual object. In another embodiment, digital data representing an avatar—e.g., a simulation of an actual or fictional person existing in a virtual environment—is an example of a virtual object. In yet another embodiment, data representing a virtual object that is a virtual t-shirt (e.g., a simulation of an actual 100% cotton t-shirt, worn on the body of a living human user of a virtual environment output device) may be simulated in a virtual environment as a virtual t-shirt worn on the user's avatar (while the virtual user is riding her virtual bicycle in the virtual environment). In at least some embodiments, a virtual object is a simulation of a physical object. In at least some embodiments, a virtual object is a representation of a physical object. A virtual object is not a physical object, as those terms are defined herein.

Object Property: when not qualified by a “virtual” or “physical,” a property of a virtual or physical object. An object property (also referred to herein simply as a “property” or a “property of an object”) may, for example, be any of the properties described herein, such as, but not limited to: size, shape, color, location, speed, velocity, acceleration, and proximity in relation to another object.

Virtual Object Property: an object property of a virtual object, also referred to herein simply as a “property of a virtual object.” The term “property,” when used herein in connection with a virtual object (e.g., “the location of a virtual object”) should be understood to refer to a virtual object property.

Physical Object Property: an object property of a physical object, also referred to herein simply as a “property of a physical object.” The term “property,” when used herein in connection with a physical object (e.g., “the location of a physical object”) should be understood to refer to a virtual object property.

Object Property Criterion: a criterion (also referred to herein as a “condition”) that applies to one or more object properties (e.g., one or more virtual object properties and/or one or more physical object properties). Examples of object property criteria are <color>=<blue>, <velocity>≥10 mph, and <proximity_state(ObjectID)>=<true>. In any embodiment disclosed herein in which satisfaction of some criterion triggers performance of an action, such a criterion may, for example, be an object property criterion. Any action disclosed herein may, for example, be triggered by (e.g., performed in response to and/or performed based on) the satisfaction (or lack of satisfaction) of an object property criterion. Although various examples of object property criteria are disclosed herein, embodiments of the present invention are not limited to such examples. Furthermore, any example of an object property criterion that is disclosed herein in connection with a particular object property (e.g., location) should be understood to be applicable to other object properties (e.g., proximity state). An object property criterion may, for example, be a primitive object property criterion (e.g., <color>=<blue>) or a compound object property criterion, which includes a plurality of primitive and/or compound object property criterion, such as may be related by Boolean connectors (e.g., (<color>=<blue> AND <owner>=<UserID1>)). As these examples illustrate, an object property criterion may, for example, define a value or set of values of an object property, such that the object property criterion is satisfied when the object property has the value or a value in the set of values. As another example, an object property criterion may define a change in value of an object property, such that the object property criterion is satisfied when the object property undergoes the change in value (e.g., when a proximity state of an object changes from <true> to <false>). More generally, an object property criterion may define any function of an object property, such that the object property criterion is satisfied when the function of the object property is equal to <true> or some other predetermined value.

### DETAILED DESCRIPTION

In at least some embodiments, a person (e.g., a first person, a first user) using a computing device (such as a portable computing device, e.g., a mobile phone or smart watch) having a built-in physical object detector (e.g., a radio receiver, camera, and/or microphone, all of which are examples of a first physical object detector) is in non-proximity with a physical object (e.g., a thing, place, and/or person, all of which are examples of a first physical object). The person and the computing device subsequently relocate and/or come into proximity (from the earlier position of non-proximity) with the physical object. In the embodiment, the physical object includes a physical object-associated element (e.g., a printed code, QR code, barcode, identifying image, RFID transmitter tag, NFC transmitter tag, Bluetooth transmitter tag, speaker, and/or first physical object, all of which are examples of a first physical object-associated element) that is associated with—attached to, integrated with, printed on, or otherwise associated with—the physical object. In the embodiment, when the physical object detector (that may be associated with a user's computing device and the user, or with another system element), and the physical object-associated element (that is associated with the physical object) are in proximity with each other, a signal (e.g., a electromagnetic signal, radio signal, visual signal, optical signal, and/or audio/sound signal, all of which are examples of a first signal) is actively or passively communicated by the physical object-associated element, and is received by the physical object detector. In the embodiment, the user, the physical object, the physical object-associated element and the physical object detector exist in the physical environment. In the embodiment, the physical object-associated element (along with its associated physical object), and the physical object detector (along with any computing device or user associated with it), are not the same physical objects, and are distinct from each other. In the embodiment, a value identification module (e.g., at the computing device, processor, and/or remote computer, all of which are examples of a first value identification module) identifies a value (e.g., a first value) based on the signal communicated by the physical object-associated element (and received or otherwise detected by the physical object detector), whereby the value is associated with the signal. In the embodiment, the value is also associated with the physical object (e.g., the value represents an identity of the physical object and/or a characteristic of the physical object). In the embodiment, a virtual object identification module (e.g., at the computing device, processor, and/or remote computer, all of which are examples of a first virtual object identification module) identifies a first virtual object based on the first value. In the embodiment, the value is communicated (e.g., transmitted) from the value identification module to the virtual object identification module (which receives the value). These modules may be embodied as the same processing module, or as distinct processing modules which may be co-located (e.g., integrated, attached, or coupled to each other) or physically separate from each other. In the embodiment, a virtual environment output device (e.g., virtual reality headset, augmented reality device, and/or mixed reality device, all of which are examples of a first virtual environment output device) manifests a manifestation (e.g., a first manifestation) of the virtual object in a manifestation of the virtual environment (e.g., first virtual environment). In the embodiment, a user may perceive the manifestation of the virtual object that is manifested in the virtual environment using the virtual environment output device.

In a second embodiment of the present invention, following manifestation of the virtual object in the virtual environment, for example, a user (and the user's computing device that includes a physical object detector) relocates or moves to subsequently be in non-proximity (not in proximity) with the physical object (and the physical object's physical object-associated element that communicates the signal). In this embodiment, based on the non-proximity, the system determines that the user's computing device is in non-proximity with the physical object (e.g., by means of no longer receiving the signal at the physical object detector, by means of determining an absence of the signal at the physical object detector, by means of determining a change in a signal-related characteristic such as the signal's strength, by means of the information communicated by the signal, by other means of determining that the physical object-associated element and the physical object detector are in non-proximity with each other, or by means of determining that the physical object-associated element is in proximity with a physical object other than the first or originally detected physical object). Based on the determination of non-proximity, the embodiment subsequently revises or updates the manifestation of the virtual object, such as by changing the manifestation of the virtual object (or one or more properties of the virtual object) in the manifestation of the virtual environment, or by removing or deleting the manifestation of the virtual object from the manifestation of the virtual environment.

For example, a user walks from inside her home, where she is in non-proximity (not in proximity) with her bicycle, to a location outside of her home near where her bicycle is stored, to be in proximity with her bicycle. In at least some embodiments, proximity between the user and her bicycle is determined or identified by means of a Bluetooth Low Energy tag (a form of physical object-associated element), such as a tag attached to the frame of her bicycle, which communicates a radio signal that is received by a radio receiver (a form of physical object detector) in a mobile device that she carries with her in her pocket. Receipt of the signal is passive and does not (in this example) require any user action or intervention. The signal contains information that represents the identity of the user's bicycle. Based on this information (e.g., a value), the system identifies a virtual object, such as a virtual object representing a virtual bicycle that simulates the user's physical bicycle. This virtual object—the virtual object representing the user's virtual bicycle—is then manifested, by a virtual environment output device, in a virtual environment. The virtual object may be stored in at least one non-transitory computer-readable medium, for example. The virtual object may be manifested by one or more virtual environment output means (e.g., in response to and/or concurrent with the user's use of the bike, or at another time). The user's personalized avatar may be simulated as riding her virtual bicycle in the virtual environment, for example. In the embodiment, at a later time, when the user parks her physical bicycle and moves away from it (e.g., transitions from proximity to non-proximity with her physical bicycle, such as may be determined by determining that the user's mobile device has transitioned from proximity to non-proximity with her physical bicycle), the system may identify the non-proximity between the user and her physical bicycle, and no longer show her avatar riding her virtual bicycle in the virtual environment. In another embodiment, at a later time, when the user parks her physical bicycle and moves away from it (e.g., transitions from proximity to non-proximity with her physical bicycle, such as may be determined by determining that the user's mobile device has transitioned from proximity to non-proximity with her physical bicycle), the system may determine the non-proximity between the user and her physical bicycle, and no longer show her bicycle in the virtual environment (e.g., by removing a previously-generated manifestation of the bicycle from a manifestation of the virtual environment). Other methods, scenarios, system elements, physical objects, and more, are within the scope of embodiments of the present invention.

In some embodiments of the present invention, a user may control or change (e.g., update, modify) a position of an avatar of the user in an embodiment of a virtual environment, such as to enable the user to explore or move around the virtual environment via the user's avatar. In some embodiments of the invention, a user may control or change (e.g., update, modify) the user's view of an embodiment of a virtual environment, such as to enable the user to explore, or move around in, the virtual environment. This may enable the user to view the virtual environment from a new perspective or vantage point, or in a new or different way. Such control of the user's position in, or view of, the virtual environment may be facilitated by a virtual environment control means, which may be operated or controlled by a user. At least some embodiments of a virtual environment control means may be or include, without limitation, finger operated or hand-held means, body worn means, sensor means, brain interface means, physiologic sensor means, camera means, a touch screen, and/or eye tracking means. At least some embodiments of a virtual environment control means may be integrated with a virtual environment output device.

In at least some embodiments of the present invention, a user may be able to manipulate a virtual object in a virtual environment. This may enable a user to change, alter, modify, update, add to, subtract from, and/or remove a virtual object in the virtual environment. Such control of the user's position in, or view of, the virtual environment may be facilitated by a virtual environment control means (which may control any aspect(s) of a virtual environment, such as one or more virtual objects in the virtual environment and/or ambient properties of the virtual environment, such as temperature and time), which may be operated or controlled by a user. At least some embodiments of a virtual environment control means may be or include, without limitation, finger operated or hand-held means, body worn means, sensor means, brain interface means (e.g., one or more neural sensors, such as one or more neural implants), physiologic sensor means, camera means, a touch screen, and/or eye tracking means. At least some embodiments of a virtual environment control means may be integrated with a virtual environment output device.

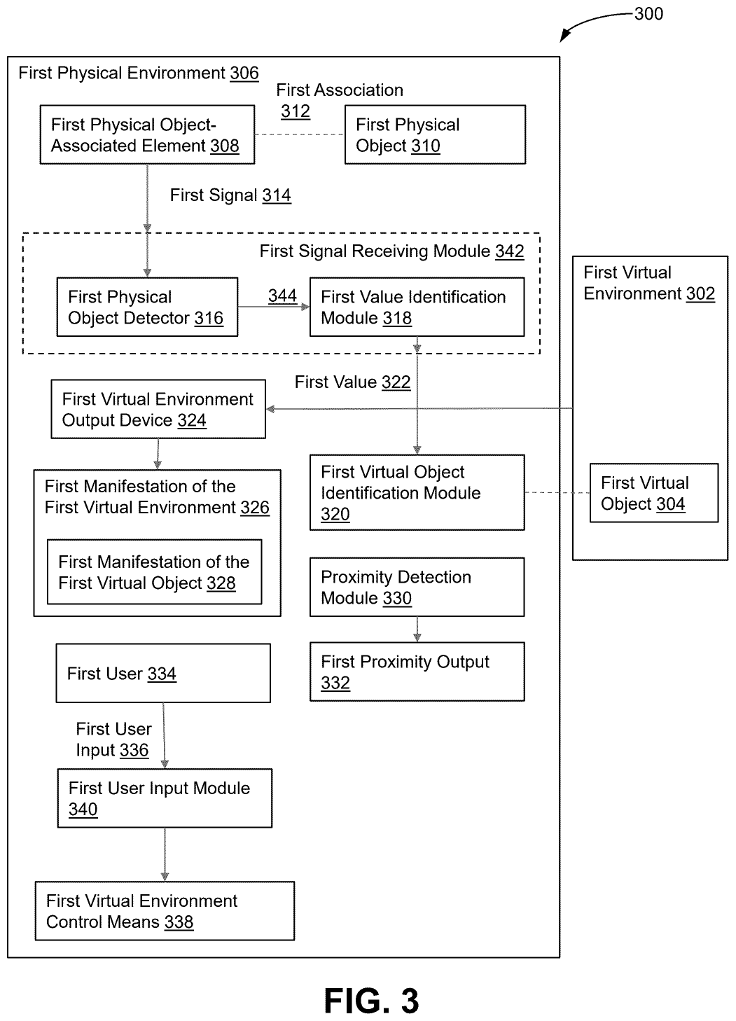

For example, referring to FIG. 3, a diagram is shown of a system 300 for manifesting a first virtual object 304 in a first virtual environment 302, in accordance with one or more embodiments of the invention. For example, in general, a first user 334 may provide, via a virtual environment controls means 338, first user input 336 to an embodiment of the present invention, which may, in response to and/or based on the first user input 336, perform any of the operations disclosed herein on one or more virtual objects (e.g., the first virtual object 304) in the first virtual environment 302, such as any one or more of the following, in any combination:
changing, altering, modifying, updating, adding to, and/or subtracting from one or more properties of one or more virtual objects (e.g., the first virtual object 304) in the first virtual environment 302;
adding one or more virtual objects to the first virtual environment 302;
removing one or more virtual objects (e.g., the first virtual object 304) from the first virtual environment 302;
performing any of the above on one or more properties of the first virtual environment 302, such as temperature or time, which are not associated with any particular virtual object(s) in the first virtual environment 302.

The first user 334 may provide any such input 336 to the first virtual environment control means 338 either actively or passively. An example of providing such input 336 actively is intentionally moving the first user 334's legs to provide input that instructs the first virtual environment control means 338 to detect such movement and cause an avatar of the first user 334 to walk in the first virtual environment 302. An example of providing such input 336 passively is the first virtual environment control means 338 using a heart rate monitor to detect the first user 334's heart rate (with or without the first user 334's intention to provide the first user 334's heart rate as input to the first virtual environment control means 338) and generating input based on the first user 334's heart rate.

Embodiments of the present invention may generate, based on any such input 336 to the first virtual environment control means 338, data representing an estimate or prediction of a physiological (e.g., emotional) state of the first user 334. Embodiments of the present invention may use such data (instead of or in addition to the original user input 336) to perform any of the functions disclosed herein, such as to modify the first virtual environment 302 and/or to modify one or more virtual objects (e.g., the first virtual object 304).

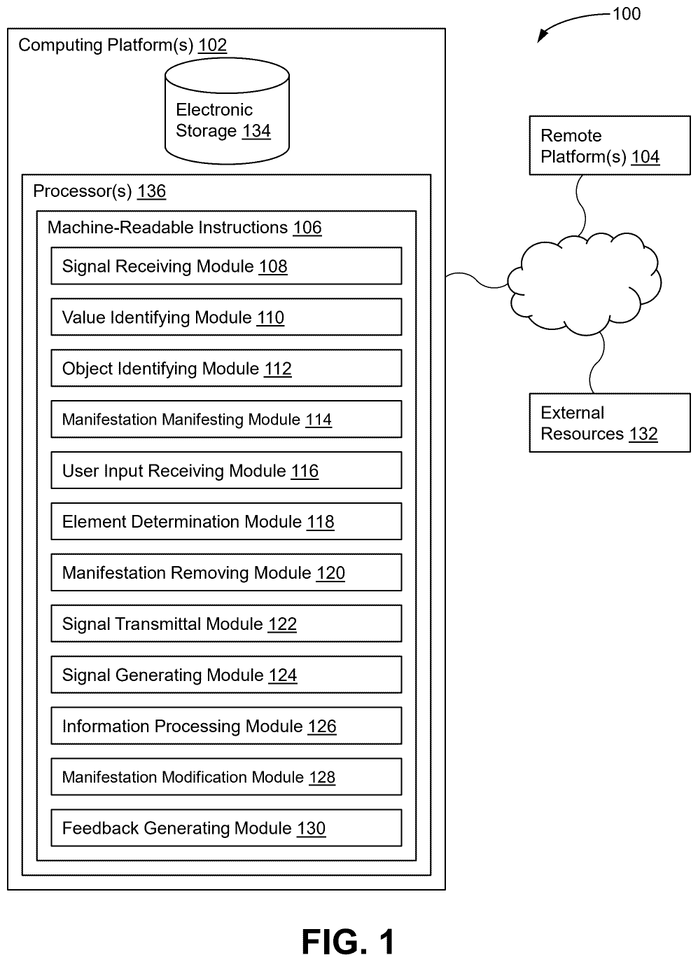

FIG. 1 illustrates a system 100 configured for manifesting a virtual object in a virtual environment, in accordance with one or more embodiments. In some embodiments, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

As described above, FIG. 3 illustrates a system 300 for manifesting a first virtual object 304 in a first virtual environment 302, in accordance with one or more embodiments of the invention. Some of the elements of the system 100 of FIG. 1 may perform some or all of the same functions as corresponding elements of the system 300 in FIG. 3, and vice versa. For example,
the signal receiving module 108 may perform some or all of the same functions as the first physical object detector 316, and vice versa;
the value identifying module 110 may perform some or all of the same functions as the first value identification module 318, and vice versa;
the object identifying module 112 may perform some or all of the same functions as the first virtual object identification module 320, and vice versa;
the manifestation manifesting module 114 may perform some or all of the same functions as the first virtual environment output device 324, and vice versa;
the user input receiving module 116 may perform some or all of the same functions as the first user input module 340, and vice versa;
the element determination module 118 may perform some or all of the same functions as the proximity detection module 330, and vice versa;
the manifestation removing module 120 may perform some or all of the same functions as the first virtual environment output device 324, and vice versa; and
the manifestation modification module 128 may perform some or all of the same functions as the first virtual environment output device 324, and vice versa.

As a result, any reference herein to one of the modules in any of the pairs of modules listed above should be understood to be equally applicable to the corresponding module in that pair.

Computing platform(s) 102 may be configured by machine-readable instructions 106. Machine-readable instructions 106 may include one or more instruction modules. The instruction modules may include computer program modules. The instruction modules may include one or more of signal receiving module 108, value identifying module 110, object identifying module 112, manifestation manifesting module 114, user input receiving module 116, element determination module 118, manifestation removing module 120, signal transmittal module 122, signal generating module 124, information processing module 126, manifestation modification module 128, feedback generating module 130, and/or other instruction modules.

Signal receiving module 108 may be configured to receive, at a first physical object detector 316, a first signal 314, from a first physical object-associated element 308 in a first physical environment 306. The first physical object-associated element 308 may be associated with a first physical object 310 in the first physical environment 306. A first association 312 between the first physical object-associated element 308 and the first physical object 310 may, for example, be represented and stored in the system 300 in the form of any kind of data. Receiving the first signal 314 may include receiving the first signal 314 wirelessly. Receiving the first signal 314 may include receiving the first signal 314 from the first physical object-associated element 308 without any physical contact between the first physical object detector 316 and the first physical object-associated element 308. Receiving the first signal 314 may include receiving the first signal 314 from the first physical object-associated element 308 with physical contact between the first physical object detector 316 and the first physical object-associated element 308.

Receiving the first signal 314 may include receiving the first signal 314 automatically from the first physical object-associated element 308. Receiving the first signal 314 automatically from the first physical object-associated element 308 may include receiving the first signal 314 without facilitation by the first user 334 or any other user.

The first signal 314 may be or include a first electromagnetic signal, and receiving the first signal 314 may include receiving the first signal 314 via an electromagnetic receiver means. The electromagnetic receiver means may include a radio receiver. The electromagnetic receiver means may include a radio frequency identification (RFID) tag receiver means (e.g., an RFID tag receiver). The electromagnetic receiver means may include a near-field communication (NFC) tag receiver means (e.g., an NFC tag receiver). The electromagnetic receiver means may include a Bluetooth receiver means and/or a Bluetooth Low Energy (BLE) receiver means. The radio receiver may receive an electromagnetic signal, which may be transmitted by a radio transmitter. A transmitter may be a tag. A transmitter may be associated with a physical object-associated element, or with another element of an embodiment of a system of the invention.

The first signal 314 may be or include a first optical signal, and receiving the first signal 314 may include receiving the first signal 314 via an optical receiver means. The optical receiver means may include a camera. The optical receiver means may include one or more lenses. The optical receiver means may include a light sensor, or a multi-dimensional array of light sensors. The camera may be associated with (e.g., be contained within or coupled to) a mobile communication device (such as a mobile phone), and may furthermore include one or more lenses. The first signal may include an optical signal. The optical signal may be communicated (e.g., transmitted) by a physical object, or by an image (such as an image that is printed on a physical object), or by other optical signal generating means. Such an optical signal may be received by an optical signal receiver means. The optical signal may actively generate light, and/or the optical signal may reflect otherwise generated (e.g., ambient) light, in order to communicate an optical signal that is capable of being received by an optical signal receiver means.

Embodiments of the present invention may apply various image recognition techniques to the first signal 314 when the first signal 314 comprises an optical (e.g., visual) signal or a signal produced by an optical sensor, for example, to produce image recognition output. The first value identification module 318 may implement one or more image recognition algorithms to analyze visual content contained within the first signal 314 received from the first physical object-associated element 308. The image recognition techniques may include, for example, optical character recognition (OCR) for identifying text elements, barcode recognition for decoding linear or matrix barcodes, QR code recognition for processing quick response codes, shape recognition for identifying geometric patterns, color analysis for detecting specific color combinations, and/or pattern matching for recognizing predefined visual markers, as well as other image recognition techniques or methods, including those capable of recognizing object characteristics including, for example: size, shape, color, branding, movement, and/or behavior.

The image recognition output generated by these techniques may provide structured data that represents the visual content of the first signal 314. The first value identification module 318 may process this image recognition output to derive the first value 322 associated with the first signal 314. The image recognition output may include, for example, decoded text strings from OCR processing, numerical identifiers extracted from barcode scanning, alphanumeric codes retrieved from QR code analysis, geometric measurements from shape recognition, color values from color analysis, and/or confidence scores indicating the reliability of the recognition results.

Embodiments of the system 300 may implement machine learning-based image recognition techniques that may improve recognition accuracy over time. The first value identification module 318 may utilize trained neural networks, convolutional neural networks, or other machine learning models to analyze the first signal 314 and generate image recognition output. These machine learning approaches may enable the system to recognize complex visual patterns, adapt to variations in lighting conditions, accommodate different viewing angles, and/or handle partially obscured or damaged visual elements within the first signal 314. The image recognition output from these advanced techniques may provide enhanced accuracy and robustness compared to traditional rule-based recognition methods.

The first signal 314 may be or include a first audio signal, and receiving the first signal 314 may include receiving the first signal 314 via an audio receiver means. The audio receiver means may include a microphone. The audio receiver means may include a sound amplifier. The audio receiver means may include an audio processing means. The first physical object detector 316 may include an audio receiver means.

The first audio signal may be communicated (e.g., transmitted) by a physical object, or by an audio signal generating means associated with the physical object. The first audio signal may be a natural sound created, synthesized, or produced by the physical object, or otherwise communicated by the physical object. The first audio signal may be communicated by a speaker or other sound generating means. The first audio signal may be received by an audio signal receiver. An audio signal receiver may include a microphone, and/or another sensor that is capable of receiving an audio or sound signal and generating output based on the received audio or sound signal.

Embodiments of the present invention may apply various audio recognition techniques to the first signal 314 when the first signal 314 comprises an audio signal, for example, to produce audio recognition output. The first value identification module 318 may implement one or more audio recognition algorithms to analyze audio content contained within the first signal 314 received from the first physical object-associated element 308. The audio recognition techniques may include, for example, speech recognition for identifying spoken words or phrases, sound pattern recognition for detecting specific audio signatures, frequency analysis for identifying characteristic sound frequencies, amplitude analysis for detecting volume patterns, and/or audio fingerprinting for recognizing predefined audio markers, as well as other audio recognition methods.

The audio recognition output generated by these techniques may provide structured data that represents the audio content of the first signal 314. The first value identification module 318 may process this audio recognition output to derive the first value 322 associated with the first signal 314. The audio recognition output may include, for example, transcribed text from speech recognition processing, numerical identifiers extracted from audio pattern analysis, frequency measurements from spectral analysis, amplitude measurements from volume analysis, and/or confidence scores indicating the reliability of the recognition results.

Embodiments of the system 300 may implement machine learning-based audio recognition techniques that may improve recognition accuracy over time. The first value identification module 318 may utilize trained neural networks, recurrent neural networks, or other machine learning models to analyze the first signal 314 and generate audio recognition output. These machine learning approaches may enable the system to recognize complex audio patterns, adapt to variations in acoustic conditions, accommodate different speaker voices or sound sources, and/or handle background noise or audio interference within the first signal 314.

The audio recognition output from these advanced techniques may provide enhanced accuracy and robustness compared to traditional rule-based recognition methods.

Other signal types, receiver means, and signal recognition/identification methods fall within the scope of embodiments of the present invention, including other signal types that use energy (e.g., electromagnetic energy, chemical energy) to communicate a signal.

A first mobile communication device may include the first physical object detector 316. A mobile communication device may be, for example and without limitation, a mobile phone (e.g., an Apple iPhone), a tablet computer (e.g., an Apple iPad), a laptop computer (e.g., an Apple MacBook Air), or a wearable computer (e.g., an Apple Watch).

The first physical object detector 316 may be physically distinct from the first physical object-associated element 308. The first physical object detector 316 may be physically distinct from the first physical object 310.

The first physical object-associated element 308 may communicate a visual image. The visual image may, for example, be on (e.g., printed on) or manifested by the first physical object. The visual image may provide the first signal. Receiving the first signal 314 from the first physical object-associated element 308 may include receiving the first signal 314 from the first physical object-associated element 308 using optical receiver means (e.g., to receive the visual image). The visual image may communicate the first signal 314 to the first physical object detector 316. The first physical object detector 316 may include optical receiver means. The visual image may include a code, such as a QR code and/or a bar code. The visual image may include another type or form of visual code. The visual image may include at least one color. The visual image may include a black and white, single-color, and/or multi-color image. The visual image may communicate (e.g., contain data representing) an identity of the physical object. The visual image may be unique. The visual image may be non-unique (e.g., the visual image may represent a category, class, or type of physical object). In embodiments, the visual image may also represent at least one characteristic of a physical object, in place of or in addition to an identity of the physical object, such as the category, class, type, color, feature, feature set, capacity, capability, position, location, and/or other characteristic of a physical object. The visual image may be static (e.g., unchanging) or dynamic (e.g., changing, such as according to a state of the physical object). A dynamic image may, for example, communicate (e.g., include data representing) information that includes an identity of the physical object, as well as a changing characteristic associated with the physical object (e.g., the physical object's temperature) or its environment (e.g., the ambient temperature of the physical object's physical environment).

The first physical object-associated element 308 may include a wireless signal transmitter. The wireless signal transmitter may provide (e.g., communicate) the first signal 314. Receiving the first signal 314 from the first physical object-associated element 308 may include receiving the first signal 314 wirelessly from the first physical object-associated element 308 using wireless receiver means. The first physical object detector 316 may include wireless receiver means. The wireless signal transmitter may wirelessly communicate the first signal 314 to the first physical object detector 316. The wireless signal transmitter may include a near field communication (NFC) transmitter (tag). The wireless signal transmitter may include a radio frequency identification (RFID) transmitter (tag). A RFID transmitter tag may be passive. A RFID transmitter tag may be active. An NFC tag, RFID tag, or other similar wireless communication means may wirelessly (e.g., contactlessly) communicate a signal containing information, such as an identity of the tag, or an identity of a physical object with which the tag is associated. The first signal 314 may communicate (e.g., contain data representing) an identity of the physical object. The first signal 314 may be unique. The first signal 314 may be non-unique (e.g., the first signal 314 may represent a category, class, or type of physical object). In embodiments, the first signal 314 may also represent at least one characteristic of a physical object, in place of or in addition to an identity of the physical object, such as the category, class, type, color, feature, feature set, capacity, capability, position, location, and/or other characteristic of a physical object. The first signal 314 may be static (e.g., unchanging) or dynamic (e.g., changing, such as according to a state of the physical object). A dynamic signal may, for example, communicate (e.g., include data representing) information that includes an identity of the physical object, as well as a changing characteristic associated with the physical object (e.g., the physical object's temperature) or its environment (e.g., the ambient temperature of the physical object's physical environment).

The first physical object-associated element 308 may include a sound generating means. The sound generator means may include a speaker. The sound generator means may be, be included in, or include the first physical object 310. The sound generator means may be the vocalization apparatus (e.g., vocal chords) of a person. A sound may include music or be musical. A sound may include a voice. A sound may include a sound produced by the first physical object. Receiving the first signal 314 from the first physical object-associated element 308 may include receiving the first signal 314 from the first physical object-associated element 308 using sound receiver means. The sound receiver means may include a microphone. The sound receiver means may include a sound amplifier. The sound receiver means may include an audio processing means. The first physical object detector 316 may include a sound receiver means. The sound generator means may communicate the first signal 314 to the first physical object detector 316. The sound generator means may include a speaker. The words “sound” and “audio” are used interchangeably herein, e.g., sound receiver means has the same meaning as audio receiver means. The sound may communicate (e.g., contain data representing) an identity of the physical object. The sound may be unique. The sound may be non-unique (e.g., the sound may represent a category, class, or type of physical object). In embodiments, the sound may also represent at least one characteristic of a physical object, in place of or in addition to an identity of the physical object, such as the category, class, type, color, feature, feature set, capacity, capability, position, location, and/or other characteristic of a physical object. The sound may be static (e.g., unchanging) or dynamic (e.g., changing, such as according to a state of the physical object). A dynamic sound may, for example, communicate (e.g., include data representing) information that includes an identity of the physical object, as well as a changing characteristic associated with the physical object (e.g., the physical object's temperature) or its environment (e.g., the ambient temperature of the physical object's physical environment).

Determining that the first physical object-associated element 308 is in proximity to the first physical object detector 316 may include determining that the first physical object-associated element 308 is in proximity to the first physical object detector 316 based on the first signal 314. Determining that the first physical object-associated element 308 is in proximity to the first physical object detector 316 may include determining that the first physical object-associated element 308 is in proximity to the first physical object detector 316 in response to receiving the first signal 314. Determining that the first physical object-associated element 308 is in proximity to the first physical object detector 316 may include determining that the first physical object-associated element 308 is in substantially the same place as the first physical object detector 316 at substantially the same time. Receiving the first signal 314 may be performed in response to determining that the first physical object-associated element 308 is in proximity to the first physical object detector 316 in the first physical environment 306. In various embodiments, a determination of proximity between the first physical object-associated element 308 and the first physical object detector 316 may be a proxy for a determination of proximity between the first physical object 310 and the first user 334 (such as a user of a mobile device or virtual environment output device that includes an object detector).

Identifying the first value associated with the first signal 314 may be performed in response to determining that the first physical object-associated element 308 is in proximity to the first physical object detector 316 in the first physical environment 306. Identifying the first virtual object 304 may be performed in response to determining that the first physical object-associated element 308 is in proximity to the first physical object detector 316 in the first physical environment 306. Manifesting the first manifestation of the first virtual object 328 may be performed in response to determining that the first physical object-associated element 308 is in proximity to the first physical object detector 316 in the first physical environment 306. Determining that the first physical object-associated element 308 is in proximity to the first physical object detector 316 in the first physical environment 306 may be performed in response to determining that the first physical object-associated element 308 is in proximity to the first physical object detector 316 in the first physical environment 306.

The system 100 may also include an element determination module 118. The element determination module 118 and/or the proximity detection module 330 may determine that the first physical object-associated element 308 is in proximity to the first physical object detector 316 in the first physical environment 306, and which may generate first proximity output 332 based on the determination. The first proximity output 332 may, for example, represent a value of “in proximity” or “not in proximity,” depending on the result of the determination performed by the element determination module 118. Determining that the first physical object-associated element 308 is in proximity to the first physical object detector 316 in the first physical environment 306 may include determining that the first physical object-associated element 308 is in proximity to the first physical object detector 316 in the first physical environment 306 based on a presence of the first signal 314. Determining that the first physical object-associated element 308 is in proximity to the first physical object detector 316 in the first physical environment 306 may include determining that the first physical object-associated element 308 is in proximity to the first physical object detector 316 based on the content of the first signal 314.

The element determination module 118 and/or the proximity detection module 330 may, additionally or alternatively, determine that the first physical object-associated element 308 is not in proximity to the first physical object detector 316 in the first physical environment 306. For example, the element determination module 118 may, additional or alternatively, determine, based on the first signal 314, that the first physical object-associated element 308 is not in proximity to the first physical object detector 316 in the first physical environment 306.

Determining that the first physical object-associated element 308 is not in proximity to the first physical object detector 316 in the first physical environment 306 may include determining that the first physical object-associated element 308 is not in proximity to the first physical object detector 316 based on an absence of the first signal 314. Determining that the first physical object-associated element 308 is not in proximity to the first physical object detector 316 in the first physical environment 306 may include determining that the first physical object-associated element 308 is not in proximity to the first physical object detector 316 in the first physical environment 306 in response to an absence of the first signal 314. Determining that the first physical object-associated element 308 is not in proximity to the first physical object detector 316 in the first physical environment 306 may include determining that the first physical object-associated element 308 is not in proximity to the first physical object detector 316 in the first physical environment 306 in response to not receiving the first signal 314. Determining that the first physical object-associated element 308 is not in proximity to the first physical object detector 316 in the first physical environment 306 may include determining that the first physical object-associated element 308 is not in proximity to the first physical object detector 316 in the first physical environment 306 based on a change in the first signal 314. Determining that the first physical object-associated element 308 is not in proximity to the first physical object detector 316 in the first physical environment 306 may include determining that the first physical object-associated element 308 is not in proximity to the first physical object detector 316 in the first physical environment 306 based on the content of the first signal 314. Determining that the first physical object-associated element 308 is not in proximity to the first physical object detector 316 in the first physical environment 306 may include determining that the first physical object-associated element 308 is not in proximity to the first physical object detector 316 in the first physical environment 306 based on the strength of the first signal 314. Determining that the first physical object-associated element 308 is not in proximity to the first physical object detector 316 in the first physical environment 306 may include determining that the first physical object-associated element 308 is not in proximity to the first physical object detector 316 in the first physical environment 306 based on determining that the first physical object-associated element 308 is not in substantially the same location as the first physical object detector 316 at substantially the same time. Determining that the first physical object-associated element 308 is not in proximity to the first physical object detector 316 in the first physical environment 306 may include determining that the first physical object-associated element 308 is not in proximity to the first physical object detector 316 in the first physical environment 306 based on a second signal (not shown). The second signal may not be the first signal 314, and the second signal may be received from a second physical object-associated element (not shown) that is associated with a second physical object (not shown), wherein the second physical object-associated element is not the first physical object-associated element 308, and wherein the second physical object is not the first physical object.

Any determination of proximity or non-proximity disclosed herein may, for example, be performed based on, in whole or in part, the image recognition output disclosed herein. The element determination module 118 and/or the proximity detection module 330 may utilize image recognition output generated from the first signal 314 when the first signal 314 comprises an optical signal to determine whether the first physical object-associated element 308 is in proximity to the first physical object detector 316.

The proximity determination process may analyze the image recognition output to identify visual indicators of distance or spatial relationships between the first physical object-associated element 308 and the first physical object detector 316. As shown in FIG. 3, the system 300 may evaluate characteristics of the image recognition output such as the size, clarity, focus, or resolution of visual elements within the first signal 314 to infer proximity states. Larger, clearer, or more detailed visual elements in the image recognition output may indicate closer proximity, while smaller, less clear, or lower resolution elements may suggest greater distance or non-proximity conditions. The confidence scores included in the image recognition output may also serve as proximity indicators, where higher confidence scores in recognizing visual patterns may correlate with closer proximity between the detection components.

Machine learning-based image recognition techniques may enhance proximity determination capabilities by analyzing complex visual patterns within the first signal 314 that traditional rule-based methods might not detect. The first value identification module 318 may utilize trained neural networks or other machine learning models to process the first signal 314 and generate image recognition output that includes proximity-related features such as depth estimation, perspective analysis, or relative positioning data. This advanced image recognition output may enable more accurate proximity determinations by accounting for variations in lighting conditions, viewing angles, and environmental factors that may affect the visual characteristics of the first signal 314 received from the first physical object-associated element 308.

The first physical object 310 may be a thing. Byway of non-limiting example, the thing may be or include at least one of: an object, a personal object, a commercial object, an industrial object, a military object, an item of clothing, a shirt, a pair of pants, a jacket, a hat, a helmet, an item of protective gear, an item of footwear, a shoe, a sneaker, a mode of transportation, a bicycle, a motorcycle, an automobile, an aircraft, a plane, a helicopter, a boat, a ship, a drone, a scooter, an autonomous vehicle, a machine, equipment, a food item, a food preparation item, a food processor, a beverage maker, a coffee maker, a cup, a tool, a construction material, a house, an office, a factory, a room, a door, a shelf, a document, a piece of paper, a book, a magazine, a resource, a supply, and an implement.

The first physical object 310 may include a physical place. The physical place may include a residential setting. The physical place may include a commercial setting. The physical place may include an industrial setting. The physical place may include an outdoor setting. The physical place may include a natural setting. The first physical object may include a physical event. The physical event may include a performance. The physical event may include a concert. The physical event may include a meeting. The physical event may include a conference. The physical thing may include an experience.

The first physical object 310 may include a physical person. The physical person may include a first user (e.g., first user 334). The physical person may be a human. The physical person may be an animal. The first user may be a user of the first virtual environment output device 324. The first user may be someone who is not a user of the first virtual environment output device 324. The first physical object may be a user of a second physical object. The first physical object may be a user of a second virtual environment output device.

The first physical object 310 may include the first physical object-associated element 308. The first physical object-associated element 308 may be coupled to the first physical object 310. The first physical object-associated element 308 may be the first physical object 310. The first object-associated element may be attached to a surface of the first physical object 310. The first physical object-associated element 308 may be physically distinct from the first physical object 310. The first physical object-associated element 308 may communicate a signal, including the first signal 314. The first physical object-associated element 308 may communicate a signal by visual, light, audio, sound, radio, electromagnetic, wireless, or other signal communication or transmission means.

The first signal 314 may contain information representing an identity of the first physical object 310. The first signal 314 may contain information representing a code that is associated with an identity of the first physical object 310. The identity of the first physical object 310 may be a unique identity of the first physical object 310, e.g., an identity that is different from the identity of all other physical objects within the physical world, or at least within a particular physical environment (e.g., the first physical environment 306). The identity of the first physical object 310 may be a non-unique identity of the first physical object 310, e.g., an identity that is not different from the identity of all other physical objects within the physical world, or at least within a particular physical environment (e.g., the first physical environment 306). The non-unique identity of the first physical object 310 may include a class. The first physical object 310 may be an instance of the class.

Signal receiving module 108 may be configured to receive, at the first physical object detector 316, a second signal (not shown). Receiving the second signal may include receiving the second signal from the first physical object 310. Receiving the second signal may include transmitting the second signal from the first virtual environment output device 324 to a computer (e.g., over a network to a remote computer). Receiving the second signal may include transmitting the second signal from a mobile communication device to the computer (e.g., over a network to a remote computer). Receiving the second signal may include transmitting the second signal from a sensor device to a computer (e.g., over a network to a remote computer).

The sensor device may include a physiologic sensor. A physiologic sensor may sense a first physiologic parameter of a person, such as a user (e.g., the first user 334). The first physiologic parameter may be a heart rate, respiration rate, blood pressure, or any other physiologic parameter that may be sensed or measured. A sensed or measured physiologic parameter may have a corresponding value, such as a numeric representation of the number of heartbeats per minute of a person whose physiology is being measured. The physiologic sensor may include, for example, an electrical detector, sound detector (e.g., a microphone), light detector (e.g., camera or other optical sensor means). One or more sensed physiologic parameter values may be communicated to other elements of a system of the invention, and may be processed, analyzed, transformed, and outputted.

Signal receiving module 108 may be configured to receive, at the remote computer, the second signal. The second signal may be based on the first signal 314. The second signal may be based on the first value. The second signal may be based on the first virtual object 304.

Value identifying module 110 may be configured to identify, at a first value identification module 318, based on the first signal 314, a first value 322 associated with the first signal 314. The first signal 314 may contain information representing the first value 322. Identifying the first value 322 may include deriving the first value 322 from the first signal 314. Deriving the first value 322 from the first signal 314 may include performing an analysis on the first signal 314 to identify the first value 322. Identifying the first value 322 may include using the first signal 314 to look up the first value 322 in a library.

More generally, the first signal 314 may be received by a first signal receiving module 342, which may include the first physical object detector 316 and the first value identification module 318. The first physical object detector 316 may, for example, receive the first signal 314 via the first signal receiving module 342, and generate a first intermediate signal 344 based on and/or in response to the first signal 314. The first intermediate signal 344 may be the same as or differ from the first signal 314 in any of a variety of ways. Any reference herein to the first signal 314 are equally applicable to the first intermediate signal 344, and vice versa. The first value identification module 318 may receive the first intermediate signal 344 from the first physical object detector 316. The first signal receiving module 342 may output the first value 322.

Identifying the first value 322 may include applying a model to the first signal 314 to identify the first value 322. The model may include a neural network. Identifying the first value 322 may include applying a rule to the first signal 314 to identify the first value 322. Identifying the first value 322 may include applying machine learning or artificial intelligence to the first signal 314 to identify the first value 322. Identifying the first value 322 may be performed based on receiving the first signal 314. Identifying the first value 322 may be performed in response to receiving the first signal 314. The first value 322 may represent an identity of the first physical object 310. The identity of the first physical object 310 may be unique or not unique.

The identity of the first physical object 310 may include a commercial identity of the first physical object 310. A commercial identity of a physical object may be a brand of the physical object. A commercial identity of a physical object may be a product type of the physical object. A commercial identity of a physical object may be a trademarked or trademarkable aspect of the physical object (e.g., a brand or a representation of a brand). The identity of the first physical object may include a unique identity of the first physical object. A unique identity of a physical object may indicate that the particular physical object is the only (sole) instance of that physical object that exists in the known physical world (e.g., an original Picasso painting). The identity of the first physical object may include a non-unique identity of the first physical object. A non-unique identity of a physical object may indicate that a particular physical object is one of multiple copies of that physical object that exists in the known physical world (e.g., a specific model of a product of which thousands are made every year). A non-unique identity of the first physical object may be a class, wherein the first physical object is a representative member (or instance) of the class. A class may be a brand. A non-unique identity of the first physical object may be a category, wherein the first physical object is a representative member (or instance) of the category.

The first value 322 may include a value of a first parameter. The first parameter may include a first characteristic of the first physical object 310. A characteristic of a physical object may be a feature, attribute or element of the physical object. The first value 322 may represent an identifier (that represents an identity) of the first physical object 310. The first value 322 may be associated with the first physical object. The first parameter may include a first characteristic of the first physical environment 306. A characteristic of a physical environment may be a feature, attribute or element of the physical environment. The first parameter may include a first characteristic of a first user of the first virtual environment output device 324 (e.g., the first user 334). A characteristic of a user may be a feature, attribute or behavior of the user. The first characteristic of the first user of the first virtual output device may include a language being spoken by the first user. The first characteristic of the first user of the first virtual output device may be a physiologic measurement of the first user.

Non-limiting examples of physiologic measurements and physiologic parameters that may be measured, sensed, and/or analyzed include core vital parameters such as heart rate, blood pressure, respiratory rate, body temperature, and/or oxygen saturation. Cardiovascular parameters may include cardiac output, stroke volume, blood volume, central venous pressure, and/or total peripheral resistance. Respiratory parameters may include tidal volume, vital capacity, residual volume, arterial PO₂, and/or arterial PCO₂. Blood and plasma chemistry measurements may include hemoglobin, hematocrit, plasma sodium, plasma potassium, plasma bicarbonate, blood glucose, and/or plasma cortisol. Metabolic measures may include basal metabolic rate, blood urea nitrogen, cholesterol and triglycerides, and/or body mass index. Fluid and electrolyte balance parameters may include body water, extracellular fluid and intracellular fluid volumes, plasma osmolarity, and/or urine output. Neurological and muscular parameters may include resting membrane potential and/or nerve conduction velocity.

Value identifying module 110 may be configured to identify, at the first value identification module 318, based on the second signal, a second value (not shown). The second value may represent a property of the first physical object 310 other than the identifier of the first physical object 310. The second signal may be received from a second physical object or an object-associated element that is associated with the second physical object (neither are shown). The second physical object may be distinct from the first physical object 310. The second value may include a location (or any other property) of the second physical object. The second physical object may include a computing device. The second value may include an identifier of the computing device. The second value may include an identifier of an application executing on the computing device. The second physical object may include a user of the first physical object 310. The second value may include an identifier of the user of the first physical object 310. The second value may include a physiologic measurement of the user of the first physical object 310. The second value may represent a state of a user of the second physical object. The state of the user of the second physical object may include an emotional state of the user of the second physical object. The method may include receiving the first signal 314 at a first time, and receiving the second signal at a second time that is later than (after) the first time. The method may include receiving a first value that represents a first value of a first parameter of the first physical object 310 at the first time, and receiving a second value that represents a second value of the first parameter of the first physical object 310 at a second time.

Object identifying module 112 may be or include a first virtual object identification module 320. The first virtual object identification module 320 may be configured to identify, based on the first value 322, the first virtual object 304 and/or a first virtual entity represented by the first virtual object 304.

Identifying the first virtual object 304 may include selecting the first virtual object 304 from a library of virtual objects. Identifying the first virtual object 304 may include generating the first virtual object 304. Identifying the first virtual object 304 may include selecting an existing virtual object in the first virtual environment 302 as the first virtual object 304. Identifying the first virtual object 304 may include modifying an existing virtual object in the first virtual environment 302. Identifying the first virtual object 304 may include replacing an existing virtual object in the first virtual environment 302 with the first virtual object 304. Identifying the first virtual object 304 may include replicating an existing virtual object in the first virtual environment 302. Identifying the first virtual object 304 may include removing an existing virtual object from the first virtual environment 302. The first virtual object 304 may have the first value 322. The first virtual object 304 may not have the first value 322.

Identifying the first virtual entity may include selecting the first virtual entity from a library of virtual entities. Identifying the first virtual entity may include generating the first virtual entity. Identifying the first virtual entity may include selecting an existing virtual entity in the first virtual environment 302 as the first virtual entity. Identifying the first virtual entity may include modifying an existing virtual entity in the first virtual environment 302. Identifying the first virtual entity may include replacing an existing virtual entity in the first virtual environment 302 with the first virtual entity. Identifying the first virtual entity may include replicating an existing virtual entity in the first virtual environment 302. Identifying the first virtual entity may include removing an existing virtual entity from the first virtual environment 302. The first virtual entity may have the first value. The first virtual entity may not have the first value.

Identifying the first virtual object 304 may be performed based on receiving the first signal 314. Identifying the first virtual object 304 may be performed in response to receiving the first signal 314. Identifying the first virtual object 304 may be performed based on information contained in (or communicated by) the first signal 314.

Identifying the first virtual entity may be performed based on receiving the first signal 314. Identifying the first virtual entity may be performed in response to receiving the first signal 314. Identifying the first virtual entity may be performed based on information contained in (or communicated by) the first signal 314.

Identifying the first virtual object 304 may be performed based on identifying the first value 322. Identifying the first virtual object 304 may be performed in response to identifying the first value 322. Identifying the first virtual object 304 may be performed based on information contained in (or communicated by) the first value 322.

Identifying the first virtual entity may be performed based on identifying the first value 322. Identifying the first virtual entity may be performed in response to identifying the first value 322. Identifying the first virtual entity may be performed based on information contained in (or communicated by) the first value 322.

As described above, embodiments of the present invention may apply various image recognition techniques to the first signal 314 when the first signal 314 comprises an optical signal, for example, to produce image recognition output 70. The image recognition output generated by these techniques may provide structured data that represents the visual content of the first signal 314. The first value identification module 318 may process this image recognition output to derive the first value 322 associated with the first signal 314. The image recognition output may include, for example, decoded text strings from OCR processing, numerical identifiers extracted from barcode scanning, alphanumeric codes retrieved from QR code analysis, geometric measurements from shape recognition, color values from color analysis, and/or confidence scores indicating the reliability of the recognition results.

Embodiments of the present invention may apply various audio recognition techniques to the first signal 314 when the first signal 314 comprises an audio signal, for example, to produce audio recognition output. The audio recognition output generated by these techniques may provide structured data that represents the audio content of the first signal 314. The first value identification module 318 may process this audio recognition output to derive the first value 322 associated with the first signal 314. The audio recognition output may include, for example, transcribed text strings from speech recognition processing, numerical identifiers extracted from audio tone analysis, alphanumeric codes retrieved from audio frequency modulation decoding, acoustic measurements from sound pattern recognition, amplitude values from volume analysis, frequency characteristics from spectral analysis, and/or confidence scores indicating the reliability of the recognition results.

The first virtual object 304 may be or include a first simulation of the first physical object 310. The first virtual object 304 may be or include a first representation of the first physical object 310. A virtual object (e.g., the first virtual object 304) may be or include a simulation or representation of a physical person, a physical living organism, a physical place, a physical setting, a physical location, a physical thing, a physical object, and an item made of physical atoms.

The first virtual object 304 may simulate or represent a physical thing (e.g., the first physical object 310). The first virtual object 304 may be a simulation or representation of a physical thing (e.g., the first physical object 310). Byway of non-limiting example, the physical thing (that the first virtual object 304 simulates or represents) may be or include at least one of: an object, a personal object, a commercial object, a industrial object, a military object, a clothing item, a item of footwear, a shoe, a sneaker, a mode of transportation, a bicycle, an automobile, an aircraft, a boat, a ship, a drone, a scooter, a machine, equipment, a food item, a tool, a resource, a supply, a book, furniture, a furnishing, and an implement.

The first virtual object 304 may simulate or represent a physical place or location. The first virtual object 304 may be a simulation or representation of a physical place or location. The place or location may be a residential setting, such as a home. The place or location may be a commercial setting. The place or location may be an industrial setting. The place or location may be an outdoor setting, such as a natural setting.

The first virtual object 304 may simulate or represent a physical person or living organism. The first virtual object 304 may be a simulation or representation of a physical person or living organism. The person or living organism may be a first user. The person or living organism may be a user of the first physical object 310. The person or living organism may be a user of a second physical object (e.g., that is distinct from the first physical object, that is not the first physical object). The person or living organism may be a user of the first virtual environment output device 324. The person or living organism may be someone who is not a user of the first virtual environment output device 324 (other than the first user of the first virtual environment output device 324). The person or living organism may be a user of a second virtual environment output device.

The first virtual object 304 may simulate or represent a virtual experience or event. The first virtual object 304 may be a simulation or representation of a virtual experience or event. The virtual experience or event may be a performance. The virtual experience or event may be a concert. The virtual experience or event may be a meeting. The virtual experience or event may be a conference. The virtual experience or event may be or include a simulation or representation of an experience or event in the physical environment.

The first virtual object 304 may have a first virtual characteristic that simulates a first physical characteristic of the first physical object (e.g., the first physical object 310). The first virtual object 304 may have a first virtual characteristic that represents a first physical characteristic of the first physical object.

The first virtual object 304 may include a subset of the first virtual environment 302. The first virtual object 304 may include a subset of a second virtual object in the first virtual environment 302. The first virtual object 304 may include a non-fungible token. The first virtual object 304 may include digital content. The first virtual object 304 may include a first simulation of a second physical object. The second physical object may have a characteristic in common with the first physical object 310. The second physical object may relate to the first physical object 310. The second physical object may complement the first physical object 310. The second physical object may commercially compete with the first physical object 310.

The first virtual object 304 may represent a first virtual entity that includes a subset of a virtual space represented by the first virtual environment 302. The first virtual entity may include a subset of a second virtual entity in the virtual space. The first virtual entity may include a non-fungible token. The first virtual entity may include digital content. The first virtual entity may include a first simulation of a second physical object. The second physical object may have a characteristic in common with the first physical object 310. The second physical object may relate to the first physical object 310. The second physical object may complement the first physical object 310. The second physical object may commercially compete with the first physical object 310.

Manifestation manifesting module 114 may be configured to manifest, at a first virtual environment output device 324, a first manifestation of the first virtual object 328 in a first manifestation of the first virtual environment 326. The first virtual environment output device 324 may be the same as or include the first physical object detector 316. The first physical object detector 316 may be distinct from the first virtual environment output device 324. The first virtual environment output device 324 may be the same as or include the first physical object detector 316. The first virtual environment output device 324 may be coupled to the first physical object detector 316.

The first user 334 may be a user of the first virtual environment output device 324. Manifesting the first manifestation of the first virtual object 328 in the first manifestation of the first virtual environment 326 may include generating first visual output representing the first virtual object 304. In some embodiments, the first virtual object 304 may represent or simulate a physical object (e.g., the first physical object 310), such as a physical object that exists, or could exist, in the first physical environment 306. In some embodiments, the first virtual object 304 may be, for example, text, audio, or video output, or a combination of these. Manifesting such first visual output may include, for example, generating the first visual output in two dimensions within a three-dimensional manifestation of the first virtual environment. As a particular example, the first manifestation of the first virtual object 328 may be a two-dimensional video displayed within a three-dimensional manifestation of the first virtual environment 302. As another particular example, the first manifestation of the first virtual object 328 may be a three-dimensional video displayed within a three-dimensional manifestation of the first virtual environment 302. Such a two-dimensional video or three-dimensional video may, for example, include user interface controls. Such user interface controls may include one or more of a play button, a stop button, a pause button, a rewind button, a fast forward button, an enlarge button, and a hide button, which the first user may indicate, select or otherwise interact with to cause the corresponding functions to be performed. Such first user indication, selection, or other interaction may be performed by the first user, and sensed by the system 100, using any of a variety of means, including, but not limited to, a manual manipulation by the first user 334 using an interactive feature (e.g., a button, a joystick, a body motion sensor, a touch sensor) of the system 100 and/or the system 300. Embodiments may use eye tracking and an eye movement sensor, body movement and a body movement sensor, voice or sound produced by a user and a microphone, for example.

Manifesting the first manifestation of the first virtual object 328 may include generating auditory output representing the first virtual object 304. Manifesting the first manifestation of the first virtual object 328 may include generating tactile output representing the first virtual object 304. Manifesting the first manifestation of the first virtual object 328 may include generating haptic output representing the first virtual object 304. Manifesting the first manifestation of the first virtual object 328 may include generating proprioceptive output representing the first virtual object 304.

Manifesting the first manifestation of the first virtual object 328 may include generating olfactory output representing the first virtual object 304. Manifesting the first manifestation of the first virtual object 328 may include manifesting a plurality of manifestations of the first virtual object 304 using one or a plurality of output devices. Manifesting the first manifestation of the first virtual object 328 may be performed based on identifying the first value 322.

Manifesting the first manifestation of the first virtual object 328 may be performed in response to identifying the first value 322. Manifesting the first manifestation of the first virtual object 328 may be performed based on identifying the first virtual object 304. Manifesting the first manifestation of the first virtual object 328 may be performed in response to identifying the first virtual object 304.

Regardless of the form that the first manifestation of the first virtual object 328 takes, the user input receiving module 116 and/or the first user input module 340 may receive, from the first user 334, first user input 336 that is directed to the first manifestation of the first virtual object 328. The first user input 336 may take any of the forms disclosed herein, such as one or more of the following, in any combination: one or more body or body part movements of the first user 334 (e.g., one or more movements of the first user 334's hands, head, one or more limbs, one or more joints, and/or one or more eyes), text or typed input received from the first user 334, audio (e.g., voice or sound) input received from the first user 334, absolute or relative positional/directional input received from the first user 334 (e.g., via a mouse and/or trackpad), and proximity input (e.g., repositioning or being in proximity with a particular physical object in the physical environment, or location). Regardless of the form that the first user input 336 takes, the first user input 336 may, for example, cause an avatar of the first user 334 in the first virtual environment 302 to indicate, select, point to, look at, touch, grasp, move, or otherwise interact with (directly or indirectly) the first manifestation of the first virtual object 328. For example, the first user input 336 may include movement input (e.g., movement of the first user 334's arms, hands, head, and/or eyes) which selects the first manifestation of the first virtual object 328, such as by causing an avatar of the first user 334 in the first virtual environment to select, point to, look at, touch, grasp, move, or otherwise interact with the first manifestation of the first virtual object 328. As another example, the first user input 336 may be a simple indication or selection of an interactive feature in the virtual environment, e.g., indicating or selecting a button or choice of options presented to the first user 334 in the first virtual environment 302.

In response to receiving the first user input 336, the system 100 and/or the system 300 may perform any of a variety of actions, such as performing one or more actions in connection with the first virtual object 304 and/or the first manifestation of the first virtual object 328. Such actions include, for example, modifying the first virtual object 304 and/or modifying the first manifestation of the first virtual object 328. For example, such an action may include modifying a characteristic (e.g., size, shape, and/or location) of the first virtual object 304, and modifying the first manifestation of the first virtual object 328 within the first manifestation of the first virtual environment 326 to reflect the modified characteristic of the first virtual object 304, and presenting a new virtual object (other than the first virtual object 304). As a particular example, if the first virtual object 304 includes digital content (e.g., text, audio and/or video content), such an action may include performing an action in connection with the digital content, such as playing, pausing, stopping, rewinding, fast forwarding, hiding or enlarging the video content, and modifying the first manifestation of the first virtual object 328 to reflect such playing, pausing, stopping, rewinding, fast forwarding, hiding or enlarging.

In one embodiment, a first user may be presented with a first virtual object in a first virtual environment, based on the first user being in proximity with a particular physical object in the physical environment. In another embodiment, a first user may be presented with a first virtual object in a first virtual environment, in response to the first user being in proximity with a particular physical object in the physical environment. In either example, a first virtual object may represent or simulate a physical thing, such as a physical object that exists (or could exist) in the physical environment. As another example, a first virtual object may be first digital content, such as text, audio or video content (or a representation or indication that such content is available to the first user) in the first virtual environment. Such first digital content in the first virtual environment may relate to a physical object that the first user is (or was) in proximity with in the physical environment. For example, such first digital content may be a video that offers or provides instructions, directions, use case examples, promotions or other information relating to the particular physical object in the physical environment that the first user is (or was) in proximity with. A video may show a first user how to operate a physical object, for example. An audio may present a music or sound file useful or enjoyable during use of a physical object, as another example. A text or other visual content may present a user with a promotion or other commercial opportunity (e.g., coupon, store opening, product trial), and possibly directions as to how the user may take advantage of such commercial opportunity, as yet another example. Such first digital content may be presented (or otherwise made available to) the first user at the time of first proximity between the first user and the physical object in the physical environment, or at a later time (e.g., after an elapsed time, or based on or in response to a future event, such as an indication or selection by the first user, or proximity between the first user and the same or another physical object in the physical environment at a second time).

Manifesting the first manifestation of the first virtual object 328 may be performed based on receiving first user input 336 from the first user 334. Manifesting the first manifestation of the first virtual object 328 may be performed in response to receiving the first user input 336 from the first user 334. Manifesting the first manifestation of the first virtual object 328 may include delaying by an amount of time before manifesting the first manifestation of the first virtual object 328. The first virtual environment output device 324 may include a visual output means. The first virtual environment output device 324 may include an image projector. The first virtual environment output device 324 may include a hologram generator, which implies that the first manifestation of the first virtual object 328 may be or include a first hologram, and that, more generally, any manifestation of a virtual environment or a virtual object may be or include a hologram.

The first virtual environment output device 324 may include an audio output means. The first virtual environment output device 324 may include a tactile output means. The first virtual environment output device 324 may include a haptic output means. The first virtual environment output device 324 may include a proprioceptive output means. The first virtual environment output device 324 may include an olfactory output means. The first virtual environment output device 324 may include a virtual reality output means.

The first virtual environment output device 324 may include a mixed reality output device. The first virtual environment output device 324 may include an augmented reality output device. The first user may be a user of the first virtual environment output device 324. The first user may be not a user of the first virtual environment output device 324. The first virtual environment output device 324 and the first physical object detector 316 may be distinct from each other. The first virtual environment output device 324 may be coupled to the first physical object detector 316.

The first virtual environment output device 324 and the first virtual object generator may be distinct from each other. The first virtual environment output device 324 may be coupled to the first virtual object generator. The first virtual environment output device 324 may perform the identifying of the first value. The first virtual environment output device 324 may perform the identifying of the first virtual object.

Manifesting the first manifestation of the first virtual object 328 may include manifesting the first manifestation of the first virtual object 328 in response to determining that the first physical object-associated element 308 is in proximity to the first physical object detector 316 in the first physical environment 306 and that a condition (also referred to herein as a criterion) has been satisfied. A condition may include a temporal condition. The condition may include a duration condition. The condition may include an event-based condition. The condition may include an identity-based condition. The condition may include a user permission-based condition. The condition may include a device identity-based condition. The condition may include a software application identity-based condition. The condition may include a proximity-based condition. A proximity-based condition may include a determination of proximity of the first physical object-associated element 308 to a second physical object (or a proximity detector means associated with the second physical object) in the first physical environment 306.

Manifesting the first manifestation of the first virtual object 328 may include manifesting the first manifestation of the first virtual object 328 in response to determining that a condition has been satisfied. The condition may include a temporal condition. The condition may include a duration condition. The condition may include an event-based condition. The condition may include an identity-based condition. The condition may include a user permission-based condition. The condition may include a device identity-based condition. The condition may include a software application identity-based condition. The condition may include a proximity-based condition. A proximity-based condition may include a determination of proximity of the first physical object-associated element 308 to a second physical object (or a proximity detector means associated with the second physical object) in the first physical environment 306.

In at least some embodiments of the present invention, the condition may be a payment-based condition. For example, following a determination of proximity, such as between a first physical object-associated element (that is associated with a first physical object) and a first physical object detector (that is associated with a first device used by a first user), the first user may be prompted to make or approve a payment of money (e.g., perform a financial transaction) using the first device. Such a payment may satisfy a condition, and the satisfaction of the condition may be determined by systems and/or methods of the present invention. A payment may be for the purchase of a first virtual object, rental of a first virtual object, or a subscription to use a first virtual object, as examples. A third-party payment processing service or method may be used, and may communicate a signal to the first user's first device, or to a remote computer, in order to provide information that the payment condition has been satisfied and the virtual object may be made available in the first virtual environment, for example. In at least some embodiments of the present invention, such a method may enable a first user to interact with a first physical object in a physical environment (e.g., in a store, in an office, in an industrial setting), perform a financial transaction (e.g., make or approve of a payment of money from the first user to a third party), and subsequently receive access to a first virtual object in a first virtual environment. In this use case the first virtual object may simulate the first physical object, for example.

The system 100 may also include manifestation removing module 120, which may remove the first manifestation of the first virtual object 328 from the first manifestation of the first virtual environment 326. Removing the first manifestation of the first virtual object 328 from the first manifestation of the first virtual environment 326 may include removing the first manifestation of the first virtual object 328 based on the determination that the first physical object-associated element 308 is not in proximity to the first physical object detector 316 in the first physical environment 306. Removing the first manifestation of the first virtual object 328 from the first manifestation of the first virtual environment 326 may include removing the first manifestation of the first virtual object 328 based on the determination that the first physical object-associated element 308 is not in proximity to the first physical object detector 316 in the first physical environment 306. Removing the first manifestation of the first virtual object 328 from the first manifestation of the first virtual environment 326 may include removing the first manifestation of the first virtual object 328 in response to the determination that the first physical object-associated element 308 is not in proximity to the first physical object detector 316 in the first physical environment 306.

More generally, the manifestation removing module 120 and/or the manifestation modification module 128 may perform any one or more of the following functions: (1) remove the first manifestation of the first virtual object 328 from the first manifestation of the first virtual environment 326; (2) remove the first virtual object 328 from the first virtual environment 326; and (3) modify one or more properties of the first virtual object 328. The manifestation removing module 120 and/or the manifestation modification module 128 may perform any such function(s) in response to any one or more of the following, in any combination:
the first virtual object 304 satisfying any criterion;
the first physical object-associated element 308 being in non-proximity to the first physical object detector 316;
the first physical object-associated element 308 being in proximity to the first physical object detector 316;
satisfaction of a temporal criterion, e.g., the lapse of a particular amount of time or occurrence of a particular time (e.g., time of day or date/time combination);
satisfaction of a criterion by the first virtual environment 302 (e.g., by the time or weather in the first virtual environment 302);
receipt of input from a user (e.g., the first user 334) requesting removal of the second virtual object from the first virtual environment 302;
sale or transfer of ownership of the first virtual object 328 from one user to another (e.g., from the first user 334 to another user);
copying or moving of the first virtual object 328 from the first virtual environment 302 to another virtual environment;
manifesting (e.g., printing) the first virtual object 328 in the first physical environment 306;
performing a particular operation on the first virtual object 328, e.g., playing audio and/or video content in the first virtual object 328 (e.g., to completion);
purchasing another object using the first virtual object 328 or exchanging the first virtual object 328 for another object;
satisfaction of a criterion by a proximity state of the first virtual object 328 relative to a virtual object other than the first virtual object (e.g., having a value of “in proximity,” having a value of “in non-proximity,” changing from “in proximity” to “in non-proximity,” “changing from “in non-proximity” to “in proximity”);
the absence or negation of any criterion described herein as triggering the creation or manifestation of the first virtual object 328 in the first virtual environment 302.

Manifestation manifesting module 114 may be configured to manifest a second manifestation of a second virtual object in the first virtual environment before manifesting the first manifestation of the first virtual object 328.

Manifestation manifesting module 114 may be configured to, based on the determination that the first physical object-associated element 308 is not in proximity to the first physical object detector 316, manifest, at the first virtual environment output device 324, a second manifestation of the first virtual object in the first manifestation of the first virtual environment 326. The second manifestation of the first virtual object may differ from the first manifestation of the first virtual object 328. Manifesting the second manifestation of the first virtual object may include manifesting the second manifestation of the first virtual object in response to the determination that the first physical object-associated element 308 is not in proximity to the first physical object detector 316 in the first physical environment 306.

User input receiving module 116 may be configured to receive first user input 336 in response to the manifestation of the second virtual object. Manifesting the first manifestation of the first virtual object 328 may include manifesting the first manifestation of the first virtual object 328 in response to the first user input 336. Manifesting the first manifestation of the first virtual object 328 may include manifesting the first manifestation of the first virtual object 328 based on the first user input 336. The first virtual environment output device 324 may perform the receiving of the first signal 314.

Element determination module 118 may be configured to determine that the first physical object-associated element 308 is in proximity to the first physical object detector 316 in the first physical environment 306.

Element determination module 118 may be configured to determine, based on the first signal 314, that the first physical object-associated element 308 is not in proximity to the first physical object detector 316 in the first physical environment 306.

Element determination module 118 may be configured to determine that the first physical object-associated element 308 is not in proximity to the first physical object detector 316 in the first physical environment 306.

Manifestation removing module 120 may be configured to, based on the determination that the first physical object-associated element 308 is not in proximity to the first physical object detector 316, remove the first manifestation of the first virtual object 328 from the first manifestation of the first virtual environment 326.

Manifestation removing module 120 may be configured to, based on the determination that the first physical object-associated element 308 is not in proximity to the first physical object detector 316, remove the first manifestation of the first virtual object 328 from the first manifestation of the first virtual environment 326. Manifestation removing module 120 may be configured to, in response to the determination that the first physical object-associated element 308 is not in proximity to the first physical object detector 316, remove the first manifestation of the first virtual object 328 from the first manifestation of the first virtual environment 326.

Signal transmittal module 122 may be configured to transmit a second signal, based on the first signal 314, to a remote computer over a first network. The second signal may be based on the first signal 314. The second signal may be transmitted based on the first signal 314. The second signal may be transmitted in response to the first signal 314. The remote computer may perform the identifying, based on the first signal 314, of the first value associated with the first signal 314. The remote computer may be physically distinct from the first physical object detector 316. The remote computer may be physically distinct from the first value identification module 318. The remote computer may be physically distinct from the first virtual object identification module 320. The remote computer may be physically distinct from the first virtual environment output device 324. The remote computer may be physically distinct from the first physical object detector 316 and the first virtual environment output device 324. By way of non-limiting example, the remote computer may include a processor that is not included in the first physical object detector 316, or the first virtual environment output device 324. By way of non-limiting example, the remote computer may include a computer-readable medium that is not included in the first physical object detector 316, or the first virtual environment output device 324.

The first network may include a direct cable connection. Transmitting the second signal to the remote computer over the first network may include transmitting the second signal to the remote computer over the direct cable connection.

The first network may include a local area network. Transmitting the second signal to the remote computer over the first network may include transmitting the second signal to the remote computer over the local area network.

The first network may include a wide area network. Transmitting the second signal to the remote computer over the first network may include transmitting the second signal to the remote computer over the wide area network.

The first network may include the Internet. Transmitting the second signal to the remote computer over the first network may include transmitting the second signal to the remote computer over the Internet.

The first network may include a wireless network. Transmitting the second signal to the remote computer over the first network may include transmitting the second signal to the remote computer over the wireless network.

The first network may include a Bluetooth network. Transmitting the second signal to the remote computer over the first network may include transmitting the second signal to the remote computer over the Bluetooth network.

The first network may include a mesh network. Transmitting the second signal to the remote computer over the first network may include transmitting the second signal to the remote computer over the mesh network.

Signal transmittal module 122 may be configured to, at the remote computer, transmit a third signal over a second network. The second network may include a direct cable connection. Transmitting the third signal over the second network may include transmitting the third signal over the direct cable connection. The second network may include a local area network. Transmitting the third signal over the second network may include transmitting the third signal over the local area network. The second network may include a wide area network. Transmitting the third signal over the second network may include transmitting the third signal over the wide area network. The second network may include the Internet. Transmitting the third signal over the second network may include transmitting the third signal over the Internet. The second network may include a wireless network. Transmitting the third signal over the second network may include transmitting the third signal over the wireless network. The second network may include a Bluetooth network. Transmitting the third signal over the second network may include transmitting the third signal over the Bluetooth network. The second network may include a mesh network. Transmitting the third signal over the second network may include transmitting the third signal over the mesh network.

Transmitting the third signal may include transmitting the third signal to the first virtual environment output device 324. Transmitting the third signal may include transmitting the third signal to a mobile communication device.

Transmitting the third signal may include transmitting the third signal to a computing device other than the remote computer.

Signal receiving module 108 may be configured to, at the first virtual environment output device 324, receive the third signal.

Manifestation manifesting module 114 may be configured to, at the first virtual environment output device 324, manifest a manifestation of a second virtual object in the first manifestation of the first virtual environment 326 based on the third signal.

Manifestation manifesting module 114 may be configured to, at the first virtual environment output device 324, manifest a second manifestation of the first virtual object in the first manifestation of the first virtual environment 326 based on the third signal. The first virtual environment output device 324 may perform the manifesting of the first virtual object. Manifesting the second manifestation may include manifesting the second manifestation of the first virtual object based on the determination that the first physical object-associated element 308 is not in proximity to the first physical object detector 316 in the first physical environment 306. Manifesting the second manifestation may include manifesting the second manifestation of the first virtual object in response to the determination that the first physical object-associated element 308 is not in proximity to the first physical object detector 316 in the first physical environment 306. Manifesting the second manifestation may include removing the first manifestation of the first virtual object 328 based on the determination that the first physical object-associated element 308 is not in proximity to the first physical object detector 316 in the first physical environment 306. Manifesting the second manifestation may include removing the first manifestation of the first virtual object 328 in response to the determination that the first physical object-associated element 308 is not in proximity to the first physical object detector 316 in the first physical environment 306.

Signal generating module 124 may be configured to generate the second signal based on the first physiologic output.

Information processing module 126 may be configured to, at the remote computer, process information. Processing the information may include identifying the first value 322 based on the second signal. Processing the information may include identifying the first virtual object 304 based on the second signal. Processing the information may include processing information based on the second signal. Processing the information may include processing information contained in the second signal. Processing the information may include analyzing the information. Processing the information may include applying a rule to the information. Processing the information may include applying a model to the information. Processing the information may include using a neural network, machine learning, or artificial intelligence.

Manifestation modification module 128 may be configured to, at the first virtual environment output device 324, modify the first manifestation of the first virtual object 328 in the first manifestation of the first virtual environment 326 based on the third signal.

Feedback generating module 130 may be configured to, at the first virtual environment output device 324, generate feedback based on the third signal. Generating the feedback based on the third signal may include providing the feedback as output to a user of the first virtual environment output device 324. Generating the feedback based on the third signal may include providing the feedback as output to the remote computer. Generating the feedback based on the third signal may include providing the feedback as output to a computing device other than the remote computer. Generating the feedback based on the third signal may include providing the feedback as output to a mobile communication device.

In some embodiments, the signal may include a radio signal. In some embodiments, by way of non-limiting example, the digital content may include at least one of text, audio, and video. In some embodiments, the first virtual environment 302 may include a virtual reality environment. In some embodiments, the first virtual environment 302 may include a mixed reality environment. In some embodiments, the first virtual environment 302 may include an augmented reality environment.

In some embodiments, the first virtual environment 302 may include a simulation of a second physical environment. In some embodiments, the first virtual environment 302 may include a fictional environment. In some embodiments, the first virtual environment 302 may be governed by a set of virtual laws of physics that differ from a set of natural laws of physics. In some embodiments, the first virtual environment 302 may include a first avatar corresponding to a first user. In some embodiments, the first virtual environment 302 may include a first avatar corresponding to a first user. In some embodiments, by way of non-limiting example, the first virtual environment 302 may include a first avatar corresponding to a first user, and a second avatar corresponding to a second user. The second physical environment may include the first physical environment 306.

In some embodiments, the first user and the second user are distinct.

A first object (whether virtual or physical) may be different from a second object (whether virtual or physical) in any of a variety of ways. For example, the first object may differ from the second object in size, where the first object may be larger, smaller, or have different dimensions compared to the second object. The objects may also have distinct shapes, such as one being circular and the other square, or they may have different colors or patterns. In some embodiments, the material composition may differ, where the first object might be made of wood, while the second is made of metal, plastic, or another material. The objects may serve different purposes or have different capabilities in terms of functionality. Additionally, one object may be older or newer than the other, and the first object could be new or in pristine condition, while the second might be worn or damaged. The objects may have different designs, styles, or aesthetic features, and they could be produced by different companies or brands. There may also be a difference in weight between the two objects, and the surface texture of the first object might be smooth, while the second could be rough or textured. One object may be more valuable or expensive than the other, either monetarily or sentimentally, and the objects may be located in different places. In some cases, one object may have cultural, historical, or artistic significance that the other does not. The first object might incorporate advanced technology, while the second is more basic or traditional. If the objects are machines or tools, one may perform better or more efficiently than the other. One object may be customized or personalized, while the other is standard, and the first object could be complex with many components, while the second is simple with few parts. One object may have interactive features or be responsive to user input, while the other is passive. The objects could be in different states of matter, such as one being solid and the other liquid or gas. If the objects are living organisms, they may differ in species, gender, genetic makeup, or health status. In the context of digital objects, they may run different software or operating systems. The objects might have different legal statuses, such as one being patented and the other not, and one object may be eco-friendly or sustainable, while the other is not.

These are just a few examples, and the ways in which objects can differ are virtually limitless, depending on the context and the attributes being compared. As the above implies, and as a particular example, a virtual object may differ from a physical object in any of the ways listed above.

In some embodiments of the present invention, a first object (e.g., a first virtual object) may differ from a second object (e.g., a first physical object) in any of a variety of ways. For example, the first object may exhibit dimensional variance, having a greater or lesser height, width, or depth compared to the second object, resulting in a difference in overall dimensions. As one particular example, a virtual representation of a microscopic organism may be enlarged for easier study. The first object may possess volume disparity, having a larger or smaller volume than the second object, which may be quantifiable by measuring the space each object occupies in their respective environments. The first object may exhibit scale variation, being a scaled-up or scaled-down version of the second object while maintaining the same proportions but differing in absolute size. This may allow for detailed examination of small physical objects or comprehensive views of large physical structures. The first object may demonstrate expandability, being capable of expansion or contraction to alter its size dynamically, while the second object may remain static in size. This feature may enable users to zoom in on specific details or zoom out for a broader perspective. In some embodiments, the first object may differ from the second object through proportional size discrepancy, where one or more of its constituent parts or features are proportionally larger or smaller relative to the whole, allowing for emphasis on specific aspects or functionalities. For objects composed of smaller particles or units, the first object may consist of larger or smaller granules, grains, or particles than those found in the second object, enabling more detailed or simplified representations as needed. The first object may have parts or components that extend further or cover a greater range than those of the second object, impacting the object's spatial influence within the virtual environment. The first object may present a larger or smaller profile or outline when viewed from a particular angle or perspective compared to the second object, potentially enhancing visibility or interaction within the virtual space.

In some embodiments of the present invention, a first object (e.g., a first virtual object) may differ from a second object (e.g., a first physical object) in any of a variety of ways. The first object may have a geometric form that differs from the second object, such as when the first object has a geometric shape such as a cube, sphere, or pyramid, while the second object may have a different geometric form, such as a cylinder, cone, or prism. This may allow for simplified or idealized representations of complex physical objects in the virtual environment. The first object may have surface contours that differ from the second object, such as when the first object has a flat, planar surface, while the second object features a contoured, curved, or irregular surface. This may enable easier manipulation or interaction with the virtual object in the virtual environment. The first object may have a complexity of shape that differs from the second object. For example, the first object may have a simple, uniform shape, whereas the second object has a complex, composite shape consisting of multiple interconnected parts. This simplification may aid in understanding the core structure or function of the object. The first object may have modularity characteristics that differ from the second object, such as when the shape of the first object is modular, allowing for reconfiguration or rearrangement of its parts, while the second object's shape could be a single, unibody construction. This modularity in the virtual object may enable dynamic customization or exploration of different configurations. The first object may have expandability features that differ from the second object. For example, the shape of the first object may be expandable or collapsible, such as an accordion-style mechanism, while the second object's shape is fixed. This feature may allow for more versatile representations and interactions in the virtual environment. The first object may have dimensionality characteristics that differ from the second object, such as when the first object could be represented in higher dimensions than the second object, allowing for visualization of concepts or properties that are not directly observable in the physical world. The first object may exhibit a fractal nature that differs from the second object. For example, the first object may exhibit a fractal shape with self-similarity at various scales, while the second object has a regular, non-fractal shape. This may enable exploration of complex mathematical or natural structures in the virtual environment. The first object may have dynamic shape changing capabilities that differ from the second object, such as when the first object is capable of dynamically changing its shape in response to user interactions or environmental conditions in the virtual space, a feature that may not be possible with the second object.

In some embodiments of the present invention, a first object (e.g., a first virtual object) may differ from a second object (e.g., a first physical object) in any of a variety of ways. The first object may be of one hue, such as red, while the second object may be of a different hue, such as blue, which may allow for easy differentiation or highlighting of the virtual object in the virtual environment. The first object may feature a combination of colors in a pattern or design, while the second object has a single, solid color, which may be used to convey information or enhance the visual appeal of the virtual object. The first object may exhibit a gradient of color, transitioning from one color to another, while the second object maintains a consistent color throughout, which may be used to represent changes in properties or states of the virtual object. The first object's color may change dynamically under different conditions or user interactions within the virtual environment, while the second object's color remains static, which may provide visual feedback or represent changing states of the virtual object. The first object may display iridescence, showing different colors when viewed from various angles within the virtual environment, while the second object may have a non-iridescent color, which may create visually interesting effects and enhance the user's interaction with the virtual object. The color of the first object may have adjustable opacity, allowing for transparency or translucency, while the color of the second object is opaque, which may be used to reveal internal structures or layer information within the virtual object. The first object may display colors beyond the visible spectrum of the second object, such as ultraviolet or infrared, represented visually in the virtual environment, which may be used for educational or scientific visualization purposes. The first object's color may adapt based on its context or surroundings in the virtual environment, while the second object's color remains constant regardless of its physical surroundings.

These color-related differences between the first virtual object and the first physical object may enable enhanced visualization, interaction, and understanding of objects and concepts within the virtual environment, extending beyond the limitations of physical reality.

In some embodiments of the present invention, a first object (e.g., a first virtual object) may differ from a second object (e.g., a first physical object) in any of a variety of ways. The first object may be composed of wood, while the second object may be made of metal, plastic, glass, ceramic, or another material. The first object may be made of an alloy, such as brass or steel, whereas the second object may be made from a pure element, like iron or copper. The first object may be a composite material, combining fibers and a resin matrix, while the second object may be a homogeneous material. The first object may be made from natural materials, such as cotton or leather, while the second object may be made from synthetic materials like nylon or polyester. The first object may be constructed from a high-grade material, such as surgical steel, while the second object may use a lower-grade variant, such as stainless steel. The first object may have undergone treatment, such as tempering for metals or preservatives for wood, while the second object may be untreated. The first object may incorporate recycled materials in its composition, while the second object may be made from new, virgin materials. The first object's material may be biodegradable, while the second object's material is non-biodegradable. The first object may have a high-density material, making it heavier, while the second object may be made from a low-density material, making it lighter. The first object may have a crystalline material structure, while the second object may be amorphous.

In some embodiments of the present invention, a first object (e.g., a first virtual object) may differ from a second object (e.g., a first physical object) in any of a variety of ways. The first object may be designed for a specific use, such as cutting, while the second object may be designed for a different use, such as fastening. The first object may have a single function, whereas the second object may serve multiple functions, incorporating features or tools. The first object may require manual operation, while the second object may function automatically or through electronic control. The first object may be simple to operate, with minimal steps or actions required, while the second object may involve a complex series of operations. The first object may be fixed in its function, while the second object may be adaptable, capable of being modified or adjusted to perform in different conditions or for different purposes. The first object may perform its function with high efficiency, while the second object may perform the same function with less efficiency. The first object may be designed for precision tasks, offering fine control or accuracy, whereas the second object may be suited for more general, less precise applications. The first object may be built for heavy-duty, long-term functionality, while the second object may be intended for light or temporary use. The first object may be standalone in its functionality, while the second object may be designed to work in conjunction with other systems or devices. The first object may lack connectivity, while the second object may include smart features, such as the ability to connect to the internet, integrate with apps, or be part of the Internet of Things (IoT).

In some embodiments of the present invention, a first object (e.g., a first virtual object) may differ from a second object (e.g., a first physical object) in any of a variety of ways. The first object may have been manufactured recently, while the second object may have been produced many years or decades earlier. The first object may originate from a specific historical period, such as the Victorian era, whereas the second object may be from a different period, like the mid-20th century. The first object may show signs of age through wear, patina, or weathering, while the second object may appear new and unused. The first object may belong to an earlier generation of technology, with outdated features, while the second object may be a current-generation model with modern specifications. The first object may be considered an antique, valued for its age, while the second object may not be old enough to be classified as such. The first object may have a documented history of use or ownership, adding to its age-related provenance, whereas the second object may have an unknown or more recent history. The first object may have undergone restoration or conservation efforts to preserve its age, while the second object may remain in its original aged condition. The first object may exhibit signs of degradation due to age, such as rust or decay, while the second object, though old, may have been preserved or protected from such effects. The age of the first object may contribute to its status as a collectible item, while the second object's age may not impart the same level of collectability. The first object may be at the end of its functional lifecycle due to age, while the second object, though of similar chronological age, may remain fully functional due to differences in material durability or maintenance.

In some embodiments of the present invention, a first object (e.g., a first virtual object) may differ from a second object (e.g., a first physical object) in any of a variety of ways. For example, the first object may show significant signs of wear and tear, such as scratches and dents, while the second object may be in pristine condition with no visible damage. The operational status of the objects may also differ, where the first object may be in working order and functioning as intended, whereas the second object may be non-operational or require repair. Preservation levels may vary between the objects, with the first object being well-preserved and retaining its original features and appearance, while the second object may have deteriorated due to environmental factors or neglect. Restoration status may provide another point of differentiation, where the first object may have been restored to a like-new condition, while the second object may remain in its found state with all the marks of its history intact. Completeness may vary, as the first object could be complete with all its original parts and accessories, while the second object may be missing components or have been partially disassembled. Cleanliness levels may differ, with the first object being clean and free of contaminants, while the second object may be dirty, stained, or have residue from previous use. Cosmetic appearance may serve as another distinguishing factor, where the first object may have a flawless cosmetic appearance, while the second object may have blemishes, discoloration, or fading. Structural integrity may also differ between the objects, with the first object having solid structural integrity with no cracks or weaknesses, whereas the second object may show signs of structural compromise. The history of upkeep and maintenance may vary, where the first object might have a history of regular upkeep and maintenance, while the second object may have been neglected or poorly maintained. Finally, refurbishment status may distinguish the objects, where the first object could be refurbished with certain parts or components replaced or upgraded, while the second object may remain in its original state without any updates or changes.

In some embodiments of the present invention, a first object (e.g., a first virtual object) may differ from a second object (e.g., a first physical object) in any of a variety of ways. For example, the first object may have a modem, minimalist aesthetic, while the second object may feature a classic, ornate design. The first object may be ergonomically designed for user comfort and efficiency, whereas the second object may not prioritize ergonomic features. The first object may incorporate design elements that enhance its functionality, like a smartphone with a waterproof casing, while the second object may have a design that is purely decorative. The first object may have a modular design, allowing for parts to be added, removed, and/or customized, while the second object may be designed as a single, non-modular unit. The first object may feature an intuitive user interface with touch controls, while the second object may rely on traditional buttons and/or switches. The first object may employ advanced materials for improved performance, such as carbon fiber, while the second object may use more conventional materials like plastic and/or metal. The first object may be designed with sustainability in mind, using eco-friendly materials and manufacturing processes, whereas the second object may not consider environmental impact in its design. The first object may reflect cultural influences in its design, incorporating traditional patterns and/or motifs, while the second object may have a universal design with no specific cultural references. The first object may offer options for personalization, such as customizable color schemes and/or engravings, while the second object may be standardized with no customization options. The first object may be the result of a design philosophy that emphasizes form over function, making a visual statement, while the second object may be designed with a focus on practicality and straightforward use.

In some embodiments of the present invention, a first object (e.g., a first virtual object) may differ from a second object (e.g., a first physical object) in any of a variety of ways. For example, the first object may be produced by a brand with a reputation for high-quality craftsmanship, while the second object may be manufactured by a brand known for affordability. The first object may be manufactured in a country renowned for a particular industry or product type, such as Swiss watches, whereas the second object may be made in a country with less association with the product. The first object may represent a brand that emphasizes eco-friendly practices and sustainability, while the second object's brand may prioritize innovation and cutting-edge technology. The first object may be from a luxury or premium brand, targeting a high-end market, while the second object may be from a mass-market brand aiming for wide accessibility. The first object may be produced by a brand with a long and storied history in the industry, while the second object may come from a relatively new or emerging brand. The first object may carry the distinctive aesthetic or design language of its brand, which is easily recognizable, whereas the second object's brand may have a more generic or less distinctive style. The first object may be from a brand known for its innovative products and technologies, while the second object's brand may have a more conservative approach to innovation. The first object may come with an extensive warranty and customer support offered by the brand, while the second object may have limited or no warranty and minimal support. The first object may benefit from a strong brand loyalty and a dedicated customer base, while the second object's brand may be less established in terms of customer loyalty. The first object may be the result of a collaboration between the brand and a well-known designer or another brand, adding to its uniqueness, while the second object may not be associated with any collaborations or partnerships.

In some embodiments of the present invention, a first object (e.g., a first virtual object) may differ from a second object (e.g., a first physical object) in any of a variety of ways. For example, the first object may serve a completely different function or purpose compared to the second object, such as a kitchen appliance versus a gardening tool. The first object may belong to a different industry or sector, like medical equipment versus consumer electronics. The first object may be designed for a specific user group, such as professionals or children, while the second object may be targeted at a general audience or a different user group. The first object may be part of a distinct product line or collection within a brand's offerings, differing in style or features from the second object's product line. The first object may be intended for use in a particular environment, such as outdoor or underwater use, whereas the second object may be designed for a different environment, like indoor or space use. The first object may be a simple, standalone item, while the second object may be part of a complex system or assembly. The first object may be a bespoke or customizable item, falling into a category of personalized goods, while the second object is a mass-produced item with no customization options. The first object may be classified differently by regulatory agencies, requiring specific certifications or standards that do not apply to the second object. The first object may be categorized under a specific technological domain, such as robotics or biotechnology, which is different from the domain of the second object. The first object may be categorized as a cultural artifact or historical item, while the second object may be a contemporary, everyday item with no particular cultural or historical value.

In some embodiments of the present invention, a first object (e.g., a first virtual object) may differ from a second object (e.g., a first physical object) in any of a variety of ways. The first object may be a physical tangible item, such as a book, while the second object may be a digital version, such as an e-book. The first object may be a consumable item, like printer ink, intended for one-time use, whereas the second object may be a durable good, like the printer itself, which may be used repeatedly over time. The first object may be a tool, such as a hammer, designed for manual tasks, while the second object may be a piece of equipment, like a power drill, which may be more complex and powered. The first object may be a component, such as a computer processor, that may be part of a larger system, while the second object may be a complete system, like a fully assembled computer. The first object may be a raw material, such as a log of wood, while the second object may be a finished product made from that material, like a wooden table. The first object may be an artifact, such as an ancient tool, representing cultural heritage, while the second object may be a specimen, like a fossil, representing natural history. The first object may be a piece of apparel, such as a shirt, that may be worn, while the second object may be an accessory, like a belt, which may complement the main article of clothing. The first object may be a piece of furniture, such as a sofa, which may serve a functional purpose, while the second object may be a decor item, like a vase, which may be primarily decorative. The first object may be a vehicle, such as a car, used for transportation, whereas the second object may be part of transport infrastructure, like a road or bridge. The first object may be a software program, such as a mobile app, while the second object may be hardware, like a smartphone, on which the software may operate.

In some embodiments of the present invention, a first object (e.g., a first virtual object) may differ from a second object (e.g., a first physical object) in any of a variety of ways. For example, the first object may be located in a specific geographical region, such as a sculpture in a European museum, while the second object may be situated in a different region, like a statue in an Asian park. The first object may be found in an urban setting, such as a streetlight, whereas the second object may be located in a rural setting, like a windmill. The first object may be in a public space and easily accessible, like a bench in a public park, while the second object may be in a private or restricted area, such as a painting in a private collection. The first object may be situated in an environment with specific conditions, like a submarine underwater, while the second object may be in a contrasting environment, such as a satellite in space. The first object may be located in a place with significant cultural relevance, such as a religious artifact in a temple, while the second object may be in a secular or non-cultural specific location, like a car in a parking lot. The first object may be in close proximity to related objects, forming a cluster or collection, such as books in a library, whereas the second object may be isolated or stand alone, like a lighthouse on a remote shore. The first object may be mobile and change locations frequently, like a food truck, while the second object may be stationary, such as a monument. The first object may be stored in a controlled environment, like a vintage wine in a cellar, while the second object may be kept in a less controlled setting, such as a bicycle in a garage. The first object may be located at a site of historical significance, like a cannon at a battlefield, while the second object may be in a modern or historically insignificant place. The first object may exist in a virtual location, such as an avatar in a virtual world, while the second object may occupy a physical space, like a statue in a real-world square.

In some embodiments of the present invention, a first object (e.g., a first virtual object) may differ from a second object (e.g., a first physical object) in any of a variety of ways. For example, the first object may have internet connectivity features, such as a smart refrigerator, while the second object may lack such features, like a traditional refrigerator. The first object may possess automation capabilities, such as a robotic vacuum cleaner, whereas the second object may require manual operation, like a standard vacuum cleaner. The first object may have an advanced user interface with touchscreens and voice control, such as a modern car dashboard, while the second object may use traditional buttons and dials, like an older car model. The first object may be integrated with software applications that enhance its functionality, such as a fitness tracker with a health monitoring app, while the second object may function independently of software, like a basic pedometer. The first object may incorporate energy-saving technologies, like an LED light bulb, whereas the second object may be less energy-efficient, such as an incandescent bulb. The first object may be equipped with sensors for monitoring various parameters, like a smartwatch that tracks heart rate, while the second object may not have such monitoring capabilities. The first object may have built-in data processing and analytics, such as a smart thermostat that learns user preferences, while the second object may lack data processing abilities. The first object may be made from advanced materials with superior properties, like carbon fiber in sports equipment, whereas the second object may be made from traditional materials, like wood or metal. The first object may include sustainable technology, such as solar panels on a backpack, while the second object may not have features that support sustainability. The first object may be designed to be easily upgraded with new technology, like a modular smartphone, while the second object may not be upgradable and may become obsolete more quickly.

In some embodiments of the present invention, a first object (e.g., a first virtual object) may differ from a second object (e.g., a first physical object) in any of a variety of ways. For example, the first object may be designed to engage users interactively, such as a video game console, while the second object may have a passive role, like a television. The first object may provide immediate feedback based on user actions, such as a touchscreen device, whereas the second object may lack such feedback capabilities, like a traditional book. The first object may adapt its behavior in response to user interactions, like a learning thermostat that adjusts to user preferences, while the second object may have a fixed behavior, such as a manual thermostat. The first object may communicate with other devices or systems, such as a smartphone syncing with a computer, while the second object may not have communication features, like a standalone calculator. The first object may offer various control options, including voice, gesture, and/or remote control, like a smart home device, whereas the second object may only offer a single mode of control, such as a light switch. The first object may allow users to customize or personalize settings, like a car with adjustable seat positions and climate control, while the second object may offer no such personalization, like a bench in a park. The first object may contain or provide access to interactive content, such as an e-reader with hyperlinked text, while the second object may contain static content, like a traditional printed book. The first object may support collaborative interactions, like a shared whiteboard application, whereas the second object may be intended for individual use, such as a personal journal. The first object may interact with users through multiple senses, including touch, sight, and/or sound, like a multimedia installation, while the second object may interact in a limited sensory manner, such as a painting. The first object may have the capability to learn from interactions and evolve over time, like an AI-powered virtual assistant, whereas the second object may remain unchanged regardless of user interaction, such as a basic alarm clock.

In some embodiments of the present invention, a first object (e.g., a first virtual object) may differ from a second object (e.g., a first physical object) in any of a variety of ways. For example, the first object may be designed to produce sound, such as a musical instrument, while the second object may be silent or non-acoustic, like a painting. The first object may offer high-fidelity sound reproduction, like a premium audio system, whereas the second object may produce lower-quality sound, such as a small portable speaker. The first object may have adjustable volume settings, like a television, while the second object may emit sound at a constant volume, such as a mechanical alarm clock. The first object may be capable of producing a variety of sounds or noises, such as a synthesizer, while the second object may be limited to a single type of sound, like a whistle. The first object may produce sound in response to user interaction, like a voice-activated device, whereas the second object's sound may not be influenced by user actions, such as a wind chime. The first object may use sound to notify or alert users, such as a smartphone ringtone, while the second object may not provide auditory notifications, like a notebook. The first object may incorporate sound-canceling technology to reduce ambient noise, like noise-canceling headphones, whereas the second object may allow all ambient sound to pass through, such as regular earbuds. The first object may direct sound in a specific direction or pattern, like a directional speaker system, while the second object may disperse sound omnidirectionally, like a traditional loudspeaker. The first object may have the capability to record sound, such as a digital voice recorder, while the second object may not have recording features, like a megaphone. The first object may be designed with specific acoustic properties to enhance or dampen sound, like an acoustic guitar, whereas the second object's acoustic properties may be incidental or non-optimized, such as a wooden box.

In some embodiments of the present invention, virtual objects may differ significantly from their physical counterparts in ways that provide specific advantages and utility. Medical training simulators may replicate human anatomy and physiological responses without the need for physical cadavers or live subjects. These simulators may simulate various medical conditions, surgical procedures, and emergency situations with high fidelity. This may provide a safe and repeatable environment for medical students and professionals to practice and hone their skills without risking patient safety. These simulators may allow for the exploration of rare medical cases that practitioners might not encounter in real life.

Architectural visualization may involve virtual models of architectural designs that allow for immersive walkthroughs of buildings before they are physically constructed. These virtual models may simulate different lighting conditions, material textures, and/or the flow of people through the space. This may enable architects and clients to experience and evaluate design choices in a realistic context, facilitating better decision-making and potentially reducing costly changes during the actual construction phase.

Flight simulators may create virtual aircraft that mimic the controls, behavior, and response of real planes. They may simulate various weather conditions, emergency scenarios, and global locations. This may allow pilots to train and practice in a controlled environment, gaining experience with different aircraft types and situations without the risks and costs associated with real flights.

Virtual prototyping may involve virtual prototypes of products that may be tested and iterated without the need for physical materials. They may simulate the product's functionality, user interaction, and/or stress tests under different conditions. This process may accelerate the development cycle, reduce costs, and allow for extensive testing and refinement before committing to manufacturing, leading to better product quality and innovation.

Educational tools and interactive learning may involve virtual educational tools that turn abstract concepts into interactive 3D models and simulations. For example, a virtual chemistry set may allow students to combine elements and observe reactions without any physical risk. Such tools may make learning more engaging and accessible, allowing students to experiment and learn through direct manipulation of virtual objects, which may enhance understanding and retention of complex subjects.

Historical reconstructions may involve virtual reconstructions that bring historical sites or artifacts to life, allowing users to explore them as they were in the past, which may be impossible with the physical remnants that exist today. This may be valuable for education and preservation, providing an immersive way to experience and study historical contexts, fostering a deeper connection to the past.

Entertainment and gaming may involve virtual objects in games that defy real-world physics, offering experiences like magic spells, fantastical creatures, or gravity-defying jumps that are not possible in reality. These elements may enhance the entertainment value, providing users with novel and engaging experiences that expand the boundaries of creativity and storytelling.

Remote collaboration and virtual workspaces may involve virtual workspaces that facilitate collaboration among users in different physical locations, allowing them to interact with shared virtual objects as if they were co-located. This capability may be useful for remote teams, enabling effective collaboration, brainstorming, and project planning without the need for physical presence, thus saving time and travel costs.

In each of these cases, the virtual object's divergence from its physical counterpart may provide specific advantages, such as safety, cost savings, enhanced learning, and the ability to experience the otherwise impossible, which may be beneficial in their respective applications.

Some particularly useful cases in which a virtual object may differ from a corresponding physical object include dynamic shape changing, impossible materials, adaptive materials, and enhanced interactivity.

Virtual objects may be programmed to change their shape in response to user interactions or environmental conditions in real-time, a feature that is not typically possible with physical objects. For example, educational anatomy models may be implemented as virtual human bodies that can dynamically expand, contract, or peel away layers to reveal different anatomical systems. This may allow medical students to interactively explore human anatomy, zooming in on specific organs or systems as needed. Architectural design visualization may be implemented through virtual building models that can dynamically alter their shape to showcase different design options or adapt to various environmental conditions. This may help architects and clients visualize how a building might change over time or in response to different weather patterns.

Engineering prototypes may be implemented as virtual machines or product prototypes that can morph their shape to demonstrate different functional states or configurations. This may be particularly useful for complex mechanical systems or products with multiple use cases. Molecular modeling may be implemented through virtual representations of molecules that can dynamically change shape to illustrate chemical reactions or protein folding. This may greatly enhance the understanding of complex biochemical processes. Terrain simulation may be implemented as virtual landscapes that can dynamically alter their topography to simulate geological processes or demonstrate the effects of erosion and climate change over time.

Interactive data visualization may be implemented through virtual objects that change their shape based on real-time data input, allowing for intuitive and dynamic representation of complex datasets. Adaptive user interfaces may be implemented as virtual controls or interfaces that dynamically reshape themselves based on user preferences, frequency of use, or context, enhancing user experience and accessibility.

Virtual objects may be composed of materials that do not exist in the physical world or violate known laws of physics. Infinitely malleable material may be implemented as virtual material that can be stretched, compressed, or molded into any shape without breaking or losing its properties. This may be used for creating highly adaptive virtual tools or structures that can transform to suit any need. Selectively permeable material may be implemented as virtual material that can be programmed to allow certain virtual objects or entities to pass through while blocking others. This may be useful for creating complex simulation environments or security systems in virtual spaces. Zero-mass material may be implemented as virtual material with no mass but retaining other physical properties like strength or conductivity. This may enable the creation of impossibly large structures or ultra-efficient virtual machines. Quantum superposition material may be implemented as virtual material that exists in multiple states simultaneously, allowing for the visualization of quantum phenomena on a macroscopic scale. This may be invaluable for education and research in quantum physics. Time-sensitive material may be implemented as virtual material that changes its properties based on the passage of time within the virtual environment. This may be used to simulate complex aging processes or create time-based puzzles and challenges. Energy-converting material may be implemented as virtual material that can convert one form of energy to another with 100% efficiency, violating the laws of thermodynamics. This may be used to explore theoretical energy systems or create unique gameplay mechanics in virtual environments. Consciousness-responsive material may be implemented as virtual material that responds to the thoughts or intentions of users, changing its properties accordingly. This may enable new forms of intuitive interaction in virtual reality experiences.

Virtual objects may be designed with materials that automatically adapt their properties based on the context or use within the virtual environment. Environment-responsive textures may be implemented as virtual materials that dynamically change their appearance based on the surrounding virtual environment. For instance, a virtual camouflage material may automatically adjust its pattern and color to blend with different backgrounds. User-interaction adaptive properties may be implemented as materials that modify their physical properties in response to user interactions. For example, a virtual fabric may become more rigid when stretched rapidly, simulating advanced smart textiles. Context-sensitive hardness may be implemented as virtual materials that adjust their hardness or softness based on the context of their use. This may be applied in virtual product design to simulate materials that adapt to different user needs or environmental conditions. Stress-distributing structures may be implemented as virtual materials that dynamically redistribute stress and strain across their structure, adapting to applied forces in real-time. This may be useful for simulating and designing advanced structural materials for architecture or engineering. Temperature-reactive properties may be implemented as virtual materials that change their properties based on simulated temperature changes. For instance, a material may become more conductive as temperature increases, allowing for the exploration of theoretical thermoelectric materials. Data-driven adaptivity may be implemented as virtual materials that adapt their properties based on real-time data input. This may be used to create dynamic visualizations of complex datasets, where the material properties reflect changing data values. Multi-state materials may be implemented as virtual materials capable of switching between multiple predefined states with distinct properties. This may be used to simulate materials with memory effects or to create puzzles and challenges in virtual environments.

Virtual objects may offer more complex interactive features than their physical counterparts, such as the ability to be manipulated in ways that defy physical laws or to respond to user input in ways not possible in the physical world. Infinite disassembly and reassembly may be implemented so that virtual objects can be taken apart into their constituent components an unlimited number of times, allowing users to explore internal structures repeatedly without damaging the object. This may be particularly useful for educational purposes, such as studying complex machinery or biological systems. Time manipulation may be implemented so that users can interact with virtual objects across different time scales, speeding up or slowing down processes to observe changes that would be imperceptible or too slow in real-time with physical objects. For example, users may watch a virtual plant grow from seed to maturity in seconds, or observe geological processes over millions of years. Scale shifting may be implemented so that users can dynamically change the scale of virtual objects, zooming in to examine microscopic details or zooming out to see macroscopic structures. This may allow for seamless exploration from atomic to cosmic scales, which is impossible with a single physical object. Physics defying interactions may be implemented so that virtual objects can be manipulated in ways that defy physical laws, such as passing through solid surfaces, changing states of matter instantly, or altering gravitational properties. This may enable unique problem-solving scenarios or creative expressions not possible in the physical world. Multi-user simultaneous manipulation may be implemented so that multiple users can interact with the same virtual object simultaneously from different locations, manipulating it collaboratively in real-time. This may go beyond what's possible with a single physical object, enabling enhanced remote collaboration and shared experiences. Context-sensitive behavior may be implemented so that virtual objects can change their behavior or properties based on the context of the interaction or the user's intent. For example, a virtual tool may automatically adapt its function based on the task at hand, transforming from a hammer to a screwdriver as needed. Data visualization integration may be implemented so that virtual objects can dynamically incorporate and visualize real-time data, transforming their appearance or behavior based on incoming information. This may create interactive data representations that a physical object couldn't replicate.

In some embodiments, computing platform(s) 102, remote platform(s) 104, and/or external resources 132 may be operatively linked via one or more electronic communication links. For example, such electronic communication links may be established, at least in part, via a network such as the Internet and/or other networks. It will be appreciated that this is not intended to be limiting, and that the scope of this disclosure includes embodiments in which computing platform(s) 102, remote platform(s) 104, and/or external resources 132 may be operatively linked via some other communication media.

A given remote platform 104 may include one or more processors configured to execute computer program modules. The computer program modules may be configured to enable an expert or user associated with the given remote platform 104 to interface with system 100 and/or external resources 132, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 132 may include sources of information outside of system 100, external entities participating with system 100, and/or other resources. In some embodiments, some or all of the functionality attributed herein to external resources 132 may be provided by resources included in system 100.

Computing platform(s) 102 may include electronic storage 134, one or more processors 136, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 134 may comprise non-transitory storage media that electronically stores information. The electronic storage media of electronic storage 134 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 134 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 134 may include one or more virtual storage resources (e.g., cloud storage, a virtual private network, and/or other virtual storage resources). Electronic storage 134 may store software algorithms, information determined by processor(s) 136, information received from computing platform(s) 102, information received from remote platform(s) 104, and/or other information that enables computing platform(s) 102 to function as described herein.

Processor(s) 136 may be configured to provide information processing capabilities in computing platform(s) 102. As such, processor(s) 136 may include one or more of a digital processor, an analog processor, a digital circuit designed to process information, an analog circuit designed to process information, a state machine, and/or other mechanisms for electronically processing information. Although processor(s) 136 is shown in FIG. 1 as a single entity, this is for illustrative purposes only. In some embodiments, processor(s) 136 may include a plurality of processing units. These processing units may be physically located within the same device, or processor(s) 136 may represent processing functionality of a plurality of devices operating in coordination. Processor(s) 136 may be configured to execute modules 108, 110, 112, 114, 116, 118, 120, 122, 124, 126, 128, and/or 130, and/or other modules. Processor(s) 136 may be configured to execute modules 108, 110, 112, 114, 116, 118, 120, 122, 124, 126, 128, and/or 130, and/or other modules by software; hardware; firmware; some combination of software, hardware, and/or firmware; and/or other mechanisms for configuring processing capabilities on processor(s) 136. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, 126, 128, and/or 130 are illustrated in FIG. 1 as being implemented within a single processing unit, In at least some embodiments in which processor(s) 136 includes multiple processing units, one or more of modules 108, 110, 112, 114, 116, 118, 120, 122, 124, 126, 128, and/or 130 may be implemented remotely from the other modules. The description of the functionality provided by the different modules 108, 110, 112, 114, 116, 118, 120, 122, 124, 126, 128, and/or 130 described below is for illustrative purposes, and is not intended to be limiting, as any of modules 108, 110, 112, 114, 116, 118, 120, 122, 124, 126, 128, and/or 130 may provide more or less functionality than is described. For example, one or more of modules 108, 110, 112, 114, 116, 118, 120, 122, 124, 126, 128, and/or 130 may be eliminated, and some or all of its functionality may be provided by other ones of modules 108, 110, 112, 114, 116, 118, 120, 122, 124, 126, 128, and/or 130. As another example, processor(s) 136 may be configured to execute one or more additional modules that may perform some or all of the functionality attributed below to one of modules 108, 110, 112, 114, 116, 118, 120, 122, 124, 126, 128, and/or 130.

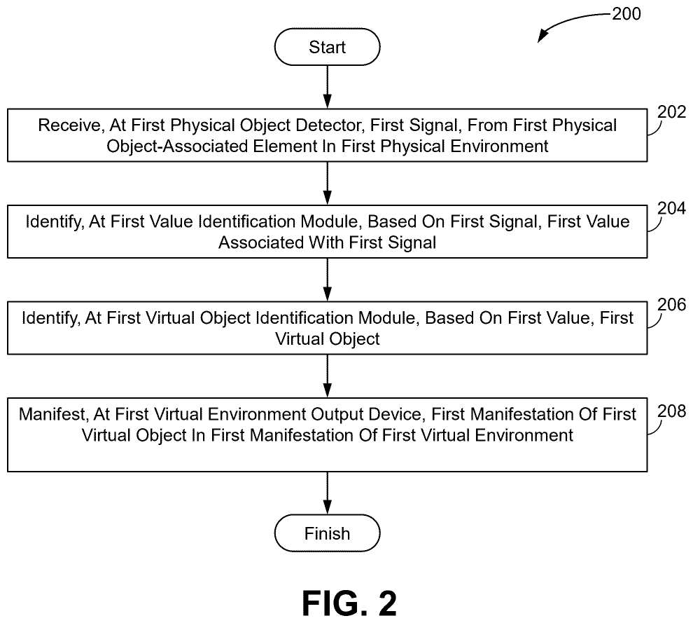

FIG. 2 illustrates a method 200 for manifesting a virtual object in a virtual environment, in accordance with one or more embodiments. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

FIG. 2 illustrates method 200, in accordance with one or more embodiments.

An operation 202 may include receiving, at the first physical object detector 316, the first signal 314, from the first physical object-associated element 308 in the first physical environment 306. The first physical object-associated element 308 may be associated with the first physical object 310 in the first physical environment 306. Operation 202 may be performed by one or more hardware processors configured by machine-readable instructions including a module that is the same as or similar to signal receiving module 108, in accordance with one or more embodiments.

An operation 204 may include identifying, at the first value identification module 318, based on the first signal 314, the first value 322 associated with the first signal 314. The first value 322 may be associated with the first physical object 310. Operation 204 may be performed by one or more hardware processors configured by machine-readable instructions including a module that is the same as or similar to value identifying module 110, in accordance with one or more embodiments.

An operation 206 may include identifying, at the first virtual object identification module 320, based on the first value 322, the first virtual object 304. Operation 206 may be performed by one or more hardware processors configured by machine-readable instructions including a module that is the same as or similar to object identifying module 112, in accordance with one or more embodiments.

An operation 208 may include manifesting, at the first virtual environment output device 324, the first manifestation of the first virtual object 328 in the first manifestation of the first virtual environment 326. Operation 208 may be performed by one or more hardware processors configured by machine-readable instructions including a module that is the same as or similar to manifestation manifesting module 114, in accordance with one or more embodiments.

As described herein, embodiments of the present invention may manifest (or change, or remove) the first manifestation of the first virtual object 328 in the first manifestation of the first virtual environment 326, in response to determining that the first physical object-associated element 308 is in proximity to the first physical object detector 316 in the first physical environment 306, wherein the first physical object-associated element 308 is associated with the first physical object 310 in the first physical environment 306. Some embodiments may manifest the first manifestation of the first virtual object 328 in the first manifestation of the first virtual environment 326 in response to determining that: (1) the first physical object-associated element 308 is in proximity to the first physical object detector 316 in the first physical environment 306; and (2) an additional condition (also referred to herein as a “criterion”), other than proximity of the first physical object-associated element 308 with the first physical object detector 316, is satisfied.

Examples of such an additional condition include, but are not limited to, any one or more of the following, in any combination:
a subsequent determination that the first physical object-associated element 308 is in proximity to the first physical object detector 316 in the first physical environment 306, examples of which include:
   determining, at a first time in (1) above, that the first physical object-associated element 308 is in proximity to the first physical object detector 316 in the first physical environment 306; then determining at a second time, later than the first time, that the first physical object-associated element 308 is not in proximity to the first physical object detector 316 in the first physical environment 306; then determining, at a third time, later than the second time, that the first physical object-associated element 308 is in proximity to the first physical object detector 316 in the first physical environment 306;
   determining, at a first time in (1) above, that the first physical object-associated element 308 is in proximity to the first physical object detector 316 in the first physical environment 306; then determining at a second time, later than the first time, that the first physical object-associated element 308 is not in proximity to the first physical object detector 316 in the first physical environment 306;
   determining, at a first time in (1) above, that the first physical object-associated element 308 is in proximity to the first physical object detector 316 in the first physical environment 306; then determining at a second time, later than the first time, that the first physical object-associated element 308 is in proximity to the first physical object detector 316 in the first physical environment 306;
a determination that the first physical object-associated element 308 has been in proximity to the first physical object detector 316 for at least some predetermined amount of time;
a determination that the duration of proximity between the first physical object-associated element 308 and the first physical object detector 316 (e.g., the amount of time that has elapsed since the first physical object-associated element 308 and the first physical object detector were determined to be in proximity to each other) otherwise satisfies a temporal condition;
a determination that the current time is equal to a predetermined time (e.g., Jan. 1, 2050 at 12:30 pm), that some amount of time has elapsed, or that the current time otherwise satisfies a temporal condition;
a determination that the first physical object 310 is in proximity to a second physical object in the first physical environment 306, such as by:
   determining whether the first physical object-associated element 308, associated with the first physical object 310 (and not associated with the second physical object in this case), is in proximity to the first physical object detector 316, associated with the second physical object (and not associated with the first physical object 310 in this case); or
   determining whether the first physical object-associated element 308, associated with a second physical object (and not associated with the first physical object 310 in this case), is in proximity to the first physical object detector 316, associated with the first physical object 310 (and not associated with the second physical object in this case);
a determination that a value of a physical parameter of a user satisfies a condition; or
a determination that a behavior of a user satisfies a condition.

As merely one example of the above use of an additional condition, consider a case in which the first user 334 (or a first device associated with the first user 334) is determined to be in proximity with the first physical object detector 316 at a first time. Either before the first time, at or during the first time, or after the first time, a trigger or event occurs. Examples of such a trigger or event include, for example: a second instance of proximity between the first user 334 (or the first device) and the first physical object 310 (or a physical object other than the first physical object 310); a change in state of the first user 334 (or the first device), such as a change in a physiologic state of the first user 334, a particular movement of the first user 334 (e.g., movement of one or both of the first user 334's eyes, as determined using eye-tracking technology), or particular words spoken by the first user 334; a change in a state of the first physical environment 306, such as change in temperature, weather, or environmental condition of the first physical environment 306, or a visual or auditory signal detected in the first physical environment 306; and manual input received from the first user 334 (e.g., via the first device).

As described herein, embodiments of the present invention may manifest (or change, or remove) a first manifestation of a first virtual object 328 in a first manifestation of a first virtual environment 326, in response to determining that the first physical object-associated element is 308 in proximity to the first physical object detector 316 in the first physical environment 306, wherein the first physical object-associated element 308 is associated with the first physical object 310 in the first physical environment 306. In some embodiments, the first virtual object 304 and/or the first manifestation of the first virtual object 328 includes any one or more of the following, in any combination:
context-relevant content (e.g., any one or more of audio, video, and text);
an icon or other graphical content which, when selected by a user (e.g., the first user 334), causes an embodiment of the present invention do display context-relevant content; and
a menu or other plurality of context-relevant content (e.g., a menu which can be opened, expanded, or otherwise explored to provide context-relevant content that may be selected by the first user 334 to access such content).

Examples of context-relevant content include, but are not limited to, any one or more of the following, in any combination: audio (e.g., spoken words, music); video (e.g., instruction or promotional video); advertisements or promotions; and icons or links that enable a user to access context-specific content. Context-relevant content may, for example, be available from and/or served by third-party content sources, such as YouTube, TikTok, Facebook, Instagram, or Spotify, as well as other third-party generated content.

The term “context-relevant” in “context-relevant content” refers to content which is generated and/or selected by embodiments of the present invention based on one or more properties of any one or more of the following, in any combination:
the first physical environment 306;
the first virtual environment 302;
the first virtual object 304;
the first physical object 310;
the first physical object-associated element 308;
the first physical object detector 316;
a user of any of the above (e.g., the first user 334);
a device of such a user.

Such properties may, for example, be current properties, past properties, or a combination thereof.

As merely one example of the above, consider a case in which the first user 334 (or a device associated with a first user) is determined to be in proximity with the first physical object 310. At some time following the determination of proximity, the first virtual object 304 is generated, implemented, or presented to the first user 334 by means of the first virtual environment output device 324. In one embodiment, the first virtual object 304 is an icon that enables the first user 334 to select the icon (within the first virtual environment 302) in order to view context-relevant content in the first virtual environment 302, e.g., via an AR/VR device. In this example, the context-relevant content may be a video with information relating to the first physical object 310. Other types of context-relevant content may also be made available to/presented to the first user 334, e.g., text, instructions, directions, coupons, promotional offers, purchase offers, and/or virtual object selections.

In some embodiments, the techniques described herein relate to a system configured for manifesting the first virtual object 304 in the first virtual environment 302, the system including: one or more hardware processors configured by machine-readable instructions to: (a) receive, at the first physical object detector 316, the first signal 314, from the first physical object-associated element 308 in the first physical environment 306, wherein the first physical object-associated element 308 is associated with the first physical object 310 in the first physical environment 306, wherein the first signal 314 contains information representing an identity of the first physical object 310; (b) identify, at the first value identification module 318, based on the first signal 314, the first value 322 associated with the first signal 314, wherein the first value 322 is associated with the first physical object 310; (c) identify, at the first virtual object identification module 320, based on the first value 322, the first virtual object 304; and (d) manifest, at the first virtual environment output device 324, the first manifestation of the first virtual object 328 in the first manifestation of the first virtual environment 326.

The first virtual object 304 may include a first simulation of the first physical object 310. The first virtual object 304 may include at least one of a virtual object, a virtual personal object, a virtual commercial object, a virtual industrial object, a virtual military object, a virtual item of clothing, a virtual item of footwear, a virtual mode of transportation, a virtual bicycle, a virtual automobile, a virtual aircraft, a virtual boat, a virtual ship, a virtual drone, a virtual scooter, a virtual machine, virtual equipment, a virtual food, a virtual tool, a virtual implement, a place, a virtual residential setting, a person, a first virtual experience, a promotion, a performance, a concert, a non-fungible token, digital content, text, audio, video, a virtual button, a virtual presentation of two or more selectable virtual objects. The digital content may relate to the first physical object 310, and the digital content may include at least one of a promotion for the first physical object 310, a promotion for a second physical object that is related to the first physical object 310, a promotion for a second virtual object that is related to the first physical object 310, instructions for using the first physical object 310, directions to the first physical object 310, directions to a location related to the first physical object 310, a discount or code, and information describing the first physical object 310.

Identifying the first virtual object 304 may include generating the first virtual object 304. Identifying the first virtual object 304 may include selecting an existing virtual object in the first virtual environment 302 as the first virtual object 304. Identifying the first virtual object 304 may include modifying an existing virtual object in the first virtual environment 302. Identifying the first virtual object 304 may include replacing an existing virtual object in the first virtual environment 302 with the first virtual object 304.

Manifesting the first manifestation of the first virtual object 328 may include generating first visual output representing the first virtual object 304. Manifesting the first manifestation of the first virtual object 328 may include generating first visual output relating to the first virtual object 304. The first visual output may include at least one of text output, audio output, and video output. Generating the first visual output may include generating the first visual output based on the first signal 314.

The one or more hardware processors may further be configured by machine-readable instructions to: (e) receive first user input directed to the first manifestation of the first virtual object 328.

Manifesting the first manifestation of the first virtual object 328 may include delaying by an amount of time before manifesting the first manifestation of the first virtual object 328.

The first virtual environment output device 324 may include at least one of a virtual reality output means and an augmented reality output means. The first virtual environment 302 may include at least one of a virtual reality environment and an augmented reality environment.

The one or more hardware processors may further be configured by machine-readable instructions to: (e) determine that the first physical object-associated element 308 is in proximity to the first physical object detector 316 in the first physical environment 306. Determining that the first physical object-associated element 308 is in proximity to the first physical object detector 316 may include determining that the first physical object-associated element 308 is in proximity to the first physical object detector 316 based on the first signal 314. Receiving the first signal 314 may be performed in response to determining that the first physical object-associated element 308 is in proximity to the first physical object detector 316 in the first physical environment 306. Determining that the first physical object-associated element 308 is in proximity to the first physical object detector 316 in the first physical environment 306 may include determining that the first physical object-associated element 308 is in proximity to the first physical object detector 316 in the first physical environment 306 based on a presence of the first signal 314.

Receiving the first signal 314 may include receiving the first signal 314 via an electromagnetic receiver means, and the first signal 314 may include an electromagnetic signal.

In some embodiments, the techniques described herein relate to a method for manifesting the first virtual object 304 in the first virtual environment 302, the method including: (a) receiving, at the first physical object detector 316, the first signal 314, from the first physical object-associated element 308 in the first physical environment 306, wherein the first physical object-associated element 308 is associated with the first physical object 310 in the first physical environment 306; (b) identifying, at the first value identification module 318, based on the first signal 314, the first value 322 associated with the first signal 314, wherein the first value 322 is associated with the first physical object 310; (c) identifying, at the first virtual object identification module 320, based on the first value 322, the first virtual object 304; and (d) manifesting, at the first virtual environment output device 324, the first manifestation of the first virtual object 328 in the first manifestation of the first virtual environment 326.

Various embodiments of the present invention may generate, store, and update a virtual environment (e.g., the first virtual environment 302) over time. For example, embodiments of the present invention may store a first state of the first virtual environment 302 at a first time. The first state of the first virtual environment 302 may, for example, be stored in one or more storage devices, which may, individually and/or collectively, include one or more copies of some or all of the first state of the first virtual environment 302. Embodiments of the present invention may generate one or more manifestations of some or all of the first state of the first virtual environment 302 in any of the ways disclosed herein. For example, a server (which refers to one or more computers, each of which may be physical or virtual, which receives requests from one or more computers, each of which may be physical or virtual, and responds to those requests) may receive (e.g., over a network) a first request from a first client (which refers to one or more computers, each of which may be physical or virtual) and, in response to that request, provide (e.g., over a network) a first manifestation of the first state of the first virtual environment 302, such as in any of the ways disclosed herein in connection with generating the first manifestation of the first virtual environment 326. Similarly, the server may receive a second request from a second client and, in response to that request, provide (e.g., over a network) a second manifestation of the first state of the first virtual environment 302, such as in any of the ways disclosed herein in connection with generating the first manifestation of the first virtual environment 326. The first and second manifestations may be the same as, or differ from, each other in any of a variety of ways. For example, if the first client is a first computer (e.g., a first desktop computer, a first laptop computer, or a first mobile computer (e.g., a first smartphone)) associated with the first user 334, then the first manifestation may represent some or all of the first state of the first virtual environment 302 from a perspective of the first user 334. Similarly, if the second client is a second computer (e.g., a second desktop computer, a second laptop computer, or a second mobile computer (e.g., a second smartphone)) associated with a second user, then the second manifestation may represent some or all of the first state of the first virtual environment 302 from a perspective of the second user.

Now assume that, at a second time that is later than the first time, the first virtual environment 302 is in a second state that differs from the first state. For example, in the first state of the first virtual environment 302, the first virtual object 304 may have a first location, while in the second state of the first virtual environment 302, the first virtual object 304 may have a second location that differs from the first location. In other words, the first virtual object 304 may have moved from the first location in the first virtual environment 302 at the first time to the second location in the first virtual environment 302 at the second time. More generally, a value of any property of the first virtual object 304 may be different in the first state of the first virtual environment 302 than in the second state of the first virtual environment 302. Embodiments of the present invention may generate one or more manifestations of some or all of the second state of the first virtual environment 302 in any of the ways disclosed herein. For example, the server disclosed above may receive a third request from the first client and, in response to that request, provide a third manifestation of the second state of the first virtual environment 302. For example, in the first manifestation of the first state of the first virtual environment 302, the first virtual object may have appeared at the first location, whereas in the third manifestation of the second state of the first virtual environment 302, the first virtual object may appear at the second location. Similarly, the server may receive a fourth request from the second client and, in response to that request, provide a fourth manifestation of the second state of the first virtual environment 302. For example, in the second manifestation of the second state of the first virtual environment 302, the first virtual object may have appeared at the first location, whereas in the fourth manifestation of the second state of the first virtual environment 302, the first virtual object may appear at the second location.

As the above description implies and the above examples illustrate, embodiments of the present invention may store a state of the first virtual environment 302 (e.g., the first and second states above) in a way that is not dependent on the existence of any particular manifestation of the first state of the first virtual environment 302. As one example, if the first virtual environment 302 is in the first state and no request is made for a manifestation of the first state of the first virtual environment 302, the system still stores the first state of the first virtual environment 302. As another example, if the first virtual object 304 changes from the first state to the second state (e.g., if the value(s) of one or more properties of the first virtual object 304 changes from the first state of the first virtual environment 302 to the second state of the first virtual environment 302), embodiments of the present invention may store the first state of the first virtual environment 302 when it is in the first state, and store the second state of the first virtual environment 302 when it is in the second state, whether or not a request is made for a manifestation of the first state of the first virtual environment 302 (and whether or not such a manifestation is generated), and whether or not a request is made for a manifestation of the second state of the first virtual environment 302 (and whether or not such a manifestation is generated). As a particular example, the first virtual object 304 may move from the first location to the second location in the first virtual environment 302 even if no manifestation of such movement is generated and/or provided to a particular user, or to any user. This is an example of the first virtual environment 302 “persisting” over time. As a result, for example, the first user 334 may use a computer to manifest one or more manifestations of the first virtual environment 302 as its state changes during a first period of time, and then stop using the computer to manifest any manifestations of the first virtual environment 302 as its state continues to change during a second period of time that is later than the first period of time. In other words, the state of the first virtual environment 302 may change while no manifestations of such changing states of the first virtual environment 302 are output by the computer.

Embodiments of the present invention may identify a second virtual object that is related to (i.e., has a relationship to) the first virtual object 304 in any of a variety of ways. The second virtual object may be identified in any of the ways disclosed herein in connection with the first virtual object 304. As some examples, “identifying” the second virtual object may include any one or more of the following, in any combination: generating the second virtual object, identifying an existing virtual object (other than the first virtual object 304) in the first virtual environment 302 as the second virtual object, and modifying an existing virtual object (e.g., an existing virtual object other than the first virtual object 304) to produce the second virtual object.

Embodiments of the present invention may, for example, identify the second virtual object based on one or more of the following, in any combination:
some or all of the properties of the first virtual object 304, such as location (e.g., absolute location or location relative to another virtual object in the first virtual environment 302), proximity state in relation to another virtual object in the first virtual environment 302, brand, style, color, size, cost, identity of an owner or other user associated with the first virtual object 304, one or more demographic properties of users who use objects of the same type as the first virtual object 304);
some or all of the properties of one or more virtual objects in the first virtual environment 302, other than the first virtual object 304;
some or all of the properties of the first virtual environment 302 (e.g., time, weather);
some or all of the properties of the first physical object 310 (such as any one or more of the properties listed above in connection with the first virtual object 304);
some or all of the properties of the first signal 314;
one or more proximity states of the first physical object-associated element 308 and the first physical object detector 316 (e.g., in proximity, in non-proximity, or a change from proximity to non-proximity or from non-proximity to proximity);
one or more proximity states of the first physical object-associated element 308 and a physical object detector other than the first physical object detector 316;
some or all of the properties of the first user 334; and
some or all of the properties of the first physical environment 306 (e.g., time, weather).

The second virtual object may, for example, include any one or more of the following in any combination, based on any of the above: text content, image content, video content, and audio content. For example, the second virtual object may include any one or more of the following, in any combination: an advertisement, an instruction (e.g., a blueprint, a schematic, a design, or a recipe); a promotion; a review; a discount; a clarification; a suggestion; an optimization; and a sign.

Embodiments of the present invention may, for example, identify the second virtual object in response to any one or more of the above, in any combination, satisfying a criterion (which may, for example, be a compound criterion which includes a plurality of criteria as components, e.g., joined by Boolean operations). As some examples, embodiments of the present invention may identify (e.g., generate) the second virtual object in response to:
the first virtual object 304 being generated;
the proximity state of the first physical object-associated element 308 and the first physical object detector 316 satisfying a particular criterion (e.g., having a value of “in proximity” or “in non-proximity,” or changing from a value of “in proximity” to “in non-proximity,” or changing from a value of “in non-proximity” to “in proximity”);
the proximity state of the first physical object-associated element 308 and a first physical object detector other than the first physical object detector 316 satisfying a particular criterion (e.g., having a value of “in proximity”);
some or all of the properties of the first physical object 310 satisfying a particular criterion (e.g., having a brand, product category, model, and/or make that satisfies the particular criterion).

Embodiments of the present invention may set the value of one or more properties of the second virtual object (e.g., its location in the first virtual environment 302 at a first time) based on any of the above (e.g., the location of the first virtual object 304 in the first virtual environment 302 at the first time), such as by setting a value of a property of the second virtual object to be equal to the value of the same property of the first virtual object 304. Embodiments of the present invention may change the value(s) of such property/properties of the second virtual object over time. As one particular example:
At a first time, embodiments of the present invention may set a location of the second virtual object in the first virtual environment 302 based on a first location of the first virtual object 304 in the first virtual environment 302 at the first time, such as by setting the location of the second virtual object in the first virtual environment 302 at the first time to be equal to, or offset by some distance from, the location of the first virtual object 304 in the first virtual environment 302 at the first time.
At a second time, the first virtual object 304 may have a second location in the first virtual environment 302, which may differ from the first location of the first virtual object 304 in the first virtual environment 302 at the first time. Embodiments of the present invention may set the location of the second virtual object in the first virtual environment 302 at the second time based on the second location of the first virtual object 304 in the first virtual environment 302 at the second time, such as by setting the location of the second virtual object in the first virtual environment 302 at the second time to be equal to, or offset by some distance from, the second location of the first virtual object 304 in the first virtual environment 302 at the second time.
The above may be repeated for any number of times. As this implies, embodiments of the present invention may automatically move the second virtual object in the first virtual environment 302 based on movement of the first virtual object 304 in the first virtual environment 302.

As another example, as the location of the first virtual object 304 in the first virtual environment 302 changes over time, the location of the second virtual object in the first virtual environment 302 may remain fixed. As another example, as the location of the second virtual object in the first virtual environment 302 changes over time, the location of the first virtual object 304 in the first virtual environment 302 may remain fixed. Embodiments of the present invention may enforce such spatial relationships between the first virtual object 304 and the second virtual object automatically. The nature of such automatic enforcement of spatial relationships over time may itself change over time. For example, in response to determining that the first physical object detector is in proximity to the first physical object-associated element during a first time period, embodiments of the present invention may automatically change the location of the second virtual object in the first virtual environment 302 based on changes to the location of the first virtual object 304 in the first virtual environment 302. During a second time period (which may be later than or earlier than the first time period), in response to determining that the first physical object detector is in non-proximity to the first physical object-associated element, embodiments of the present invention may automatically maintain the second virtual object at a fixed location in the first virtual environment 302, even while the location of the first virtual object 304 in the first virtual environment 302 changes. As this example implies, embodiments of the present invention may maintain a first spatial relationship between the first virtual object 304 and the second virtual object in the first virtual environment 302 during a first time period, and maintain a second spatial relationship (which differs from the first spatial relationship) between the first virtual object 304 and the second virtual object in the first virtual environment 302 during a second time period (which may be before or after the first time period).

The second virtual object may have any spatial relationship(s) to the first virtual object 304 in the first virtual environment 302. As some examples, in any combination:
the second virtual object may not be in contact with the first virtual object 304 (e.g., the first virtual object 304 and the second virtual object may not overlap in virtual space in the first virtual environment 302);
the second virtual object may be in contact with the first virtual object 304;
the second virtual object may partially overlap and partially not overlap with the first virtual object 304 in virtual space in the first virtual environment 302;
the first virtual object 304 may contain the entire second virtual object in the first virtual environment 302;
the second virtual object may contain the entire first virtual object 304 in the first virtual environment 302;
the second virtual object may have (or be within) a particular specified direction and/or distance of the first virtual object 304 (such as may be specified by a vector having that direction and distance).

The first virtual object 304 may be at least partially transparent, such that a manifestation of the first virtual environment 302 which includes a manifestation of the first virtual object 304 and a manifestation of the second virtual object shows at least some of the manifestation of the second virtual object through at least some of the manifestation of the first virtual object 304. The second virtual object may be at least partially transparent, such that a manifestation of the first virtual environment 302 which includes a manifestation of the first virtual object 304 and a manifestation of the second virtual object shows at least some of the manifestation of the first virtual object 304 through at least some of the manifestation of the second virtual object.

Embodiments of the present invention may remove the second virtual object from the first virtual environment 302 (e.g., delete the second virtual object from the first virtual environment 302 or otherwise cause the second virtual object to no longer be manifested), and/or modify the second virtual object in the first virtual environment 302, in response to determining that any of a variety of criteria have been satisfied, such as any one or more of the following, in any combination:
the first virtual object 304 has been removed from the first virtual environment 302;
the first virtual object 304 satisfies any criterion;
the first physical object-associated element 308 (or a third physical object-associated element associated with a third physical object that is distinct from the first physical object 310) being in non-proximity to the first physical object detector 316;
the first physical object-associated element 308 (or a third physical object-associated element associated with a third physical object that is distinct from the first physical object 310) being in proximity to the first physical object detector 316;
satisfaction of a temporal criterion, e.g., the lapse of a particular amount of time or occurrence of a particular time (e.g., time of day or date/time combination);
satisfaction of a criterion by the first virtual environment 302 (e.g., by the time or weather in the first virtual environment 302);
receipt of input from a user (e.g., the first user 334) requesting removal of the second virtual object from the first virtual environment 302;
sale or transfer of ownership of the second virtual object from one user to another (e.g., from the first user 334 to another user);
copying or moving of the second virtual object from the first virtual environment 302 to another virtual environment;
manifesting (e.g., printing) the second virtual object in the first physical environment 306;
performing a particular operation on the second virtual object, e.g., playing audio and/or video content in the second virtual object (e.g., to completion);
purchasing another object using the second virtual object or exchanging the second virtual object for another object;
satisfaction of a criterion by a proximity state of the second virtual object relative to the first virtual object 304 (e.g., having a value of “in proximity,” having a value of “in non-proximity,” changing from “in proximity” to “in non-proximity,” “changing from “in non-proximity” to “in proximity”);
the absence or negation of any criterion described herein as triggering the creation or manifestation of the second virtual object in the first virtual environment 302.

A virtual object (e.g., the first virtual object 304 or the second virtual object) may be “removed” or “deleted” from the first virtual environment 302 in any of a variety of ways, such as by deleting data representing the virtual object, or by marking such data as “deleted,” but without deleting such data.

Embodiments of the present invention may generate any of a variety of output in an attempt to influence the behavior of one or more users of the system 100 and/or the system 300 (e.g., the first user 334). Examples of such output include providing instruction (e.g., audio/video instruction) and providing augmented reality output (e.g., showing the user where to move the user's hand(s)). As a particular example, embodiments of the present invention may determine that the first user 334 is in proximity to a stovetop (e.g., by determining that the first physical object-associated element 308 associated with the first user 334 is in proximity to the first physical object 310, which may be the stovetop or be associated with the stovetop). In response to such a determination of proximity, embodiments of the present invention may identify a second virtual object in any of the ways disclosed herein, in an attempt to influence behavior of the first user 334. Such a second virtual object may, for example, be identified based, in whole or in part, on physical input received from the first user 334 in any of the ways disclosed herein, such as by receiving physiologic sensor input from the first user 334. Such a second virtual object may be or include visual instructions, such as a recipe. Alternatively, such a second virtual object may engage or direct the user in the preparation of a meal at the stovetop.

Any of the data disclosed herein (e.g., any virtual object, such as the first virtual object 304 or the second virtual object, and any manifestation thereof) may be provided as output to one or more other systems (not shown). Such other systems may be or include, for example, any one or more physical objects, such as any one or more of the following, in any combination: a computer, a robot, an Internet of Things (IoT) device (e.g., a smart television or other smart appliance), a vehicle (e.g., bicycle, car, bus, truck, train, airplane, or drone), or a 3D printer which produces a 3D object. Any such output provided to the other system(s) may, for example, include one or more signals, such as one or more control signals. As one particular example, proximity between the first physical object-associated element 308 and the first physical object 310 may trigger creation of the first virtual object 304, which may represent a menu. The first user 334 may provide input which orders food from the menu, in response to which the system 100 and/or the system 300 may send a signal to a physical computer to order the food from a restaurant, kitchen or food/drink preparation system in physical space. In this example, an automated (or semi-automated food/drink preparation system may physically prepare the food or drink item, and may package the food or drink item, as well). As another example, a user may engage with a first virtual object in a virtual environment, to modify the virtual object, and then an embodiment the invention may subsequently communicate the modified first virtual object to a manufacturing system, such as a 3-D printer, to enable the manufacturing system to make, manufacture, produce, build or otherwise create a physical embodiment representative of (or resembling) the virtual object. As one example, proximity with a physical object (e.g., a product that could be customized) or a product display (or location) representing a customizable product may trigger the manifestation of a first virtual object that represents the customizable physical object in a virtual environment. In other words, the manifestation of the virtual object in the virtual environment may be based on, or in response to, proximity with the associated physical object in the physical environment, for example. A user may then engage with such a virtual object in the virtual environment in order to customize the virtual object in some way (e.g., change its color, size, shape, ingredients, or some combination of these). A user may then instruct the system, such as by providing an input at the virtual environment output means, to produce a physical object based on the first virtual object, which the system may do by communicating instructions to a physical object manufacturing element of a system of the invention. Examples of physical object manufacturing elements include, but are not limited to: a 3-D printer, a robot, a coffee maker, a food preparation device, a production machine, an assembly line, and more, including combinations of any one or more of these. Alternatively, the physical output may include printed instructions or specifications to facilitate production of a physical object, for example. Some examples of customizable objects that could be customized as virtual objects in a virtual environment, and subsequently produced as physical objects in the physical environment include, but are not limited to: structures (e.g., physical components, machine parts, building materials, windows, blinds, furniture, buildings); clothing (e.g., shirts, pants, jackets, shoes, sneakers); clothing accessories (e.g., bags, handbags, backpacks, hats, scarves); food items and beverages (e.g., ingredients, meals, plated dishes, takeout meals, drinks, coffee, tea, beverage blends, mixed alcoholic beverages); modes of transportation (e.g., cars, trucks, motorcycles, bikes, scooters, aircraft, planes, helicopters, boats, drones); and any other physical object that can be made or produced using machinery or mechanisms informed or directed by electronic input, such as a set of instructions provided by elements of a system implemented according to an embodiment of the present invention.

Embodiments of the present invention, when communicating with any device that is capable of making a physical object (such as from an instruction based on activities in a virtual environment), may include feedback from the physical object production device to a first virtual environment output device. In such an embodiment, a notification (or modification to a virtual object) may appear or be caused by virtue of a communication sent from the physical object production device. Such communication may include a signal or information indicating that the physical object has been produced, is available for pick-up or consumption (or a time when the physical object may or will be ready for pick-up or consumption), and more.

Embodiments of the present invention may provide any text disclosed herein as input to a trained model, such as trained neural network and/or a language model (e.g., a large language model, a generative language model, an autoregressive language model, and/or a neural network-based language model) to generate output (such as one or more of text output, image output, audio output, and video output, in any combination). Specific examples of language models that may be used include, but are not limited to, any one or more of the following language models, in any combination:
Any language model in the GPT-n series of language models (such as GPT-1, GPT-2, GPT-3, GPT-3.5, GPT-4, GPT-4 Turbo, or GPT-5) available from OpenAI Incorporated of San Francisco, California;
any version of the Language Model for Dialogue Applications (LaMDA), Generalist Language Model (GLaM), Pathways Language Model (PaLM or PaLM 2), or Gemini (also known as Bard or Gemini 1, 1.5, or 2 series), available from Google LLC of Mountain View, California;
any version of the Gopher language model or Chinchilla language model, available from DeepMind Technologies of London, United Kingdom;
any version of the Turing-NLG (Turing Natural Language Generation) language model or Phi series (such as Phi-1, Phi-2, Phi-3), available from Microsoft Corporation of Redmond, Washington;
any version of the Megatron Language Model (Megatron-LM) or Megatron-Turing NLG model, available from Nvidia Corporation of Santa Clara, California;
any version of the Large Language Model Meta AI (LLaMA), including LLaMA 2 or LLaMA 3, available from Meta Platforms, Inc. of Menlo Park, California;
any version of the Claude language model (such as Claude 1, 2, 3, or 4), available from Anthropic PBC of San Francisco, California;
any version of the Mistral or Mixtral language models, available from Mistral AI SAS of Paris, France; and
any version of the Grok language model, available from xAI Corporation of San Francisco, California.

As disclosed herein, embodiments of the present invention may, for example, use one or more trained models (e.g., one or more trained language models). Such a model may, for example, include at least 1 billion parameters, at least 10 billion parameters, at least 100 billion parameters, at least 500 billion parameters, at least 1 trillion parameters, at least 5 trillion parameters, at least 25 trillion parameters, at least 50 trillion parameters, or at least 100 trillion parameters. Any processing of input (e.g., input text) by such a model to produce output (e.g., output text) is inherently rooted in computer technology and cannot be performed mentally or manually by a human, especially when taking into account that such language model output may be produced in a very short time, e.g., less than 1 second, less than 10 seconds, less than 30 seconds, or less than one minute. No human could carry out the operations carried out by such a language model on any input in one human lifetime, much less in the amounts of time disclosed herein.

Examples of text that may be provided as input to a trained model include:
text contained within and/or derived from the first user input 336;
text on and/or derived from the first physical object 310 (such as by performing optical character recognition on an image or video of the first physical object 310 to generate the text);
text contained within and/or derived from the first virtual object 304;
text contained within and/or derived from the first virtual environment 302.

Any such text may be provided as input to a trained model to generate output, such as text output, image output, video output, and/or audio output. Such output may be used as any of the kind of data disclosed herein. For example, any such output may be provided within the first virtual environment 302, e.g., within the first virtual object 304. As another example, any such output may be used to identify (e.g., generate or modify) the first virtual object 304. As a particular example, if the output includes text output, such text output may be used to generate an image (e.g., by providing the text output to the same or different trained model which generates images based on text), which may be used within the first virtual object 304 or otherwise to identify (e.g., generate or modify) the first virtual object 304.

When providing any such text to a trained model to generate output, embodiments of the present invention may provide both the text and additional data (referred to herein as “context data”) as input to the trained model. Any such data disclosed herein may be used as such context data. As one particular example, the following may be provided as input to a trained model to generate output: (1) a text description of the first virtual object 304 (e.g., text descriptions of any one or more properties of the first virtual object 304); and (2) a text description of a proximity state of the first physical object-associated element 308 to the first physical object 310.

One embodiment of the present invention is directed to a system configured for manifesting a virtual object in a first virtual environment. The system includes one or more computer processors configured by machine-readable instructions to perform a method. The method includes: (a) receiving, at a first physical object detector, a first signal, from a first physical object-associated element in a first physical environment, wherein the first physical object-associated element is associated with a first physical object in the first physical environment, wherein the first signal contains information representing an identity of the first physical object; (b) identifying, at a first value identification module, based on the first signal, a first value associated with the first signal, wherein the first value is associated with the first physical object; (c) identifying, at a first virtual object identification module, based on the first value, a first virtual object; (d) manifesting, at a first virtual environment output device, a first manifestation of the first virtual object in a first manifestation of the first virtual environment; and (e) in response to determining that a first criterion has been satisfied, modifying the first virtual object.

Determining that the first criterion has been satisfied may include any one or more of the following, in any combination:
determining that a value of a property of the first physical object satisfies the first criterion;
determining that a value of a property of the first physical environment satisfies the first criterion;
determining that a value of an input received from a user of the system (e.g., an input specifying a virtual object property value, such as a value of a color, shape, size, brand, or location within the first virtual environment) satisfies the first criterion;
determining that a value of a proximity state of the first physical object relative to a second physical object in the first physical environment satisfies the first criterion;
determining that a value of a proximity state of the first physical object relative to a second physical object in the first physical environment has changed;
determining that a temporal criterion has been satisfied (e.g., determining that a particular amount of time has elapsed);
determining that a sensor input received from a sensor in the first physical environment satisfies the first criterion;
determining that the information representing the identity of the first object satisfies the first criterion;
determining that a value of a property of the first virtual object satisfies the first criterion;
determining that a value of a property of the first virtual environment satisfies the first criterion.

Determining that the first criterion has been satisfied may include determining that the first criterion has been satisfied by a first particular value, and modifying the first virtual object may include modifying the first virtual object based on the first particular value. The first particular value may, for example, be a value of any property of the first physical object, a value of any property of the first physical environment, a value of any property of the first virtual object, a value of any property of the first virtual environment, a value of an input received from a user of the system, a value of a proximity state of the first physical object relative to a second physical object in the first physical environment, or a sensor input received from a sensor in the first physical environment. As one particular example, determining that the first criterion has been satisfied may include determining that the first criterion has been satisfied by a value of an input received from a user of the system, and modifying the first virtual object may include modifying the first virtual object based on the value of the input received from the user of the system.

The method may further include: (f) before (e), receiving, at the first physical object detector, a second signal, from the first physical object-associated element in the first physical environment, wherein the second signal contains information representing at least one of a location of the first physical object and a movement of the first physical object, and wherein modifying the first virtual object may include modifying the first virtual object based on the second signal. Alternatively, for example, the second signal may be received at a component other than the first physical object detector, such as at any component of the system 100 of FIG. 1 or the system 300 of FIG. 3. Similarly, the second signal may alternatively be received from a component other than the first physical object-associated element in the first physical environment, such as from component of the system 100 of FIG. 1 or the system 300 of FIG. 3.

Modifying the first virtual object may include modifying a value of a property of the first virtual object, where the property of the first virtual object may, for example, be a position of the first virtual object in the first virtual environment, a color of the first virtual object in the first virtual environment, a shape of the first virtual object in the first virtual environment, a size of the first virtual object in the first virtual environment, a behavior of the first virtual object in the first virtual environment, or a brand of the first virtual object in the first virtual environment.

In one embodiment of the present invention, a system and/or method may be configured for manifesting a virtual object in a first virtual environment. Any reference below to a system should be understood to be applicable to a method, and vice versa, for implementing the described embodiments. Referring to FIG. 1, the system may include one or more hardware processors configured by machine-readable instructions to perform various operations. The system may receive, at a first physical object detector, a first signal from a first physical object-associated element in a first physical environment, wherein the first physical object-associated element may be associated with a first physical object in the first physical environment, and wherein the first signal may contain information representing an identity of the first physical object. As shown in FIG. 3, the first physical object detector 316 may receive the first signal 314 from the first physical object-associated element 308, which may be associated with the first physical object 310 through the first association 312.

The system may identify, at a first value identification module, based on the first signal, a first value associated with the first signal, wherein the first value may be associated with the first physical object. With reference to FIG. 3, the first value identification module 318 may process the first signal 314 to identify the first value 322. The first value identification module 318 may be part of the first signal receiving module 342, which may coordinate the processing of signals received from the physical environment.

The system may further identify, at a first virtual object identification module, based on the first value, a first virtual object. As illustrated in FIG. 3, the first virtual object identification module 320 may receive the first value 322 and use it to identify the first virtual object 304. The identification process may involve selecting from existing virtual objects, generating new virtual objects, selecting from existing virtual object elements and combining such existing virtual object elements, generating new virtual object elements and combining such new virtual object elements, selecting from existing and newly generated virtual object elements and combining such existing and newly generated virtual object elements, or modifying existing virtual objects based on the characteristics represented by the first value 322.

The system may manifest, at a first virtual environment output device, a first manifestation of the first virtual object in a first manifestation of the first virtual environment. Referring to FIG. 3, the first virtual environment output device 324 may generate the first manifestation of the first virtual environment 326, which may include the first manifestation of the first virtual object 328. The manifestation process may involve generating visual, auditory, haptic, or other sensory output to represent the virtual object within the virtual environment.

The system may detect physical motion of a user and, in response to detecting the physical motion of the user, modify the first virtual object. As shown in FIG. 3, the first user 334 may provide the first user input 336 through various means, including physical motion that may be detected by the system. The detection of physical motion may involve monitoring or sensing body (including body part) movements, gestures, eye movements, or other forms of user motion. Such user motion may, for example, be involuntary motion (such as natural body sway or breathing movements), voluntary motion that is not intended as input (such as adjusting posture for comfort), voluntary and intentional motion to signal an input without being directed to any particular virtual object in the virtual environment (such as pointing upward to indicate an increase or nodding to indicate agreement), or voluntary and intentional motion to signal an input that is directed to or refers to a particular virtual object in the virtual environment (such as looking at a specific button in the virtual environment and blinking twice to indicate “push the button” or pointing directly at a virtual object to select it). Such user motion/movement may be subconscious or unconscious in nature. The system may use various sensors, such as body motion sensors, eye tracking sensors, or physiologic sensors, to detect and interpret user movement across these different categories of motion.

The modifications to the first manifestation virtual object 328 may include any of the modifications disclosed herein.

The physical motion detection may occur after manifesting the first manifestation of the first virtual object, allowing the user to interact with (e.g., control) the virtual object once it has been presented in the virtual environment. The detected motion may include movement of body parts such as hands, fingers, arms, head, eyes, legs, limbs, and/or joints. In some cases, the system may specifically detect hand gestures, finger movements, or eye movements as forms of user input for controlling the virtual environment.

The first virtual object 304 that may be identified and manifested in the first virtual environment 302 may take various forms, such as any of the forms disclosed herein. In some cases, the first virtual object 304 may comprise a first simulation of the first physical object 310. With reference to FIG. 3, this simulation relationship may allow the virtual representation to mirror characteristics, behaviors, or properties of the corresponding physical object in the first physical environment 306. The simulation may provide users with a virtual representation that corresponds to the physical object they are interacting with through proximity detection.

Embodiments of the system may support a wide variety of virtual object types that may be manifested based on the detected proximity and identified values. The first virtual object 304 may comprise any one or more of the following types: a virtual object, a virtual non-living object, a virtual (representation of a) living object, a virtual life-like object, a virtual personal object, a virtual residential object, a virtual commercial object, a virtual industrial object, a virtual military object, a virtual item of clothing, a virtual item of footwear, a virtual mode of transportation, a virtual bicycle, a virtual automobile, a virtual aircraft, a virtual boat, a virtual ship, a virtual drone, a virtual scooter, a virtual machine, virtual equipment, a virtual food, a virtual tool, or a virtual implement. The first virtual object 304 may alternatively represent a place, a physical (interior or exterior) setting, a person (real or fictional), an animal, a life-like organism, an experience, an event, a promotion, a performance, or a concert.

In some embodiments, the first virtual object 304 may comprise digital content forms such as a non-fungible token, digital content, text, audio, video, a virtual button, or a virtual presentation of two or more selectable virtual objects. As shown in FIG. 3, the first virtual environment output device 324 may manifest these various types of virtual objects within the first manifestation of the first virtual environment 326, allowing users to interact with different categories of virtual content based on their proximity to corresponding physical objects.

When the first virtual object 304 comprises digital content, this content may relate specifically to the first physical object 310 that triggered its manifestation through the proximity detection process. The digital content may comprise any one or more of the following types, as examples: a promotion for the first physical object 310, a promotion for a second physical object that may be related to the first physical object 310, or a promotion for a second virtual object that may be related to the first physical object 310. The digital content may alternatively include, for example, instructions for using the first physical object 310, information relating to the first physical object 310, directions to the first physical object 310, directions to a location related to the first physical object 310, a discount/promotion or code, or information describing the first physical object 310. This contextual relationship between the digital content and the physical object may enhance the user's understanding or interaction with the physical environment through the virtual interface provided by the first virtual environment output device 324.

Embodiments of the present invention may identify the first virtual object 304 through various approaches that may be implemented by the first virtual object identification module 320, such as any of the approaches disclosed herein. As shown in FIG. 3, the first virtual object identification module 320 may receive the first value 322 from the first value identification module 318 and use this information to determine how to identify the appropriate virtual object for manifestation in the first virtual environment 302.

In some embodiments, identifying the first virtual object 304 may comprise generating the first virtual object 304. The first virtual object identification module 320 may create a new virtual object based on the characteristics represented by the first value 322, which may be derived from the first signal 314 received from the first physical object-associated element 308. This generation process may involve creating virtual object data that represents properties such as appearance, behavior, or functionality that correspond to the first physical object 310. The generated virtual object may be customized to reflect specific attributes of the physical object or may be created according to predefined templates or algorithms that translate physical object characteristics into virtual representations.

Alternatively, identifying the first virtual object 304 may comprise selecting an existing virtual object in the first virtual environment 302 as the first virtual object 304. With reference to FIG. 3, the first virtual object identification module 320 may access a library or collection of pre-existing virtual objects within the first virtual environment 302 and select one that corresponds to the first value 322. This selection process may involve matching the characteristics represented by the first value 322 to properties of existing virtual objects, allowing the system to reuse previously created virtual content rather than generating new objects for each interaction.

Alternatively, the generated virtual object may be created by combining elements, such as by combining existing virtual object elements (such as may be stored in a virtual object element library in system electronic memory), or by combining newly generated virtual object elements, or by combining at least one existing virtual object element and at least one newly generated virtual object elements—such combinations providing, or otherwise enabling the manifestation of, a virtual object that may be manifested. Embodiments of the system 300 may generate the first virtual object 304 through various combination approaches, at least some of which are particularly suitable for commercial AR/VR/XR/metaverse applications. For example, a virtual person's face may be created using a combination of existing and/or newly generated virtual object elements, e.g., a head element, a hair element, an eyes element, an ears element, a nose element, a mouth element, etc.—in combination providing (e.g., generating) a generated virtual object. Embodiments of a system 300 may generate a first virtual object based on selections (including random selections) of certain one or more virtual object elements, and modify such selections as information is input to (e.g., sensed or learned by) system 300.

Embodiments may combine virtual object elements to create combined virtual objects. For example, embodiments may combine virtual object elements to create avatars by assembling body components such as torso elements, limb elements, clothing elements, accessory elements, and/or facial expression elements. The first virtual object identification module 320 may, for example, select from libraries containing a plurality of pre-designed virtual object elements including various facial features, body components, skin tones, hairstyles, clothing options, personal accessories (e.g., eyeglasses, hat, jewelry), and/or animation sets that may be combined to create personalized avatar representations. Virtual retail environments may utilize combination techniques where product virtual objects are assembled from base geometry elements, texture elements, material property elements, and/or interactive behavior elements. For example, a virtual sneaker may be constructed by combining sole elements, upper elements, lacing elements, logo elements, and/or wear pattern elements, with each element potentially sourced from different virtual object libraries or generated dynamically based on real-world product specifications. In virtual architectural applications, embodiments may combine structural elements such as wall elements, floor elements, ceiling elements, window elements, door elements, and/or furniture elements to create comprehensive virtual building representations. In some embodiments of system 300, at least some virtual object elements may be selected and/or manifested based on assumptions, presumptions, or random selection, and then possibly refined—such as by modification, replacement, or removal of one or more virtual object elements—as additional information (e.g., sensed input) becomes known or learned by system 300.

The system 300 may implement modular combination approaches where virtual object elements include attachment points, scaling parameters, and/or compatibility metadata that facilitate seamless integration during the combination process. Gaming and entertainment applications may utilize combination techniques to create virtual environments by assembling terrain elements, vegetation elements, weather effect elements, lighting elements, and/or ambient sound elements. Virtual object elements may include behavioral components such as physics simulation elements, collision detection elements, animation trigger elements, and/or user interaction response elements that become active when combined into complete virtual objects. The first virtual environment output device 324 may render these combined virtual objects with varying levels of detail based on user proximity, system performance capabilities, and/or application requirements, enabling scalable virtual object complexity suitable for different commercial deployment scenarios.

In some cases, identifying the first virtual object 304 may comprise modifying an existing virtual object in the first virtual environment 302. The first virtual object identification module 320 may locate an existing virtual object within the first virtual environment 302 and alter its properties, appearance, or behavior based on the first value 322. This modification approach may allow the system to adapt existing virtual content to better represent the specific characteristics of the first physical object 310, for example, providing a balance between efficiency and customization in the virtual object identification process.

The modification of an existing virtual object in the first virtual environment 302 may involve altering one or more elements of the existing virtual object. Various means of such modification of an existing virtual object include, for example, modification, revision, replacement, and/or removal of the existing virtual object. Such modification may include modifying one or more elements of the existing virtual object, while preserving other elements that remain unchanged. The first virtual object identification module 320 may implement selective element modification approaches that target specific components of an existing virtual object rather than regenerating the entire object. This element-based modification process may utilize one or more existing virtual object elements that are retrieved from virtual object element libraries, one or more newly generated virtual object elements that are created specifically for the modification, or a combination of at least one existing virtual object element and at least one newly generated virtual object element to achieve the desired changes.

For example, when modifying a virtual avatar representation, embodiments of the system 300 may alter only the clothing elements while preserving the facial features, body structure, and animation elements of the existing virtual object. The first virtual object identification module 320 may replace existing clothing elements with newly generated garment elements that correspond to updated information from the first value 322, while maintaining the unchanged elements such as skin tone, hair style, and facial expression elements. This selective modification approach may enable the system to update the virtual object's appearance without the computational overhead of regenerating elements that do not require changes.

In virtual retail applications, the modification process may involve updating specific product elements while maintaining core structural components. When the first physical object 310 represents a customizable product, the first virtual object identification module 320 may modify color elements, texture elements, or branding elements of an existing virtual product representation while preserving the base geometry elements, physics simulation elements, and interactive behavior elements. This targeted modification approach may allow for real-time customization responses without requiring complete virtual object reconstruction.

The efficiency advantages of selective element modification may become apparent when considering the computational resources required for different modification approaches. Modifying one or more elements of an existing virtual object while preserving unchanged elements may require significantly less processing power, memory allocation, and/or rendering time compared to generating an entirely new virtual object. The first virtual environment output device 324 may benefit from this efficiency by maintaining consistent frame rates and responsive user interactions during virtual object updates. Unchanged elements may retain their existing memory allocations, texture mappings, and rendering optimizations, while only the modified elements require new computational resources.

Embodiments of the system may implement element dependency tracking that identifies which virtual object elements are interconnected and which may be modified independently. The first virtual object identification module 320 may analyze element relationships to determine the minimal set of elements that require modification to achieve the desired changes. For example, when updating the color of a virtual vehicle, the system may modify only the paint elements and reflection mapping elements while preserving the geometry elements, mechanical animation elements, and collision detection elements. This dependency-aware modification approach may further optimize the efficiency of virtual object updates by avoiding unnecessary changes to elements that are not affected by the modification requirements.

Embodiments of the system may also identify the first virtual object 304 by replacing an existing virtual object in the first virtual environment 302 with the first virtual object 304. As illustrated in FIG. 3, the first virtual object identification module 320 may determine that an existing virtual object should be removed from the first virtual environment 302 and substituted with a new virtual object that better corresponds to the first value 322. This replacement process may occur when the system determines that the existing virtual object no longer accurately represents the current state or characteristics of the physical environment, or when the proximity detection indicates that a different virtual object should be manifested based on the user's interaction with the first physical object 310, as examples.

Any techniques disclosed herein for identifying a single virtual object (e.g., the first virtual object 304) should be understood to be equally applicable to identifying a plurality of virtual objects and/or a virtual environment (e.g., the first virtual environment 302).

Embodiments of the present invention may manifest the first manifestation of the first virtual object 328 through various output generation approaches that may be implemented by the first virtual environment output device 324, such as any of the approaches disclosed herein. As shown in FIG. 3, the manifestation process may involve generating first visual output that represents the first virtual object 304. The first virtual environment output device 324 may create visual representations that allow users to perceive and interact with the virtual object within the first manifestation of the first virtual environment 326. This visual output generation may transform the digital data of the first virtual object 304 into perceivable visual elements that may be displayed through various output means such as displays, projectors, or virtual reality headsets.

In some embodiments, the manifestation process may involve generating first visual output that relates to the first virtual object 304. With reference to FIG. 3, the first virtual environment output device 324 may produce visual output that may be associated with, connected to, or contextually relevant to the first virtual object 304, even if the output does not directly represent the virtual object itself. This related visual output may include supplementary information, contextual elements, or associated content that enhances the user's understanding or interaction with the first virtual object 304 within the first virtual environment 302.

The first visual output generated by embodiments of the system may comprise various forms of media content. As illustrated in FIG. 3, the first virtual environment output device 324 may generate first visual output that comprises any one or more of the following: text output, audio output, and/or video output. The text output may include written information, labels, descriptions, or instructions that may be displayed within the first manifestation of the first virtual environment 326. Audio output may comprise sounds, music, spoken words, or other auditory elements that may accompany or represent the first virtual object 304. Video output may include moving images, animations, or recorded content that may provide dynamic visual representations of the virtual object or related information.

Embodiments of the present invention may generate the first visual output based on characteristics derived from the first signal 314 received from the first physical object-associated element 308. Referring to FIG. 3, the first virtual environment output device 324 may use information contained within or derived from the first signal 314 to determine the properties, appearance, or content of the first visual output. This signal-based generation approach may allow the visual output to reflect specific characteristics of the first physical object 310, creating a contextual connection between the physical environment 306 and the virtual representation. The first signal 314 may contain data that influences the color, shape, size, behavior, or other visual properties of the generated output.

The system may be configured to receive first user input 336 that may be directed to the first manifestation of the first virtual object 328. As shown in FIG. 3, the first user 334 may provide input through the first virtual environment control means 338, which may be processed by the first user input module 340. This user input capability may allow users to interact with, manipulate, or control the manifested virtual object within the first virtual environment 302. The first user input 336 may include various forms of interaction such as selection, manipulation, navigation, or modification commands that may be applied to the first manifestation of the first virtual object 328, enabling dynamic user engagement with the virtual content.

In some embodiments, the manifestation process may include temporal control features that allow the system to manage when virtual objects appear in the virtual environment. Referring to FIG. 3, the first virtual environment output device 324 may be configured to delay by an amount of time before manifesting the first manifestation of the first virtual object 328. This delay functionality may provide the system with flexibility in controlling the timing of virtual object appearances, which may be useful for various applications such as creating dramatic effects, allowing time for additional processing, or coordinating the manifestation with other system events. The delay period may be predetermined, dynamically calculated based on system conditions, or determined by user preferences or environmental factors detected through the first signal 314 or other inputs to the system.

Any techniques disclosed herein for manifesting a single virtual object (e.g., the first virtual object 304) should be understood to be equally applicable to manifesting a plurality of virtual objects and/or a virtual environment (e.g., the first virtual environment 302).

The first virtual environment output device 324 may comprise various types of output technologies that enable the manifestation of virtual objects within different types of virtual environments, such as in any of the ways disclosed herein. As shown in FIG. 3, the first virtual environment output device 324 may comprise at least one of a virtual reality output means and an augmented reality output means. Virtual reality output means may include devices such as VR/AR/XR headsets, immersive display systems, or other technologies that create fully virtual environments where users may be completely immersed in the first virtual environment 302. These virtual reality output means may generate comprehensive visual, auditory, and potentially haptic feedback to create a complete virtual experience for the first user 334.

Augmented reality output means may include AR glasses, mixed reality headsets, smartphone displays with AR capabilities, or other devices that overlay virtual content onto the physical environment. With reference to FIG. 3, when the first virtual environment output device 324 comprises augmented reality output means, the first manifestation of the first virtual object 328 may be displayed as an overlay within the first physical environment 306, allowing the first user 334 to see both the first physical object 310 and its corresponding virtual representation simultaneously. This augmented reality approach may enable users to maintain awareness of their physical surroundings while interacting with virtual content that may be contextually related to physical objects detected through the proximity sensing process.

The nature of the first virtual environment 302 may correspond to the type of output device being used for manifestation. Referring to FIG. 3, the first virtual environment 302 may comprise at least one of a virtual reality environment and an augmented reality environment. When the first virtual environment 302 comprises a virtual reality environment, the first manifestation of the first virtual environment 326 may provide a completely immersive virtual space where the first virtual object 304 may exist independently of the physical world. In such cases, the first user 334 may interact with the first virtual object 304 within a fully virtual context, though the manifestation of the virtual object may still be triggered by proximity detection between the first physical object-associated element 308 and the first physical object detector 316 in the first physical environment 306.

When the first virtual environment 302 comprises an augmented reality environment, the first manifestation of the first virtual environment 326 may blend virtual and physical elements, allowing the first virtual object 304 to appear as if it exists within or alongside the first physical environment 306. As illustrated in FIG. 3, this augmented reality approach may enable the first virtual object 304 to maintain spatial relationships with the first physical object 310, creating contextual connections between the physical and virtual elements that may enhance the user's understanding of both environments.

Embodiments of the system may be configured to determine proximity relationships between physical objects and detection components before initiating the signal reception process. As shown in FIG. 3, the one or more hardware processors may be further configured by machine-readable instructions to determine that the first physical object 310 is in proximity to the first physical object detector 316 in the first physical environment 306 before receiving the first signal 314 from the first physical object-associated element 308. This proximity determination capability may enable the system to establish spatial relationships between physical elements prior to signal-based communication, providing a foundation for subsequent virtual object manifestation processes.

The proximity determination process may be based on the same signal communication that facilitates virtual object identification. With reference to FIG. 3, determining that the first physical object 310 is in proximity to the first physical object detector 316 may comprise determining that the first physical object 310 is in proximity to the first physical object detector 316 based on the first signal 314. This signal-based proximity detection approach may allow the system to use a single communication mechanism to both establish proximity relationships and convey identifying information about the first physical object 310, creating an efficient detection and identification process.

Embodiments of the system may implement proximity-triggered signal reception, where the detection of proximity serves as a precondition for initiating the signal reception process. As illustrated in FIG. 3, the receiving of the first signal 314 at the first physical object detector 316 may be performed in response to determining that the first physical object 310 is in proximity to the first physical object detector 316 in the first physical environment 306. This proximity-responsive approach may enable the system to selectively activate signal reception capabilities based on spatial relationships, potentially reducing unnecessary processing and focusing system resources on relevant proximity events.

The system may determine proximity based on the presence of signal communication between physical elements. Referring to FIG. 3, determining that the first physical object 310 is in proximity to the first physical object detector 316 in the first physical environment 306 may comprise determining proximity based on a presence of the first signal 314. This presence-based proximity detection may allow the system to infer spatial relationships from successful signal transmission and reception, where the ability to detect the first signal 314 indicates that the first physical object-associated element 308 and the first physical object detector 316 are within sufficient range for communication to occur.

Embodiments of the present invention may implement various signal communication technologies to facilitate the transmission of the first signal 314 between the first physical object-associated element 308 and the first physical object detector 316, such as any of the signal communication technologies disclosed herein. As shown in FIG. 3, the first signal 314 may comprise at least one of an RFID signal, a Bluetooth signal, or an NFC signal. These wireless communication protocols may provide different ranges, power requirements, and data transmission capabilities that may be suitable for various proximity detection applications within the first physical environment 306.

RFID (Radio Frequency Identification) signals may enable passive or active communication between the first physical object-associated element 308 and the first physical object detector 316. With reference to FIG. 3, when the first signal 314 comprises an RFID signal, the first physical object-associated element 308 may include an RFID tag that transmits identifying information when interrogated by an RFID reader functioning as the first physical object detector 316. This RFID-based approach may allow for proximity detection and identification without requiring active power sources in the first physical object-associated element 308, making it suitable for applications where battery life or maintenance may be considerations.

Bluetooth signals may provide another wireless communication option for transmitting the first signal 314 between system components. As illustrated in FIG. 3, when the first signal 314 comprises a Bluetooth signal, the communication may occur over short to medium ranges using standardized Bluetooth protocols. The first physical object-associated element 308 may include a Bluetooth transmitter that communicates with a Bluetooth receiver in the first physical object detector 316. Bluetooth Low Energy (BLE) variants may be particularly suitable for applications requiring extended battery life while maintaining reliable proximity detection and data transmission capabilities.

NFC (Near Field Communication) signals may enable very short-range communication between the first physical object-associated element 308 and the first physical object detector 316. Referring to FIG. 3, when the first signal 314 comprises an NFC signal, the communication may typically occur within a few centimeters, providing precise proximity detection capabilities. This close-range requirement may be advantageous for applications where intentional user interaction is desired, as the first user 334 may need to deliberately bring the first physical object detector 316 into very close proximity with the first physical object-associated element 308 to initiate signal transmission.

LIDAR (Light Detection and Ranging) signals may provide another communication option for transmitting the first signal 314 between system components using optical technology. As shown in FIG. 3, when the first signal 314 comprises a LIDAR signal, the communication may occur through the emission and detection of laser pulses that measure distances and create detailed spatial maps of the surrounding environment. The first physical object-associated element 308 may include a LIDAR transmitter or reflective surface that interacts with laser pulses emitted by a LIDAR sensor functioning as the first physical object detector 316. This LIDAR-based approach may allow for highly accurate proximity detection and three-dimensional positioning information, making it suitable for applications requiring precise spatial awareness and object identification within the first physical environment 306. LIDAR signals may enable the system to not only detect the presence of the first physical object 310 but also determine its exact position, orientation, and geometric characteristics within the first physical environment 306. The first physical object detector 316 may emit laser pulses that reflect off the first physical object-associated element 308 or the first physical object 310 itself, with the time-of-flight measurements providing detailed distance and positioning data. This optical detection method may be particularly advantageous for applications requiring high-precision proximity detection, such as autonomous vehicle navigation, robotic manipulation, or augmented reality applications where accurate spatial registration between physical and virtual objects may be beneficial for the first user 334's experience.

Ultrasonic signals may provide another communication option for transmitting the first signal 314 between system components using acoustic technology. As shown in FIG. 3, when the first signal 314 comprises an ultrasonic signal, the communication may occur through the emission and detection of high-frequency sound waves that are typically above the range of human hearing. The first physical object-associated element 308 may include an ultrasonic transmitter that generates acoustic signals which are received by an ultrasonic sensor functioning as the first physical object detector 316. This ultrasonic-based approach may allow for proximity detection and data transmission through air or other acoustic media, making it suitable for applications where electromagnetic interference may be a concern or where acoustic communication provides advantages in specific environmental conditions within the first physical environment 306.

Infrared signals may enable optical communication between the first physical object-associated element 308 and the first physical object detector 316 using infrared light wavelengths. With reference to FIG. 3, when the first signal 314 comprises an infrared signal, the communication may occur through the transmission of modulated infrared light that carries identifying information about the first physical object 310. The first physical object-associated element 308 may include an infrared LED or laser diode that transmits data-encoded light signals to an infrared photodetector or camera functioning as the first physical object detector 316. This infrared-based approach may provide line-of-sight communication capabilities that may be advantageous for directional proximity detection and may offer immunity to radio frequency interference while maintaining relatively low power consumption requirements.

Magnetic field signals may provide communication capabilities through the generation and detection of controlled magnetic fields between system components. As illustrated in FIG. 3, when the first signal 314 comprises a magnetic field signal, the communication may occur through variations in magnetic field strength or orientation that encode identifying information. The first physical object-associated element 308 may include a magnetic field generator such as an electromagnet or permanent magnet with controllable properties, while the first physical object detector 316 may include magnetometers, Hall effect sensors, or other magnetic field detection devices. This magnetic field-based approach may enable proximity detection and data transmission through various materials and may be particularly suitable for applications where the first physical object 310 may be enclosed or where other signal types may be attenuated by environmental factors.

Capacitive coupling signals may enable communication through the detection of changes in electrical capacitance between the first physical object-associated element 308 and the first physical object detector 316. Referring to FIG. 3, when the first signal 314 comprises a capacitive coupling signal, the communication may occur through variations in the electrical field between conductive elements that can be measured and decoded to extract identifying information. The first physical object-associated element 308 may include conductive surfaces or electrodes that create measurable capacitive effects when in proximity to corresponding sensing electrodes in the first physical object detector 316. This capacitive coupling approach may provide touch-sensitive or near-touch proximity detection capabilities and may be particularly useful for applications where direct physical contact or very close proximity between objects is expected or desired.

Visible light communication signals may provide optical data transmission using wavelengths within the visible spectrum between the first physical object-associated element 308 and the first physical object detector 316. As shown in FIG. 3, when the first signal 314 comprises a visible light communication signal, the transmission may occur through modulated visible light that carries encoded information while potentially serving dual purposes of illumination and communication. The first physical object-associated element 308 may include LEDs or other visible light sources that can be rapidly modulated to encode data, while the first physical object detector 316 may include photodetectors, cameras, or other optical sensors capable of detecting and decoding the light-based signals. This visible light communication approach may enable simultaneous visual indication and data transmission, making it suitable for applications where visual feedback to the first user 334 may be beneficial alongside the proximity detection and identification functions.

Vibration, mechanical, sound, and audible signals may enable communication through the transmission of mechanical energy, vibrations, or acoustic waves between system components. As illustrated in FIG. 3, when the first signal 314 comprises a vibration, mechanical, sound, or audible signal, the communication may occur through controlled mechanical oscillations, impacts, acoustic emissions, or other physical movements that can be detected and decoded to extract identifying information about the first physical object 310. The first physical object-associated element 308 may include vibration motors, piezoelectric actuators, speakers, sound generators, or other mechanical and acoustic signal generators, while the first physical object detector 316 may include accelerometers, vibration sensors, microphones, sound receivers, or other motion and audio detection devices. This mechanical and acoustic signal approach may provide communication capabilities through solid materials, air, or other transmission media and may be particularly advantageous for applications where the first physical object 310 and detection components are in physical contact, connected through mechanical linkages, or positioned within acoustic range within the first physical environment 306.

Electromagnetic spectrum signals may provide comprehensive communication capabilities for transmitting the first signal 314 between the first physical object-associated element 308 and the first physical object detector 316 across various frequency ranges and applications. As shown in FIG. 3, when the first signal 314 comprises electromagnetic spectrum signals, the communication may occur through radio waves, microwaves, millimeter waves, terahertz radiation, or other electromagnetic frequencies that enable wireless data transmission and proximity detection. The first physical object-associated element 308 may include transmitters operating at various electromagnetic frequencies, such as Wi-Fi transmitters operating in the 2.4 GHz or 5 GHz bands for high-bandwidth data communication, cellular communication modules using LTE, 5G, or other mobile network protocols for long-range connectivity, or specialized industrial frequency transmitters for manufacturing and logistics applications. The first physical object detector 316 may include corresponding electromagnetic receivers, antennas, or sensor arrays capable of detecting and processing signals across multiple frequency bands simultaneously. This electromagnetic spectrum approach may be particularly advantageous for commercial applications requiring reliable wireless communication, such as retail inventory management systems using various RFID frequencies, smart building automation systems utilizing multiple wireless protocols, Internet of Things (IoT) device networks operating across different frequency allocations, or autonomous vehicle systems employing radar and communication signals for navigation and coordination within the first physical environment 306.

The first signal 314 may comprise encoded information in the form of a first code that facilitates identification and processing by the system. As shown in FIG. 3, this first code may be transmitted from the first physical object-associated element 308 to the first physical object detector 316 as part of the first signal 314. The first code may be processed by the first value identification module 318 to extract the first value 322, which may then be used by the first virtual object identification module 320 to identify the appropriate first virtual object 304 for manifestation within the first virtual environment 302.

The first code contained within the first signal 314 may represent an identity of the first physical object 310, providing a direct link between the physical and virtual elements of the system. With reference to FIG. 3, when the first code represents the identity of the first physical object 310, the first value identification module 318 may decode this identity information to generate the first value 322 that corresponds to specific characteristics or properties of the first physical object 310. This identity-based approach may enable the first virtual object identification module 320 to select, generate, or modify virtual objects that accurately represent or relate to the specific first physical object 310 detected in the first physical environment 306.

In some embodiments, the first signal 314 may directly represent an identity of the first physical object 310 without requiring additional encoding or decoding processes. As illustrated in FIG. 3, this direct representation approach may allow the first value identification module 318 to extract identity information directly from the first signal 314, streamlining the process of generating the first value 322. The identity information represented by the first signal 314 may include unique identifiers, classification codes, or other data that enables the system to distinguish the first physical object 310 from other physical objects and select appropriate virtual representations for manifestation by the first virtual environment output device 324.

Embodiments of the system may be configured to detect changes in proximity relationships and respond by modifying the virtual environment accordingly, such as in any of the ways disclosed herein. As shown in FIG. 3, the one or more hardware processors may be further configured by machine-readable instructions to determine that the first physical object 310 is not in proximity to the first physical object detector 316 in the first physical environment 306 based on at least one of an absence or a change in a characteristic of the first signal 314. This non-proximity detection capability may enable the system to evaluate or monitor ongoing spatial relationships between physical elements, including between the physical object and an element of system of the invention, and respond dynamically to changes in such relationships.

The determination of non-proximity may be based on various signal-related indicators that suggest the spatial relationship between components has changed, or meets certain criteria (e.g., predefined criteria, such as a signal strength below a certain threshold, or optical sensor changes indicating a distance greater than a certain threshold). With reference to FIG. 3, the absence of the first signal 314 may indicate that the first physical object-associated element 308 and the first physical object detector 316 are no longer within communication range, indicating or suggesting that the first physical object 310 is greater than a certain distance from the first physical object detector 316, or has moved away from the first physical object detector 316. Alternatively, a change in a characteristic of the first signal 314, such as signal strength, quality, or transmission frequency, may indicate that the proximity relationship has been altered even if some level of communication remains possible. In some embodiments, signal content, such as signal content that includes physical object 310 location information (such as GPS coordinates—e.g., latitude, longitude, and possibly also altitude—representing the location of physical object 310 in the physical environment) may indicate non-proximity.

Embodiments of the system may implement responsive virtual object management based on proximity state changes. As illustrated in FIG. 3, the system may remove the first virtual object 304 from the first virtual environment 302 in response to determining that the first physical object 310 is not in proximity to the first physical object detector 316 in the first physical environment 306. This removal process may involve the first virtual environment output device 324 ceasing to manifest the first manifestation of the first virtual object 328 within the first manifestation of the first virtual environment 326, effectively causing the virtual representation to disappear from the user's view when the corresponding physical object is no longer nearby. Embodiments of the system may alternatively (instead of removing the first virtual object 304 from the first virtual environment 302), change or modify the first virtual object 304 based on proximity state changes, including non-proximity.

The system may determine non-proximity based on specific distance measurements between physical components. Referring to FIG. 3, determining that the first physical object 310 is not in proximity to the first physical object detector 316 in the first physical environment 306 may comprise determining that the first physical object detector 316 and the first physical object 310 are at least a particular distance apart from each other. This distance-based approach may provide precise control over when virtual objects are manifested and removed, allowing the system to define specific spatial boundaries for virtual object visibility and interaction within the first virtual environment 302. Distance between physical components may be determined by sensors associated with at least one of a first physical object and a first physical object detector, by third-party sensors, or by means of calculations using, or analysis of, the content of a signal communicated between the first physical object (or the first physical object-associated element) and the first physical object detector, for example.

Embodiments of the system may utilize any of the proximity detection techniques disclosed herein to determine non-proximity states through appropriate modifications or inversions of the detection criteria. As shown in FIG. 3, the proximity detection techniques described for determining when the first physical object-associated element 308 is in proximity to the first physical object detector 316 may be adapted to detect non-proximity conditions by applying inverse logic or modified thresholds to the same underlying detection mechanisms. For example, signal strength measurements that indicate proximity when above a certain threshold may indicate non-proximity when below that threshold (or below another, lower threshold), signal presence detection that confirms proximity may indicate non-proximity through signal absence, and communication success rates that suggest proximity may indicate non-proximity when communication fails or becomes unreliable (e.g., below some measure of reliability).

The system may implement threshold-based inversions where proximity detection parameters are reversed to identify non-proximity states. With reference to FIG. 3, electromagnetic signal detection techniques such as RFID, NFC, or Bluetooth communication may determine non-proximity when signal reception fails, signal strength falls below some predetermined level, or communication timeouts occur. Optical detection methods including infrared, visible light, or LIDAR signals may indicate non-proximity through loss of optical communication, reduced light intensity below detection thresholds, or failure to receive expected optical patterns (e.g., below a particular detected size). Mechanical and vibration-based detection approaches may determine non-proximity when expected mechanical coupling is lost, vibration transmission ceases or is detected below a predetermined threshold, or mechanical signal characteristics change beyond predetermined or acceptable ranges.

Embodiments of the system may apply temporal considerations to proximity detection inversions, where sustained absence of proximity indicators over specified time periods indicates and/or confirms non-proximity states. The specified time periods may include, for example, durations of about 100 milliseconds to about 60 seconds, about 500 milliseconds to about 30 seconds, about 1 second to about 15 seconds, or about 2 seconds to about 10 seconds. In some embodiments, the time periods may be about 100 milliseconds, about 250 milliseconds, about 500 milliseconds, about 750 milliseconds, about 1 second, about 2 seconds, about 3 seconds, about 5 seconds, about 7 seconds, about 10 seconds, about 15 seconds, about 20 seconds, about 30 seconds, about 45 seconds, or about 60 seconds. As illustrated in FIG. 3, the system may require multiple consecutive failed detection attempts, such as about 2 to about 50 attempts, about 3 to about 25 attempts, about 5 to about 15 attempts, or about 3, about 5, about 7, about 10, about 12, about 15, about 20, about 25, about 30, about 40, or about 50 consecutive failed attempts. The system may require sustained signal absence for predetermined durations, such as about 1 second to about 2 minutes, about 2 seconds to about 1 minute, about 5 seconds to about 45 seconds, or about 1 second, about 2 seconds, about 5 seconds, about 10 seconds, about 15 seconds, about 20 seconds, about 30 seconds, about 45 seconds, about 60 seconds, about 90 seconds, or about 120 seconds. The system may require consistent below-threshold measurements, where the threshold may be set at about 10% to about 90%, about 20% to about 70%, about 30% to about 60%, or about 10%, about 15%, about 20%, about 25%, about 30%, about 40%, about 50%, about 60%, about 70%, about 80%, or about 90% of a baseline signal strength before confirming that the first physical object 310 is not in proximity to the first physical object detector 316. This temporal approach may help distinguish between temporary signal interruptions and actual non-proximity conditions, providing more reliable non-proximity detection while avoiding false positives that might occur from momentary signal variations or environmental interference. Embodiments of the invention may infer non-proximity based on the lapse of a predetermined or calculated amount of time (e.g., 1 minute, 5 minutes, 1 hour, 5 days), which may be useful following proximity with a predictably perishable physical object.

Embodiments of the system may implement learning and adaptation mechanisms that enhance proximity detection accuracy through analysis of historical patterns and user behaviors. The system may utilize machine learning algorithms that analyze historical proximity detection patterns to optimize temporal parameters for specific deployment scenarios. The proximity detection module 330 may monitor the frequency and duration of signal interruptions that do not correspond to actual proximity changes between the first physical object-associated element 308 and the first physical object detector 316, enabling the system to automatically adjust its confirmation requirements to minimize false positives while maintaining appropriate sensitivity to genuine proximity events.

The machine learning algorithms may analyze patterns in the first signal 314 characteristics over time, identifying recurring signal variations that correlate with environmental factors rather than actual changes in proximity between the first physical object 310 and the first physical object detector 316. With reference to FIG. 3, the first value identification module 318 may incorporate these learned patterns when processing the first signal 314, applying adaptive filtering techniques that distinguish between signal variations caused by environmental interference and those indicating genuine proximity state changes. This adaptive approach may enable the system to maintain consistent virtual object manifestation behavior even in challenging signal environments.

Embodiments of the system may implement user behavior pattern recognition capabilities that analyze typical user movement patterns and interaction behaviors to inform proximity detection decisions. As illustrated in FIG. 3, the system may monitor how the first user 334 typically interacts with the first physical object 310 and the duration of proximity events, using this behavioral data to customize proximity detection parameters for individual users or user groups. For users who tend to move quickly past detection points, the system may reduce confirmation delays to avoid missing brief proximity events that would otherwise result in failed manifestation of the first virtual object 304 within the first virtual environment 302.

The user behavior analysis may consider movement velocity patterns, typical interaction durations, and frequency of proximity events to optimize the temporal parameters used in non-proximity determination. Referring to FIG. 3, for users who typically remain in proximity to the first physical object 310 for extended periods, the system may increase confirmation requirements to avoid responding to temporary signal fluctuations during stationary interactions. This behavioral adaptation may prevent unnecessary removal and re-manifestation of the first manifestation of the first virtual object 328 when the first user 334 is engaged in prolonged interaction with physical objects that may cause intermittent signal variations.

Embodiments of the system may implement adaptive threshold adjustment mechanisms that modify proximity detection sensitivity based on learned environmental conditions and user preferences. The system may analyze historical data regarding signal strength variations, environmental interference patterns, and successful proximity detection events to establish dynamic thresholds that optimize detection accuracy for specific deployment contexts. These adaptive thresholds may influence how the first physical object detector 316 interprets variations in the first signal 314, enabling more accurate determination of when the first physical object-associated element 308 transitions between proximity and non-proximity states relative to the detection system.

The learning mechanisms may incorporate feedback from user interactions with manifested virtual objects to refine proximity detection parameters over time. The system may monitor whether the first user 334 successfully interacts with the first manifestation of the first virtual object 328 following proximity-triggered manifestation, using successful interaction patterns as positive feedback to validate proximity detection accuracy. Conversely, instances where virtual objects are manifested but not utilized by users may indicate overly sensitive proximity detection, prompting the system to adjust its detection criteria to reduce unnecessary manifestations while maintaining responsiveness to genuine user proximity events.

Embodiments of the system may be configured to detect user motion at various stages of the virtual object manifestation process with contextual awareness, adaptive capabilities, and predictive anticipation of user intentions. As shown in FIG. 3, detecting physical motion of the first user 334 may comprise detecting physical motion of the first user 334 after manifesting the first manifestation of the first virtual object 328. This temporal sequencing may allow the system to first establish the virtual object within the first virtual environment 302 and then monitor for user movements or interactions that may modify or control the manifested virtual object.

The detection of first user motion after manifestation may, for example, enable responsive virtual object behavior or changes based on user actions that occur subsequent to the initial proximity-triggered manifestation process. As another example, embodiments of the system may detect first user motion before manifestation, enabling predictive virtual object preparation and customization based on anticipated user interactions. For example, the system may detect that the first user 334 is making a pointing gesture toward the location where a virtual object will be manifested, and in response, the system may modify the future manifestation to include enhanced interactive elements or enlarged visual components that align with the detected pointing motion. This pre-manifestation motion detection capability may provide the benefit of creating more intuitive and responsive virtual environments by anticipating user intentions and preparing virtual object manifestations that are optimized for the user's detected movement patterns, thereby reducing interaction latency and improving overall user experience when the virtual object is subsequently manifested.

The system may implement predictive motion analysis that anticipates user intentions before motion is completed (or for an incomplete or ambiguous motion), using machine learning algorithms to analyze partial gestures, early-stage movement patterns, and physiological precursors to predict the user's intended actions. For example, the system may detect the initial muscle activation patterns or slight hand positioning changes that precede a pointing gesture, enabling the system to begin preparing the appropriate virtual object response before the gesture is fully executed. With reference to FIG. 3, this predictive capability may allow the first virtual environment output device 324 to begin modifying the first manifestation of the first virtual object 328 based on anticipated user intentions rather than waiting for completed gestures from the first user 334. This predictive capability may also allow the first virtual environment output device 324 to begin modifying the first manifestation of the first virtual object 328 based on partial, incomplete, or ambiguous user (body or body part) motions.

The system may implement contextual motion recognition that adapts based on the first user 334's past motion or behavior, current activity, environment, environmental conditions, or the specific application being used within the first virtual environment 302. For example, the system may employ different gesture vocabularies for different types of virtual environments, such as using precise finger movements for detailed design work versus broader arm gestures for gaming applications. The contextual adaptation may also include adjusting motion sensitivity based on user fatigue levels, skill proficiency, or the complexity of the current task, enabling more accurate motion interpretation as conditions change.

Embodiments of the system may implement body motion detection capabilities to capture various forms of user interaction with predictive gesture recognition. With reference to FIG. 3, detecting physical motion of the first user 334 may comprise detecting movement of at least one body part of the first user 334. The at least one body part may comprise at least one of hands, fingers, arms, head, eyes, legs, limbs, joints, torso, shoulders, wrists, elbows, knees, ankles, neck, skin (e.g., an area or region of a person's skin surface), muscle (e.g., a single muscle or group of muscles), and/or facial features. Some embodiments may be configured to detect motion of multiple different body parts, while other embodiments may be configured to detect motion of only a single body part or a limited subset of body parts. The system may implement anticipatory gesture recognition that analyzes partial body movements to predict complete gestures before they are fully executed, enabling proactive virtual object responses that begin before the user completes their intended motion.

Embodiments of the system may detect specific types of user gestures and movements to facilitate precise virtual object control. As illustrated in FIG. 3, detecting physical motion of the first user 334 may comprise detecting hand gestures of the first user 334. Hand gesture detection may enable the first user 334 to perform specific movements that correspond to particular commands or interactions with the first virtual object 304. The system may detect various hand gestures including, for example, pointing gestures, grasping motions, swiping movements, waving patterns, open palm presentations, closed fist formations, and/or thumbs-up or thumbs-down indicators. The system may detect body part orientation, such as relative to the ground or relative to another body part. Additionally, detecting physical motion of the first user 334 may comprise detecting finger movements (of one or more fingers) of the first user 334, which may provide fine-grained control capabilities for detailed virtual object manipulation within the first virtual environment 302.

The system may be configured to detect specific finger interactions that correspond to common user interface paradigms. Referring to FIG. 3, detecting finger movements may comprise detecting interaction between a thumb and an index finger of the first user 334. This thumb-index finger interaction detection may correspond to pinching gestures commonly used in touch interfaces, allowing the first user 334 to perform familiar interaction patterns when controlling the first virtual object 304. The system may also detect other finger interactions including, for example, finger tapping motions, finger spreading or contracting gestures, finger crossing, individual finger pointing, multi-finger selections, finger scrolling movements, finger orientation, and/or finger rotation patterns. Such gesture recognition may enable intuitive user interaction with virtual content based on established user interface conventions.

Embodiments of the system may implement head motion tracking capabilities to enhance user interaction with virtual environments. As shown in FIG. 3, detecting physical motion of the first user 334 may comprise detecting head movements of the first user 334. Head movement detection may include tracking head rotation along multiple axes, including yaw (left-right turning), pitch (up-down nodding), and/or roll (side-to-side tilting) movements. The system may use head motion to control viewpoint navigation within the first virtual environment 302, enable head-based selection of the first virtual object 304, or trigger specific interactions based on head gesture patterns such as nodding or shaking motions.

Embodiments of the system may implement eye tracking capabilities to detect user attention and gaze-based interactions with predictive gaze modeling capabilities. As shown in FIG. 3, detecting physical motion of the first user 334 may comprise detecting eye movements of the first user 334. Eye movement detection may enable the system to determine where the first user 334 is looking within the first virtual environment 302, potentially allowing for gaze-based selection or control of the first virtual object 304. The system may track various eye movements including, for example, saccadic movements, smooth pursuit tracking, fixation duration, rotation, blinking, blink patterns, pupil dilation, and/or convergence adjustments. This eye tracking capability may complement other motion detection methods to provide user interaction monitoring and may enable hands-free interaction with (e.g., control of) virtual content through sustained gaze, rapid eye movements, or deliberate blinking patterns.

The system may implement predictive gaze analysis that anticipates where the first user 334 will look next based on current gaze patterns, saccadic velocity, and environmental context, enabling preemptive virtual object preparation and interface adjustments before the user's gaze actually shifts. Advanced eye tracking applications may include foveated rendering optimization, where the system may dynamically adjust rendering quality based on the first user 334's gaze direction to improve computational efficiency by rendering high-detail graphics only in the user's central vision area. The system may implement attention-based UI adaptation that modifies interface elements based on where the first user 334 is looking, such as enlarging buttons or highlighting options that receive sustained visual attention.

Cognitive load assessment through pupil response may enable the system to monitor pupil dilation patterns to determine the first user 334's mental workload and adjust the complexity of virtual interactions accordingly. In multi-user environments, the system may provide social presence indicators that track and communicate eye contact patterns between users, enabling more natural social interactions within the first virtual environment 302. Predictive gaze modeling may allow the system to anticipate where the first user 334 will look next based on historical gaze patterns and environmental context, enabling preemptive loading of virtual content or interface adjustments. Eye-based authentication may provide secure access control by analyzing unique eye movement patterns, pupil response characteristics, or iris features to verify the identity of the first user 334 before allowing interaction with sensitive virtual objects or environments.

The system may implement arm and limb tracking capabilities for full-body interaction with virtual environments. With reference to FIG. 3, detecting physical motion of the first user 334 may comprise detecting arm movements, leg movements, and/or full-body posture changes of the first user 334. Arm movement detection may include tracking shoulder rotation, elbow flexion and extension, wrist rotation, and/or overall arm positioning in three-dimensional space. Leg movement detection may enable the system to track walking motions, stepping patterns, knee bends, foot positioning, and/or balance shifts that may be used for navigation within the first virtual environment 302 or interaction with the first virtual object 304.

### Physiologic Changes

Embodiments of the system may be configured to sense or detect user physiologic states or changes. This information may allow the system to first establish the virtual object within the first virtual environment 302, such as following proximity between a first physical object and a first physical object detector, and then monitor for (e.g., using a physiologic sensor) user physiologic states or changes that may modify or control the manifested virtual object.

Non-limiting examples of physiologic measurements and physiologic parameters that may be measured, sensed, and/or analyzed to determine a user's current and/or future physiological state include core vital parameters such as heart rate, blood pressure, respiratory rate, body temperature, and/or oxygen saturation. Cardiovascular parameters may include cardiac output, stroke volume, blood volume, central venous pressure, and/or total peripheral resistance. Respiratory parameters may include tidal volume, vital capacity, residual volume, arterial PO₂, and/or arterial PCO₂. Blood and plasma chemistry measurements may include hemoglobin, hematocrit, plasma sodium, plasma potassium, plasma bicarbonate, blood glucose, and/or plasma cortisol. Metabolic measures may include basal metabolic rate, blood urea nitrogen, cholesterol and triglycerides, and/or body mass index. Fluid and electrolyte balance parameters may include body water, extracellular fluid and intracellular fluid volumes, plasma osmolarity, and/or urine output. Neurological and muscular parameters may include resting membrane potential and/or nerve conduction velocity.

The sensing or detection of first user physiology (e.g., a state or change in a user physiologic parameter) may be performed using a sensor or other detector useful for sensing or detecting the particular physiological parameter, e.g., a heart rate monitor for measuring heart rate, a blood glucose sensor for measuring blood glucose, a urine volume output monitor for measuring urine output, etc. The sensing or detection of first user physiology (e.g., a state or change in a user physiologic parameter) after manifestation of a first virtual object may, for example, enable responsive virtual object behavior or changes (or removal) based on first user physiologic state, or first user physiologic state changes, that occur subsequent to the initial proximity-triggered virtual object manifestation process. As another example, embodiments of the system may detect first user physiology before manifestation, enabling predictive virtual object preparation and customization based on anticipated future user physiology. For example, the system may detect that the first user 334 is feeling stressed (e.g., has elevated or increasing cortisol levels, has elevated or increasing heart rate) at some point following proximity with a first physical object, and in response, the system may modify the future manifestation of the first virtual object to include enhanced (e.g., helpful, stress-reducing) interactive elements that help alleviate the stress felt by the first user. Such pre-manifestation user physiology sensing or detection capability may provide the benefit of creating more helpful and useful (e.g., user friendly) virtual environments by measuring, sensing, or anticipating user physiologic states or changes and preparing virtual object manifestations that are optimized for according to the user's current or predicted physiology, thereby reducing response latency and improving overall user experience when a virtual object is subsequently manifested. Embodiments of systems of the invention may use processors and algorithms to analyze and interpret physiologic data, including the analysis and interpretation of user physiologic data time series, combinations of physiologic data, comparisons of physiologic data to known benchmarks, and more. Such analysis and/or interpretation of a user's physiologic data may then be used to determine and cause an action, such as a modification or removal of a virtual object or virtual object element. Embodiments may use any one or more (e.g., a combination) of the physiologic parameters listed above, which may be the subject of analysis and/or interpretation, and cause of a subsequent instruction or action, such as a modification or removal of a virtual object or virtual object element of the invention.

The system may utilize various sensor technologies to detect and interpret user motion across one or a plurality of modalities. With reference to FIG. 3, detecting physical motion of the first user 334 may be performed using at least one of a body motion sensor, an eye tracking sensor, a physiologic sensor, an inertial measurement unit, a camera (e.g., a depth camera and/or a stereo camera system), an infrared sensor, a magnetic tracking system, a neural sensor (e.g., neural implant), and/or an ultrasonic positioning system, as examples. These different sensor types may provide complementary detection capabilities, with body motion sensors detecting gross motor movements, eye tracking sensors monitoring visual attention, physiologic sensors detecting muscle activity or other physical signals, chemical signals, or biological signals that may indicate user intent or movement, and depth cameras providing three-dimensional spatial tracking of body segments.

In some embodiments, the system may solely use non-optical sensors such as inertial measurement units, physiologic sensors, magnetic tracking systems, and/or ultrasonic positioning systems for motion detection. In other embodiments, the system may solely use optical sensors such as cameras, infrared sensors, and/or eye tracking sensors for motion detection. In yet other embodiments, the system may use a combination of optical and non-optical sensors to provide enhanced motion detection capabilities.

Embodiments of the system may implement distinct sensor configurations, in which the sensors used for detecting physical motion of the first user 334 may be the same as or different from the first physical object-associated element 308 that provides the first signal 314 for virtual object identification and manifestation. As illustrated in FIG. 3, the first physical object-associated element 308 may communicate the first signal 314 to the first physical object detector 316 for purposes of identifying the first virtual object 304, while separate and distinct sensors may be employed to detect physical motion of the first user 334 for virtual object modification purposes. This sensor differentiation may enable the system to optimize each detection function independently, using specialized sensors that are particularly suited for their respective tasks.

In some embodiments, the first physical object-associated element 308 may comprise an RFID tag, NFC transmitter, or Bluetooth beacon that communicates identification information through the first signal 314, while physical motion detection of the first user 334 may be performed using entirely different sensor technologies such as electromyography (EMG) sensors, accelerometers, or optical tracking systems. For example, the first physical object-associated element 308 may be an RFID tag attached to a physical bicycle that transmits identification data when the first user 334 approaches with a mobile device containing the first physical object detector 316, while one or more EMG sensors worn by the first user 334 may detect muscle activation patterns to enable gesture-based control of a virtual bicycle representation within the first virtual environment 302. This dual-sensor approach may allow the system to maintain clear separation between object identification functions and user interaction functions.

Referring to FIG. 3, the system may implement configurations where the first physical object-associated element 308 provides a Bluetooth Low Energy signal containing identification information about the first physical object 310, while the first user 334's physical motion may be detected using wearable inertial measurement units, optical cameras, or physiologic sensors that operate independently of the Bluetooth communication channel. This separation may enable the system to continue detecting user motion even when the first signal 314 from the first physical object-associated element 308 is temporarily unavailable or when the first user 334 moves away from the proximity detection range while still interacting with the manifested first virtual object 304.

In alternative embodiments, the same sensor technology may serve dual purposes for both object identification and motion detection. As shown in FIG. 3, a single sensor system may receive the first signal 314 from the first physical object-associated element 308 for virtual object manifestation while simultaneously monitoring signal characteristics such as signal strength variations, transmission frequency changes, or communication patterns that may indicate physical motion of the first user 334 relative to the first physical object 310. For example, an NFC-enabled mobile device may detect proximity to an NFC tag on a physical object to trigger virtual object manifestation, while also analyzing the NFC signal strength fluctuations and connection stability patterns to infer user movement and gesture patterns for virtual object control.

Embodiments of the system may implement neural sensor technologies to detect and interpret user movement intentions directly from neural activity patterns. As shown in FIG. 3, detecting physical motion of the first user 334 may be performed using one or more neural sensors (e.g., one or more neural implants) that monitor electrical activity in the brain regions associated with motor planning and execution. A neural sensor may comprise electrode arrays, microelectrodes, or other biocompatible sensing devices that may be surgically implanted in motor cortex areas, premotor cortex regions, and/or supplementary motor areas to capture neural signals that precede and accompany movement intentions.

A neural sensor may enable the system to detect movement intentions even when the first user 334 is unable to physically execute the intended movement. For example, in cases where the first user 334 may have experienced limb amputation, spinal cord injury, or other conditions that limit physical movement capabilities, a neural sensor may detect the neural activity patterns that would normally trigger the intended movement. With reference to FIG. 3, when the first user 334 forms the intention to point at the first virtual object 304 but lacks the physical ability to perform the pointing gesture, a neural sensor may detect the motor cortex activation patterns associated with pointing movements and translate these neural signals into corresponding virtual object control commands.

Embodiments of the system may implement predictive movement detection through neural signal analysis that identifies movement intentions before conscious awareness occurs. A neural sensor may monitor preparatory neural activity in motor planning regions that may occur hundreds of milliseconds before the first user 334 becomes consciously aware of their movement intention. This predictive capability may enable the system to begin preparing virtual object responses based on detected neural precursors to movement, potentially providing more responsive interaction than systems that rely solely on completed physical movements. As illustrated in FIG. 3, a neural sensor may detect the early stages of neural activity associated with reaching toward the first virtual object 304, enabling the first virtual environment output device 324 to begin highlighting or preparing interactive elements before the first user 334 completes or even consciously initiates the reaching movement.

The system may implement neural signal classification algorithms that distinguish between different types of movement intentions based on the spatial and temporal patterns of neural activity detected by the implants. For example, a neural sensor may differentiate between neural patterns associated with grasping movements, pointing gestures, reaching motions, and eye movement intentions by analyzing the specific cortical areas activated and the characteristic firing patterns of neurons in those regions. Referring to FIG. 3, when a neural sensor detects neural activity patterns consistent with grasping intentions, the system may modify the first virtual object 304 to become graspable or to display grasping affordances, while detection of pointing-related neural patterns may cause the system to highlight selectable elements within the first virtual environment 302.

Embodiments of the system may provide neural signal calibration and training capabilities that adapt to individual users' neural patterns and movement intentions. A neural sensor may undergo calibration procedures where the first user 334 attempts or imagines specific movements while the system records the corresponding neural activity patterns. This calibration process may enable the system to create personalized neural signal profiles that improve the accuracy of movement intention detection for each individual user. The system may implement machine learning algorithms that continuously refine the neural signal interpretation based on user feedback and successful interaction outcomes, gradually improving the correlation between detected neural patterns and intended virtual object manipulations.

A neural sensor may enable the system to detect complex movement sequences and multi-step interaction intentions that extend beyond simple gesture recognition. For example, a neural sensor may detect neural planning activity associated with compound movements such as reaching for the first virtual object 304, grasping it, and then moving it to a different location within the first virtual environment 302. As shown in FIG. 3, this sequential intention detection may enable the first virtual environment output device 324 to prepare the entire interaction sequence in advance, potentially pre-loading visual feedback, collision detection, and physics simulation components that will be needed for the anticipated multi-step manipulation.

Embodiments of the system may implement neural feedback mechanisms that provide direct neural stimulation to confirm successful intention detection and virtual object interaction. A neural sensor may include stimulation capabilities that deliver controlled electrical pulses to sensory cortex areas, creating artificial tactile or proprioceptive sensations that correspond to virtual object interactions. When the first user 334's movement intentions result in successful manipulation of the first virtual object 304, a neural sensor may provide stimulation patterns that simulate the tactile feedback that would normally accompany physical object interaction, creating a more complete sensory experience for users who may lack natural tactile feedback pathways.

The system may utilize one or more neural sensors to detect movement intentions across multiple motor modalities simultaneously, enabling complex multi-limb coordination for virtual environment interaction. The one or more neural sensors may monitor neural activity associated with arm movements, leg movements, head movements, and eye movements concurrently, for example, allowing the first user 334 to control multiple aspects of the first virtual environment 302 through coordinated neural intentions. With reference to FIG. 3, neural sensors may detect simultaneous intentions for head turning to change viewpoint direction, arm reaching to select the first virtual object 304, and leg movement intentions for navigation within the first virtual environment 302, enabling fluid multi-modal interaction that may not be possible through traditional input methods.

Embodiments of the system may implement sensor integration and fusion approaches to combine multiple detection methods for more accurate and robust motion detection. For example, the system may utilize sensor fusion algorithms that integrate data from multiple sensor types simultaneously, such as combining inertial measurement unit data with computer vision tracking to provide more reliable motion detection even when individual sensors experience limitations or interference. The sensor fusion approach may enable the system to cross-validate motion data across different sensing modalities, reducing false positives and improving detection accuracy for the first user 334's interactions with the first virtual object 304. These integrated sensor systems may create closed-loop interaction systems where haptic feedback sensors work in conjunction with optical tracking to provide both motion detection and tactile response, enabling more immersive and responsive virtual object manipulation within the first virtual environment 302. The fusion of multiple sensor inputs may also enable the system to maintain tracking continuity when individual sensors are temporarily occluded or experience signal degradation, ensuring consistent user interaction capabilities across varying environmental conditions.

Embodiments of the system may implement physiologic sensing capabilities to detect subtle user movements and intentions with predictive intention recognition. As illustrated in FIG. 3, the physiologic sensor may comprise an electric detector configured to detect muscle signals. The electric detector may comprise an electromyography (EMG) sensor, which may detect electrical activity produced by skeletal muscles. This electromyography-based detection may enable the system to detect user movement intentions even before visible motion occurs, potentially providing highly responsive virtual object control based on muscle activation patterns detected from the first user 334. The system may implement predictive intention analysis that monitors physiological precursors to movement, such as subtle changes in muscle tension, neural activity patterns, or autonomic nervous system responses that occur milliseconds before conscious movement initiation. This predictive capability may enable the system to anticipate user actions based on involuntary physiological signals, allowing virtual object responses to begin before the user is consciously aware of their own movement intentions. The system may implement other physiologic sensors including, for example, accelerometers for detecting micro-movements, gyroscopes for orientation tracking, heart rate monitors for detecting heart rate variability (which may be used to determine user emotions) or user engagement levels, and/or neural interface devices for detecting brain activity patterns associated with movement and/or movement intentions (including whether or not the movement actually occurs).

Embodiments of the system may be configured to distinguish between intentional and unintentional user movements to provide accurate virtual environment control with adaptive sensitivity adjustment and predictive motion filtering. Referring to FIG. 3, detecting physical motion of the first user 334 may comprise detecting intentional movement of the first user 334 for controlling the first virtual environment 302. This intentional movement detection capability may enable the system to filter out inadvertent motions such as natural body sway, breathing movements, involuntary muscle twitches, or environmental vibrations, and respond only to deliberate user actions intended to interact with the first virtual object 304 or modify the first virtual environment 302.

Embodiments of the system may implement machine learning algorithms or pattern recognition techniques to distinguish between intentional gestures and background motion. The system may implement predictive motion filtering that analyzes movement trajectories and physiological indicators to predict whether a detected motion will develop into an intentional gesture or remain as unintentional background movement, enabling more accurate filtering of inadvertent motions before they interfere with virtual object control. In some embodiments, the system may utilize one or more neural sensors to enhance the distinction between intentional and unintentional movement. Neural sensors may be configured to detect neural activity patterns associated with conscious movement intention, such as motor cortex activation signals that precede voluntary muscle activation. For example, one or more neural sensors may monitor electrical activity in the motor cortex, premotor cortex, and/or supplementary motor area to identify neural signatures that indicate deliberate movement planning versus involuntary neural activity.

Embodiments of the system may implement adaptive sensitivity adjustment that modifies motion detection thresholds based on physiological indicators such as heart rate variability, muscle tension levels, or tremor patterns that may indicate user fatigue, stress, or motor impairment. This adaptive capability may enable the system to maintain consistent interaction quality by increasing sensitivity when the first user 334 shows signs of fatigue or decreasing sensitivity when detecting elevated stress levels that might cause unintentional movements. The system may also adapt gesture recognition based on the first user 334's demonstrated skill level, providing more forgiving interpretation for novice users while enabling more precise control for experienced users. A neural sensor may provide additional data for adaptive sensitivity adjustment by monitoring neural fatigue indicators, attention levels, and cognitive load through analysis of brainwave patterns, neural firing rates, and/or cortical activity distribution. For example, a neural sensor may detect changes in alpha wave activity that indicate decreased attention or increased theta wave activity that suggests cognitive fatigue, enabling the system to adjust motion detection parameters accordingly to maintain optimal user interaction performance.

Embodiments of the system may implement wearable sensor technologies to facilitate continuous motion monitoring across multiple body locations. As shown in FIG. 3, detecting physical motion of the first user 334 may be performed using one or more body-worn sensor devices. The body-worn sensor devices may comprise wristbands, finger rings, chest straps, headbands, ankle bands, smart clothing with embedded sensors, haptic gloves, motion capture suits, and/or neural interface implants or headsets, all configured to detect physical motion of the first user 334. This distributed wearable approach may provide unobtrusive motion detection capabilities, allowing the first user 334 to interact with the first virtual object 304 while maintaining freedom of movement within the first physical environment 306.

The system may implement various response actions based on detected user motion, such as any of the actions disclosed herein. With reference to FIG. 3, modifying (controlling) the first virtual object 304 may comprise removing the first virtual object 304 from the first virtual environment 302, repositioning the first virtual object 304 within the first virtual environment 302, resizing the first virtual object 304, rotating the first virtual object 304, changing visual properties of the first virtual object 304, changing behavioral properties of the first virtual object 304, triggering animations of the first virtual object 304, replicating the first virtual object 304, merging the first virtual object 304 with other virtual objects, and/or transforming the first virtual object 304 into different virtual objects in response to detecting the physical motion of the first user 334. This motion-triggered control capability may enable the first user 334 to perform manipulations of virtual objects through natural body movement (or neural signals indicating intention of body movement), providing intuitive control over the virtual environment content manifested by the first virtual environment output device 324.

Any techniques disclosed herein for modifying a single virtual object (e.g., the first virtual object 304), whether in response to detected user motion or any other trigger disclosed herein (e.g., detection of proximity or non-proximity), should be understood to be equally applicable to modifying a plurality of virtual objects and/or a virtual environment (e.g., the first virtual environment 302).

Embodiments of the system may implement various approaches for determining how detected physical motion, or intent of physical motion, modifies the first virtual object 304. For example, the system may utilize predetermined motion-modification associations that map specific user movements to corresponding virtual object changes. These predetermined associations may include, for example, mapping a leftward hand gesture to rotating the first virtual object 304 counterclockwise, mapping an upward finger pointing motion to enlarging the first virtual object 304, or mapping a pinching gesture to selecting and highlighting the first virtual object 304. The system may store these associations in a lookup table or database that enables rapid identification of the appropriate modification based on the detected motion pattern from the first user 334.

The system may employ rule-based approaches to determine virtual object modifications based on detected user motion. With reference to FIG. 3, these rules may define conditional relationships between motion characteristics and virtual object changes, such as “if hand velocity exceeds a threshold, then increase virtual object movement speed” or “if eye gaze duration on virtual object exceeds two seconds, then display additional information about the virtual object.” The rule-based system may evaluate multiple motion parameters simultaneously, including motion direction, speed, duration, and/or amplitude, to determine the most appropriate modification to apply to the first virtual object 304. These rules may be hierarchical, allowing complex decision trees that consider multiple motion inputs and environmental factors within the first virtual environment 302.

Embodiments of the system may implement algorithmic approaches that calculate virtual object modifications based on mathematical relationships with detected motion parameters. As illustrated in FIG. 3, these algorithms may translate motion characteristics into virtual object property changes using mathematical functions, such as mapping hand position coordinates directly to virtual object location coordinates within the first virtual environment 302, or using velocity calculations to determine rotation speeds for the first virtual object 304. The algorithms may incorporate scaling factors, offset values, and/or transformation matrices to convert physical motion measurements into appropriate virtual space modifications. Such algorithmic approaches may enable precise, proportional control where the magnitude and direction of user motion directly correspond to the extent and nature of virtual object changes.

The system may utilize machine learning models to identify appropriate virtual object modifications based on detected user motion patterns. Referring to FIG. 3, these models may be trained on datasets that associate various motion patterns with desired virtual object behaviors, enabling the system to learn complex relationships between user movements and virtual object modifications that may not be easily captured by predetermined rules or simple algorithms. The machine learning models may include neural networks, decision trees, support vector machines, and/or ensemble methods that can recognize subtle motion patterns and predict the most appropriate modification for the first virtual object 304 based on the detected physical motion of the first user 334.

Embodiments of the system may implement adaptive machine learning models that continuously update their motion-modification associations based on user behavior and feedback with predictive learning capabilities. As shown in FIG. 3, these adaptive models may monitor the first user 334's interactions with the first virtual object 304 over time, learning from successful interactions and adjusting their predictions accordingly. The adaptive models may incorporate reinforcement learning techniques that reward successful motion-modification pairings and penalize unsuccessful ones, gradually improving the system's ability to predict the desired virtual object changes based on user motion. The system may implement predictive learning algorithms that analyze patterns in the first user 334's motion sequences to anticipate future gesture combinations and interaction preferences, enabling the system to proactively suggest or prepare virtual object modifications based on predicted user intentions. This adaptive capability may enable the system to personalize its responses to individual users, learning their preferred interaction patterns and motion styles.

The system may combine multiple identification approaches to provide robust and flexible motion-modification determination. The system may use a hierarchical approach where predetermined associations handle common, well-defined gestures, rule-based systems manage intermediate complexity interactions, and machine learning models address novel or ambiguous motion patterns. This multi-layered approach may provide fallback mechanisms, where if one identification method fails to determine an appropriate modification, alternative methods may be employed to ensure responsive virtual object control based on the detected physical motion of the first user 334.

Embodiments of the system may implement context-aware identification that considers environmental factors and virtual object states when determining modifications, with dynamic adaptation based on activity-specific requirements and predictive context analysis. As illustrated in FIG. 3, the system may evaluate the current state of the first virtual object 304, the surrounding virtual environment 302, and the first user 334's interaction history to influence how detected motion is interpreted and translated into virtual object modifications. For example, the same hand gesture may result in different modifications depending on whether Grethe first virtual object 304 is currently selected, whether other virtual objects are nearby, or whether the first user 334 is in a navigation mode versus a manipulation mode within the first virtual environment 302.

The system may implement predictive context analysis that anticipates changes in user context based on current activity patterns, environmental cues, and historical behavior, enabling proactive adjustment of gesture recognition parameters before context changes occur. The system may implement activity-specific gesture recognition that automatically switches between different gesture vocabularies based on the current application or task context. For instance, when the first user 334 is engaged in architectural design activities, the system may prioritize precise measurement gestures and construction-related commands, while switching to entertainment-focused gestures during gaming sessions.

The system may also implement environmental adaptation that modifies motion detection parameters based on physical space constraints, lighting conditions, or the presence of other users or objects that might interfere with tracking. Dynamic sensitivity adjustment may occur in real-time based on user performance metrics, automatically fine-tuning gesture recognition thresholds to optimize interaction accuracy and reduce user frustration. The contextual adaptation may include learning individual user preferences and motor patterns over time, creating personalized gesture profiles that improve recognition accuracy for each specific user's movement characteristics and interaction style.

Embodiments of the present invention may extend the proximity-based virtual object manifestation system to include predictive proximity determination capabilities that proactively manifest, modify, or remove virtual objects based on calculated future proximity states. These predictive proximity embodiments may operate in conjunction with the embodiments of the proximity detection system described above in connection with FIGS. 1-3, or may function independently of such embodiments.

Referring to FIG. 3, the system 300 may include additional components for implementing predictive proximity calculations. In some embodiments, the system may include a predictive proximity calculation engine that determines the intersection of estimated travel time to reach a physical object location and lead time data from third-party systems for services associated with that location. This predictive capability may enable the system to manifest virtual objects before actual proximity occurs, optimizing user interaction timing and service delivery coordination.

The predictive proximity calculation engine may receive various movement prediction inputs to calculate estimated travel times. For vehicle-based transportation, the system may analyze current speed, acceleration, direction vector, GPS route data, traffic conditions, estimated arrival time, and fuel or battery levels. For pedestrian movement, the system may consider walking speed patterns, foot traffic density, pedestrian route optimization, step counting data, and mobility device usage. Public transit calculations may incorporate bus or train schedules, route timing data, transfer connections, delay predictions, and capacity information. Multi-modal transportation predictions may combine multiple transportation methods, parking availability at destinations, and last-mile connectivity options. The system may consider user context factors such as calendar appointments, historical travel patterns, preferred travel times, and routine destination predictions.

In some embodiments, the system may integrate lead time data from various third-party sources to determine service availability and timing requirements. Restaurant and food service systems may provide point-of-sale system wait times, kitchen capacity, order queue length, preparation complexity, and staffing levels. Retail systems may supply inventory availability, checkout wait times, service counter queues, and product preparation times such as pharmacy prescriptions. Service appointment systems may offer appointment schedulers, wait room capacity, provider availability, and service duration estimates. Manufacturing and industrial systems may provide production line status, quality control checkpoints, shipping preparation times, and custom order processing information. Healthcare systems may supply appointment systems, examination room availability, procedure scheduling, and wait time analytics. Entertainment venues may provide ticket availability, venue capacity, event start times, and intermission schedules. Government services may offer DMV wait times, permit processing, office hours, and peak service periods.

The system may implement various timing granularity options to accommodate different service types and user preferences. High precision calculations may provide second-level accuracy for time-critical services such as emergency services or time-sensitive appointments. Standard precision may offer minute-level calculations for typical food service and retail interactions. Approximate precision may use hour-level calculations for entertainment and recreational activities. The system may implement confidence intervals that provide statistical ranges around timing estimates, such as plus or minus 5 minutes, plus or minus 15 minutes, or plus or minus 1 hour. Adaptive precision may dynamically adjust based on service type, traffic reliability, and user preferences. Margin-of-error calculations may incorporate probability distributions for arrival time predictions, while fuzziness parameters may provide adjustable tolerance ranges for timing intersection calculations.

In some embodiments, the predictive proximity system may operate in conjunction with the proximity detection system described herein. Referring to FIG. 3, the system 300 may simultaneously monitor for both predictive proximity conditions and current proximity detection through the first physical object detector 316 receiving the first signal 314 from the first physical object-associated element 308. This combined approach may provide multiple layers of virtual object manifestation that respond to different temporal relationships between users and physical objects.

The system may implement parallel operation modes where current proximity mode provides traditional reactive manifestation when physical proximity is detected, predictive proximity mode enables proactive manifestation based on calculated future proximity, and combined mode allows both systems to operate simultaneously with predictive objects appearing before current proximity objects. When the predictive proximity calculations indicate that the first user 334 will be in proximity to the first physical object 310 within an optimal service timing window, the first virtual object identification module 320 may identify the first virtual object 304 and the first virtual environment output device 324 may manifest the first manifestation of the first virtual object 328 in advance of actual proximity detection.

As the first user 334 approaches the first physical object 310, the traditional proximity detection system may activate when the first physical object detector 316 receives the first signal 314 from the first physical object-associated element 308. At this point, the system may transition the predictively manifested virtual object to a proximity-confirmed state, potentially enhancing its detail, interactivity, or prominence within the first virtual environment 302. The first value identification module 318 may process the first signal 314 to identify the first value 322, which may be used to verify or refine the predictively manifested virtual object.

The system may implement fallback mechanisms to ensure continuous functionality when predictive data becomes unavailable or unreliable. In such cases, the system may degrade gracefully to traditional proximity-based operation, maintaining the core functionality of manifesting virtual objects based on signal reception from physical object-associated elements. This hybrid approach may provide enhanced user experience when predictive data is available while ensuring reliable operation under all conditions.

Embodiments of the present invention may implement predictive proximity-based virtual object manifestation as a standalone system that operates independently of traditional signal-based proximity detection. In these embodiments, the system may identify physical objects and manifest corresponding virtual objects based entirely on predictive calculations without requiring the receipt of signals from physical object-associated elements.

Referring to FIG. 3, in standalone predictive operation, the system 300 may bypass the signal reception process where the first physical object detector 316 receives the first signal 314 from the first physical object-associated element 308. Instead, the first value identification module 318 may derive the first value 322 from alternative data sources such as location databases, mapping services, business directories, API calls to third-party services, or other data retrieval methods. The first virtual object identification module 320 may then identify the first virtual object 304 based on this database-derived information, and the first virtual environment output device 324 may manifest the first manifestation of the first virtual object 328 based purely on predictive proximity calculations.

The system may access comprehensive databases containing restaurant locations, retail store information, service provider addresses, appointment locations, and other physical object data. When predictive proximity calculations indicate that the first user 334 will be in proximity to a service location within a timeframe that aligns with the service's lead time requirements, the system may manifest appropriate virtual objects without any direct communication from the physical environment. For example, the system may manifest a virtual restaurant menu when travel time calculations indicate the user will arrive at a restaurant location within the restaurant's typical order preparation window, even if the restaurant has no RFID tags, NFC transmitters, or other signal-transmitting elements.

This standalone approach may be particularly advantageous in scenarios where physical objects lack associated signal-transmitting elements, where signal reception is unreliable due to environmental factors, or where advance notice of services provides greater value than proximity-triggered reactive responses. The system may still provide dynamic virtual object evolution, user interaction capabilities, and real-time updates based on changing conditions, but may operate entirely through predictive algorithms and database integration.

Embodiments of the present invention may implement sophisticated real-time update mechanisms that continuously adjust virtual object manifestation based on changing conditions. The system may implement threshold-based manifestation where virtual objects appear when the calculated intersection of travel time and lead time falls within acceptable temporal ranges. As conditions change, the system may dynamically manifest or remove virtual objects based on updated calculations.

Manifestation triggers may include various condition changes that bring users into viable service windows. Traffic improvements may reduce travel time, bringing users into optimal ordering windows for restaurants or service appointments. Service availability increases, such as reduced restaurant wait times or increased appointment availability, may make previously impractical services viable for users. Route optimization through navigation systems may find faster routes that enable access to time-sensitive services. User preference satisfaction may occur when service parameters align with user-defined acceptable wait time limits. Real-time promotions may create time-limited opportunities that match user arrival windows. Capacity updates from service locations may report increased capacity that reduces lead times and enables service access.

Removal triggers may cause virtual objects to disappear when conditions make services impractical. Threshold exceedance removal may occur when predicted proximity exceeds viable service windows, such as when lead times increase beyond user estimated arrival times or when travel delays make service timing impractical. Traffic deterioration may increase travel time and push arrival beyond service viability windows. Service capacity reduction, such as restaurants becoming busy and extending wait times beyond user arrival windows, may trigger virtual object removal. Route disruption from construction, accidents, or detours may significantly delay arrival and make services impractical. Service unavailability, such as locations closing, running out of preferred items, or suspending service, may cause immediate virtual object removal. User preference violations may occur when updated conditions exceed user-defined maximum acceptable wait times. Real-time conflicts from calendar changes or shifted priorities may affect destination viability and trigger virtual object removal.

The system may implement continuous update processing that integrates real-time data from multiple sources. Traffic condition monitoring may provide automatic recalculation of travel times based on current road conditions. Service status polling may update wait times and availability information from restaurants, retailers, and service providers. Route optimization may continuously adjust path calculations based on changing traffic patterns and road conditions. User behavior learning may improve prediction accuracy by analyzing historical patterns and preferences.

Embodiments of the present invention may implement dynamic virtual object evolution based on prediction confidence and arrival time calculations. As prediction confidence increases, virtual objects may become more detailed and interactive, transitioning from simple informational displays to comprehensive service interfaces. Initial simple icons may evolve into detailed menus or service interfaces as arrival likelihood increases. Basic information objects may expand to include rich media, user reviews, and customization options. Tentative offerings may become firm recommendations with actionable elements as timing becomes more certain.

Conversely, as prediction confidence decreases, detailed virtual objects may simplify to basic placeholders as arrival becomes uncertain. Interactive elements may disable when timing becomes impractical for service utilization. Rich content objects may fade to simple notification reminders when service windows become misaligned with user arrival times. Firm recommendations may become tentative suggestions or disappear entirely when conditions make services impractical.

The system may implement arrival time-based evolution where virtual objects change characteristics as calculated arrival times approach or recede. As arrival time decreases and users get closer to service locations, virtual objects may transition from informational to actionable states. Basic menus may become detailed ordering interfaces with customization options. Service information may become real-time status updates with current wait times and availability. General promotions may become specific, time-sensitive offers that align with user arrival windows. Virtual objects may relocate within the virtual environment to become more prominent as arrival approaches.

As arrival time increases due to delays or route changes, actionable interfaces may revert to informational displays. Detailed ordering systems may become simplified browsing experiences when timing becomes impractical for order placement. Real-time updates may become general service information when immediate relevance decreases. Time-sensitive offers may extend deadlines, become general promotions, or disappear when timing windows close. Virtual objects may reposition to less prominent locations within the virtual environment as relevance decreases.

The system may implement dynamic content adaptation that integrates real-time service status information. Menu items may appear or disappear based on real-time availability from restaurant point-of-sale systems. Pricing updates may reflect time-of-day or demand-based changes from service providers. Service features may enable or disable based on current capacity and staffing levels. Customization options may adjust based on preparation time constraints and service complexity.

User preference learning may enable the system to personalize virtual object evolution over time. Virtual objects may emphasize previously selected options based on user history. Interface complexity may adjust to match user engagement patterns and technical proficiency. Content prioritization may reflect historical preferences and interaction patterns. Timing predictions may improve based on analysis of user's actual behavior patterns, arrival times, and service utilization.

Embodiments of the present invention may implement temporal geofencing systems that create dynamic boundaries based on timing calculations rather than fixed spatial distances. These time-based perimeters may provide more accurate and relevant virtual object manifestation by considering the temporal aspects of service delivery and user movement patterns.

The system may create dynamic boundary conditions where time-based perimeters replace traditional distance-based geofences. Shrinking geofences may occur as traffic conditions slow, reducing the area where service timing remains viable for users. Expanding geofences may result from increased service capacity, broadening the area where users can successfully access services within acceptable timing windows. Route-specific shapes may follow probable travel paths rather than simple circular boundaries around physical objects, providing more accurate representations of accessible service areas.

The system may manage multiple concurrent geofences for different service types and timing requirements. Overlapping service areas may exist simultaneously, with food service geofences based on preparation time plus travel time intersections, retail service geofences incorporating product availability plus shopping time plus travel time, and appointment geofences considering check-in requirements plus travel time plus parking time. Each geofence type may have different temporal parameters and update frequencies based on the specific service characteristics and timing requirements.

Embodiments of the present invention may provide coverage across various transportation modes, adapting predictive calculations to the specific characteristics and constraints of different travel methods. The system may optimize virtual object manifestation timing based on the unique aspects of each transportation mode.

For autonomous vehicle integration, the system may leverage the fact that passengers have available attention for virtual environment interaction during travel. Navigation system integration may provide precise route planning data and travel time estimates. Traffic data incorporation may enable real-time traffic condition analysis that affects arrival predictions. Fuel or charging considerations may influence destination viability by incorporating range limitations into service accessibility calculations.

Traditional vehicle operation may require careful attention management to ensure driver safety. The system may manifest virtual objects when safe interaction is possible, such as for passenger use, when vehicles are stopped at traffic lights, or through hands-free interaction methods. Voice interface integration may enable audio-based virtual object presentation that maintains driver safety. Passenger-focused manifestation may primarily target non-driving occupants while providing limited driver-accessible features.

Public transportation integration may leverage predictable scheduling and route information. Schedule integration may use bus and train timetables to provide reliable travel timing predictions. Multi-modal calculations may account for transfer connections that affect total travel time. Crowding predictions may incorporate peak time capacity information that affects service lead time calculations. Real-time delay incorporation may update travel time estimates based on service disruptions and schedule changes.

Pedestrian applications may consider the unique characteristics of walking-based transportation. Walking speed analytics may use historical pace data to improve arrival predictions for individual users. Route complexity factors may account for stairs, elevations, and pedestrian traffic density that affect travel times. Weather impact consideration may adjust calculations based on conditions that affect walking speed and route choice. Accessibility accommodations may provide alternative route requirements and timing adjustments for mobility device users.

Stationary user scenarios may enable predictive virtual object manifestation based on scheduled activities and routine patterns. Scheduled activity integration may use calendar appointments to create predictable proximity events. Routine pattern recognition may identify regular activities such as commutes, exercise, and meals that enable prediction algorithms. Location-based triggers may initiate predictions when users are in proximity to home, office, or frequently visited locations. Time-based forecasting may use daily routines to create predictable proximity patterns that enable advance virtual object preparation.

Embodiments of the present invention may implement comprehensive user preference systems that enable personalized predictive proximity calculations and virtual object manifestation. The system may provide configurable parameters that allow users to define their preferences for various aspects of the predictive system operation.

User-configurable parameters may include maximum acceptable wait times for different service categories, enabling users to define their tolerance for restaurant wait times, retail service delays, appointment scheduling, and other service types. Advance notice preferences may allow users to specify how far ahead they want to see predictive virtual objects, balancing early notification with relevance timing. Service type priorities may enable users to rank food, retail, entertainment, and appointment services for prediction preference when multiple options are available. Timing precision requirements may allow users to specify their tolerance for arrival time uncertainty and prediction accuracy. Budget constraints may provide price-based filtering for service recommendations, ensuring that manifested virtual objects align with user financial preferences.

The system may implement adaptive learning capabilities that improve prediction accuracy and personalization over time. Pattern recognition algorithms may analyze user's typical response times to predictions, learning how quickly users act on predictive virtual object manifestations. Preference evolution tracking may monitor user choices over time to refine prediction algorithms and virtual object selection. Context awareness may enable different preferences for work versus leisure travel, weekday versus weekend patterns, and seasonal variations in user behavior.

Machine learning algorithms may analyze historical user behavior patterns, traffic data, and service utilization trends to improve prediction accuracy. The system may monitor user interactions with predictively manifested virtual objects, learning from successful interactions and adjusting predictions accordingly. Reinforcement learning techniques may reward successful prediction-manifestation pairings and penalize unsuccessful ones, gradually improving the system's ability to predict optimal timing and relevant services for individual users.

Embodiments of the present invention may provide practical applications across various service scenarios that demonstrate the utility of predictive proximity-based virtual object manifestation. These examples illustrate how the system may optimize user experience and service delivery coordination through advance timing calculations.

In restaurant ordering scenarios, the system may calculate that a user driving toward an area with restaurants will arrive at a specific restaurant in 18 minutes. The system may query the restaurant's point-of-sale system and determine that current wait time is 12 minutes for order preparation. The intersection calculation may determine that 18-minute travel time plus 12-minute preparation time creates an optimal ordering window. The system may manifest a restaurant menu in the user's virtual environment, enabling the user to place an order while traveling. Real-time updates may adjust for traffic delays that increase travel time to 22 minutes, with the system updating arrival estimates accordingly. The outcome may be that the user arrives to a ready order, optimizing both travel time and wait time.

Retail shopping scenarios may demonstrate predictive manifestation for limited-availability items. The system may predict that a user walking through a shopping district will pass an electronics store in 8 minutes based on current walking pace. An inventory check may reveal that the store has a limited-quantity sale item that the user previously viewed online. Lead time factors may indicate that the item requires 5 minutes to retrieve from storage. The system may manifest product information and purchase options in the user's virtual environment. Dynamic updates may cause the virtual object to disappear if another customer purchases the item, while alternative suggestions may manifest similar available products.

Service appointment scenarios may optimize scheduling and preparation timing. The system may calculate that a user will arrive at a medical facility in 25 minutes based on current travel conditions. Integration with the facility's appointment system may reveal that a preferred appointment slot has become available due to a cancellation, with 15 minutes required for check-in and preparation procedures. The system may manifest appointment booking options that align with the user's arrival timing, enabling efficient scheduling that minimizes wait time and optimizes appointment utilization.

These examples demonstrate how embodiments of the present invention may provide practical benefits through predictive proximity calculations that coordinate user movement with service timing requirements, creating optimized experiences that reduce wait times, improve service utilization, and enhance overall user satisfaction through proactive virtual object manifestation.

### DESCRIPTION OF CLAIMS

The present disclosure provides a system configured for manifesting a virtual object in a first virtual environment. The system comprises one or more hardware processors configured by machine-readable instructions to receive, at a first physical object detector, a first signal from a first physical object-associated element in a first physical environment, wherein the first physical object-associated element is associated with a first physical object in the first physical environment, and wherein the first signal contains information representing an identity of the first physical object. The processors are further configured to identify, at a first value identification module, based on the first signal, a first value associated with the first signal, wherein the first value is associated with the first physical object. The processors are also configured to identify, at a first virtual object identification module, based on the first value, a first virtual object, and to manifest, at a first virtual environment output device, a first manifestation of the first virtual object in a first manifestation of the first virtual environment. Additionally, the processors are configured to detect physical motion of a user and, in response to detecting the physical motion of the user, modify the first virtual object.

In other embodiments, the first virtual object may comprise a first simulation of the first physical object. The first virtual object may comprise at least one of a virtual object, a virtual personal object, a virtual commercial object, a virtual industrial object, a virtual military object, a virtual item of clothing, a virtual item of footwear, a virtual mode of transportation, a virtual bicycle, a virtual automobile, a virtual aircraft, a virtual boat, a virtual ship, a virtual drone, a virtual scooter, a virtual machine, virtual equipment, a virtual food, a virtual tool, a virtual implement, a place, a virtual residential setting, a person, a first virtual experience, a promotion, a performance, a concert, a non-fungible token, digital content, text, audio, video, a virtual button, or a virtual presentation of two or more selectable virtual objects.

The digital content may relate to the first physical object, and the digital content may comprise at least one of a promotion for the first physical object, a promotion for a second physical object that is related to the first physical object, a promotion for a second virtual object that is related to the first physical object, instructions for using the first physical object, directions to the first physical object, directions to a location related to the first physical object, a discount or code, and information describing the first physical object.

Identifying the first virtual object may comprise generating the first virtual object. Alternatively, identifying the first virtual object may comprise selecting an existing virtual object in the first virtual environment as the first virtual object. In other embodiments, identifying the first virtual object may comprise modifying an existing virtual object in the first virtual environment. Identifying the first virtual object may also comprise replacing an existing virtual object in the first virtual environment with the first virtual object.

Manifesting the first manifestation of the first virtual object may comprise generating first visual output representing the first virtual object. Alternatively, manifesting the first manifestation of the first virtual object may comprise generating first visual output relating to the first virtual object. The first visual output may comprise at least one of text output, audio output, and video output. Generating the first visual output may comprise generating the first visual output based on the first signal.

The one or more hardware processors may be further configured by machine-readable instructions to receive first user input directed to the first manifestation of the first virtual object. Manifesting the first manifestation of the first virtual object may comprise delaying by an amount of time before manifesting the first manifestation of the first virtual object.

The first virtual environment output device may comprise at least one of a virtual reality output means and an augmented reality output means. The first virtual environment may comprise at least one of a virtual reality environment and an augmented reality environment.

The one or more hardware processors may be further configured by machine-readable instructions to, before receiving the first signal, determine that the first physical object is in proximity to the first physical object detector in the first physical environment. Determining that the first physical object is in proximity to the first physical object detector may comprise determining that the first physical object is in proximity to the first physical object detector based on the first signal. The receiving of the first signal may be performed in response to determining that the first physical object is in proximity to the first physical object detector in the first physical environment. The determining that the first physical object is in proximity to the first physical object detector in the first physical environment may comprise determining that the first physical object is in proximity to the first physical object detector in the first physical environment based on a detection of a presence of the first signal.

The first signal may comprise at least one of an RFID signal, a Bluetooth signal, or an NFC signal. The first signal may comprise a first code. The first code may represent an identity of the first physical object. The first signal may represent an identity of the first physical object.

The one or more hardware processors may be further configured by machine-readable instructions to determine that the first physical object is not in proximity to the first physical object detector in the first physical environment based on at least one of an absence or a change in a characteristic of the first signal, and to remove the first virtual object from the first virtual environment in response to determining that the first physical object is not in proximity to the first physical object detector in the first physical environment. Determining that the first physical object is not in proximity to the first physical object detector in the first physical environment may comprise determining that the first physical object detector and the first physical object are at least a particular distance apart from each other.

Detecting physical motion of the user may comprise detecting physical motion of the user after manifesting the first manifestation of the first virtual object. Detecting physical motion of the user may comprise detecting movement of at least one body part of the user. The at least one body part may comprise at least one of hands, fingers, arms, head, eyes, legs, limbs, or joints.

Detecting physical motion of the user may comprise detecting a hand gesture of the user. Detecting physical motion of the user may comprise detecting a finger movement of the user. Detecting finger movements may comprise detecting interaction between a thumb and an index finger of the user. Detecting physical motion of the user may comprise detecting eye movements of the user.

Detecting physical motion of the user may be performed using at least one of a body motion sensor, an eye tracking sensor, and a physiologic sensor. The physiologic sensor may comprise an electric detector. The electric detector may comprise an electromyography sensor.

Detecting physical motion of the user may comprise detecting intentional movement of the user for controlling the first virtual environment. Detecting physical motion of the user may be performed using a body-worn sensor device. The body-worn sensor device may comprise a wristband configured to detect physical motion of the user.

The modifying of the first virtual object may comprise removing the first virtual object from the first virtual environment in response to detecting the physical motion of the user. The first physical object-associated element may be distinct from the first physical object.

The present disclosure also provides a method for manifesting a virtual object in a first virtual environment. The method comprises receiving, at a first physical object detector, a first signal from a first physical object-associated element in a first physical environment, wherein the first physical object-associated element is associated with a first physical object in the first physical environment, and wherein the first signal contains information representing an identity of the first physical object. The method further comprises identifying, at a first value identification module, based on the first signal, a first value associated with the first signal, wherein the first value is associated with the first physical object. The method also comprises identifying, at a first virtual object identification module, based on the first value, a first virtual object, and manifesting, at a first virtual environment output device, a first manifestation of the first virtual object in a first manifestation of the first virtual environment. Additionally, the method comprises detecting physical motion of a user and, in response to detecting the physical motion of the user, modifying the first virtual object.

### Boilerplate

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The term “distinct,” as used herein in connection with any object A and object B, indicates that objects A and B are not completely coextensive with each other in space. The term “same,” as used herein in connection with any object A and object B, indicates that objects A and B are not distinct. As this implies, if objects A and B are completely coextensive with each other in space, then they are the same object, and if two objects A and B are the same object, then they are completely coextensive with each other in space.

As the definition above implies, two objects A and B may be distinct and be completely non-coextensive with each other in space. Consider an example in which object A is a first chair and object B is a second chair, and in which the first chair and the second chair are completely non-coextensive with each other in space. In all of the following embodiments, the first chair and the second chair would satisfy the definition herein of “distinct”:
The first chair and the second chair are in contact with each other.
The first chair and the second chair are not in contact with each other.
The first chair and the second chair are not in contact with each other, but are coupled to each other by one or more media, such as glue, a fastener, an aspect or element of one of the objects, or another object.
The first chair and the second chair are not in contact with each other, are separated from each other in space, and are not coupled to each other.

As the definition above implies, two objects A and B may be distinct and be partially, but not completely, coextensive with each other in space. Consider an example in which object A is a first chair and object B is a second chair, and in which the first chair and the second chair are partially, but not completely, coextensive with each other in space. An example of this would be that the first chair and the second chair share a back in common, such that the first and second chairs are facing in opposite directions.

Two distinct objects may or may not have the same properties as each other. For example, two chairs may be distinct from each other even if they are the same model of chair, and even if they are indistinguishable from each other to a human observer. As another example, two chairs which are different models, and which are not entirely coextensive in space, are an example of two distinct objects.

The term “distinct,” as used herein, may apply to physical objects and virtual objects. In the case of distinct physical objects, the space that distinct physical objects occupy is physical space, and any space between distinct physical objects is physical space. In the case of distinct virtual objects, the space that distinct virtual objects occupy is virtual space, and any space between the distinct virtual objects is virtual space.

Labels such as “first” and “second” herein do not imply an order or sequence, either spatially or temporally. For example, references herein to “a first object” and “a second object” do not imply that the first object necessarily is located spatially before the second object, or that an action necessarily is performed by or on the first object before being performed by or on the second object. Similarly, references herein to “a first action” and “a second action” do not imply that the first action necessarily is performed before the second action. Any reference herein to a “first” object or action does not imply that there necessarily is a second object or action.

In some embodiments, terms such as “first” and “second” refer to distinct elements. For example, in some embodiments, a reference herein to “a first object” and “a second object” refers to a first object which is distinct from a second object, as the term “distinct” is used herein. As one example, in some embodiments the first object may be a first chair, the second object may be a second chair, and the first chair may not be completely coextensive in space with the second chair. As one particular example, the fist chair and the second chair may be completely non-coextensive with each other in space, and may be separated from each other by some amount of space.

In other embodiments, terms such as “first” and “second” refer to non-distinct elements. For example, in some embodiments, a reference herein to “a first chair” and a reference to “a second chair” both refer to the same (physical or virtual) chair. In such cases, terms such as “first” and “second” are used to label the references to the referenced element, not to imply that there are multiple instances of the referenced element itself.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention display virtual objects within a virtual environment, such as a simulated three-dimensional environment displayed on a display monitor or via a virtual reality display. Such features are inherently rooted in computer technology and cannot be performed mentally or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or grayscale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Any description herein of an act of identifying the existence of an object, state, value, or condition may include determining that the object, state, value, or condition exists. Any description herein of an act of identifying the existence of an object, state, value, or condition may include determining whether the object, state, value, or condition exists.

In some embodiments of the present invention, a first element of a system may communicate an identifier (or a representation of an identity) of a physical object to a second element of the system. The identifier may, for example, be an identifier of the physical object, an identifier of a user, an identifier of a device, or an identifier of a software application executing on a computer or other electronic processing means.

What is claimed is:

1. A system configured for manifesting a virtual object in a first virtual environment, the system comprising:
one or more hardware processors configured by machine-readable instructions to:
(a) receive, at a first physical object detector, a first signal, from a first physical object-associated element in a first physical environment, wherein the first physical object-associated element is associated with a first physical object in the first physical environment, and wherein the first signal contains information representing an identity of the first physical object;
(b) identify, at a first value identification module, based on the first signal, a first value associated with the first signal, wherein the first value is associated with the first physical object;
(c) identify, at a first virtual object identification module, based on the first value, a first virtual object;
(d) manifest, at a first virtual environment output device, a first manifestation of the first virtual object in a first manifestation of the first virtual environment;
(e) detect physical motion of a user; and
(f) in response to detecting the physical motion of the user, modify the first virtual object.

2. The system of claim 1, wherein the first virtual environment comprises at least one of a virtual reality environment and an augmented reality environment.

3. The system of claim 1, wherein the one or more hardware processors are further configured by machine-readable instructions to:
(h) before (a), determine that the first physical object is in proximity to the first physical object detector in the first physical environment.

4. The system of claim 1, wherein the first signal comprises at least one of an RFID signal, a Bluetooth signal, or an NFC signal.

5. The system of claim 1, wherein the first signal represents an identity of the first physical object.

6. The system of claim 1, wherein the one or more hardware processors are further configured by machine-readable instructions to:
(g) determine that the first physical object is not in proximity to the first physical object detector in the first physical environment based on at least one of an absence or a change in a characteristic of the first signal; and
(h) remove the first virtual object from the first virtual environment in response to determining that the first physical object is not in proximity to the first physical object detector in the first physical environment.

7. The system of claim 1, wherein detecting physical motion of the user comprises detecting movement of at least one body part of the user.

8. The system of claim 7, wherein the at least one body part comprises at least one of hands, fingers, arms, head, eyes, legs, limbs, or joints.

9. The system of claim 1, wherein detecting physical motion of the user comprises detecting a hand gesture of the user.

10. The system of claim 1, wherein detecting physical motion of the user comprises detecting a finger movement of the user.

11. The system of claim 1, wherein detecting physical motion of the user comprises detecting eye movements of the user.

12. The system of claim 1, wherein detecting physical motion of the user is performed using at least one of a body motion sensor, an eye tracking sensor, and a physiologic sensor.

13. The system of claim 12, wherein the physiologic sensor comprises an electric detector.

14. The system of claim 13, wherein the electric detector comprises an electromyography sensor.

15. The system of claim 1, wherein detecting physical motion of the user comprises detecting intentional movement of the user for controlling the first virtual environment.

16. The system of claim 1, wherein detecting physical motion of the user is performed using a body-worn sensor device.

17. The system of claim 16, wherein the body-worn sensor device comprises a wristband configured to detect physical motion of the user.

18. The system of claim 1, wherein (f) comprises removing the first virtual object from the first virtual environment in response to detecting the physical motion of the user.

19. The system of claim 1, wherein the first physical object-associated element is distinct from the first physical object.

20. A method for manifesting a virtual object in a first virtual environment, the method comprising:
(a) receiving, at a first physical object detector, a first signal, from a first physical object-associated element in a first physical environment, wherein the first physical object-associated element is associated with a first physical object in the first physical environment, and wherein the first signal contains information representing an identity of the first physical object;
(b) identifying, at a first value identification module, based on the first signal, a first value associated with the first signal, wherein the first value is associated with the first physical object;
(c) identifying, at a first virtual object identification module, based on the first value, a first virtual object;
(d) manifesting, at a first virtual environment output device, a first manifestation of the first virtual object in a first manifestation of the first virtual environment;
(e) detecting physical motion of a user; and
(f) in response to detecting the physical motion of the user, modifying the first virtual object.
